SEQUENCE LISTING (354 sequences)

SEQ ID NO: 1 - DNA, 20 bp, Artificial Sequence
  Synthetic
catccatcagaggggaaatg

SEQ ID NO: 2 - DNA, 18 bp, Artificial Sequence
  Synthetic
ccagccgttggacaaatc

SEQ ID NO: 3 - DNA, 19 bp, Artificial Sequence
  Synthetic
agcttagagggatggcagc

SEQ ID NO: 4 - DNA, 20 bp, Artificial Sequence
  Synthetic
cagaccctggggctactacc

SEQ ID NO: 5 - DNA, 19 bp, Artificial Sequence
  Synthetic
gacgggtagagtgtgcgtg

SEQ ID NO: 6 - DNA, 19 bp, Artificial Sequence
  Synthetic
agccagtgcttgttgcttg

SEQ ID NO: 7 - DNA, 20 bp, Artificial Sequence
  Synthetic
gagagaggaagagatggggc

SEQ ID NO: 8 - DNA, 20 bp, Artificial Sequence
  Synthetic
gaggatggctacaggcagag

SEQ ID NO: 9 - DNA, 20 bp, Artificial Sequence
  Synthetic
gctcctgatctggtacaggc

SEQ ID NO: 10 - DNA, 20 bp, Artificial Sequence
  Synthetic
tcctctgacatggggaagag

SEQ ID NO: 11 - DNA, 20 bp, Artificial Sequence
  Synthetic
gtaggccaccaggtgtgaag

SEQ ID NO: 12 - DNA, 20 bp, Artificial Sequence
  Synthetic
catcgtcccctagagacagc

SEQ ID NO: 13 - DNA, 19 bp, Artificial Sequence
  Synthetic
gcgacgtggtatcaagcag

SEQ ID NO: 14 - DNA, 21 bp, Artificial Sequence
  Synthetic
gtctggtgccatggagagtag

SEQ ID NO: 15 - DNA, 19 bp, Artificial Sequence
  Synthetic
tctgagactttccaggccc

SEQ ID NO: 16 - DNA, 19 bp, Artificial Sequence
  Synthetic
cttggggcacagagaggac

SEQ ID NO: 17 - DNA, 18 bp, Artificial Sequence
  Synthetic
ccttgatgccgagtcctg

SEQ ID NO: 18 - DNA, 20 bp, Artificial Sequence
  Synthetic
cctgaggctttggagatcag

SEQ ID NO: 19 - DNA, 19 bp, Artificial Sequence
  Synthetic
ggccctacatcacaggagg

SEQ ID NO: 20 - DNA, 20 bp, Artificial Sequence
  Synthetic
agtgtggatatgtggggagc

SEQ ID NO: 21 - DNA, 20 bp, Artificial Sequence
  Synthetic
atccaggtgctttgaaggtc

SEQ ID NO: 22 - DNA, 20 bp, Artificial Sequence
  Synthetic
cattggcactctccaaaagg

SEQ ID NO: 23 - DNA, 20 bp, Artificial Sequence
  Synthetic
gtccctgtgtcaatctgtgg

SEQ ID NO: 24 - DNA, 19 bp, Artificial Sequence
  Synthetic
ctggctgacagagtgaggg

SEQ ID NO: 25 - DNA, 20 bp, Artificial Sequence
  Synthetic
ggaacgcatcgatagctctg

SEQ ID NO: 26 - DNA, 20 bp, Artificial Sequence
  Synthetic
ccctaattcattcactcgcc

SEQ ID NO: 27 - DNA, 21 bp, Artificial Sequence
  Synthetic
cgatacacgtctgcagtcaac

SEQ ID NO: 28 - DNA, 21 bp, Artificial Sequence
  Synthetic
tggtcctgcaccagtaatatg

SEQ ID NO: 29 - DNA, 20 bp, Artificial Sequence
  Synthetic
ttgtccgtcatctttggagc

SEQ ID NO: 30 - DNA, 20 bp, Artificial Sequence
  Synthetic
tgcatggcattagcaaagac

SEQ ID NO: 31 - DNA, 21 bp, Artificial Sequence
  Synthetic
gttgtggacaggttttgaaag

SEQ ID NO: 32 - DNA, 21 bp, Artificial Sequence
  Synthetic
ggattaagaagcaatgccctc

SEQ ID NO: 33 - DNA, 20 bp, Artificial Sequence
  Synthetic
ctgtacacatgaagccatcg

SEQ ID NO: 34 - DNA, 18 bp, Artificial Sequence
  Synthetic
cagtctgcatggagcagg

SEQ ID NO: 35 - DNA, 17 bp, Artificial Sequence
  Synthetic
gctgaggtgtcgggctg

SEQ ID NO: 36 - DNA, 17 bp, Artificial Sequence
  Synthetic
gagtctccggcacccac

SEQ ID NO: 37 - DNA, 19 bp, Artificial Sequence
  Synthetic
tttctgctttgggacaacc

SEQ ID NO: 38 - DNA, 27 bp, Artificial Sequence
  Synthetic
tttaagattacgaaggtattggtttag

SEQ ID NO: 39 - DNA, 23 bp, Artificial Sequence
  Synthetic
aatctacagagttccctgtttgc

SEQ ID NO: 40 - DNA, 21 bp, Artificial Sequence
  Synthetic
tcagtataagcagtccctgcc

SEQ ID NO: 41 - DNA, 22 bp, Artificial Sequence
  Synthetic
acttgttgaaatttctcccttg

SEQ ID NO: 42 - DNA, 18 bp, Artificial Sequence
  Synthetic
cagagcctgcagtgagcc

SEQ ID NO: 43 - DNA, 26 bp, Artificial Sequence
  Synthetic
tagaactacagtttcaaaagttgacc

SEQ ID NO: 44 - DNA, 20 bp, Artificial Sequence
  Synthetic
cggagatttggatgttctcc

SEQ ID NO: 45 - DNA, 20 bp, Artificial Sequence
  Synthetic
aaggcagcaactaattttgg

SEQ ID NO: 46 - DNA, 26 bp, Artificial Sequence
  Synthetic
ctgctaaacactaatataacctttgg

SEQ ID NO: 47 - DNA, 21 bp, Artificial Sequence
  Synthetic
tggttgatctttgtcttcgtg

SEQ ID NO: 48 - DNA, 22 bp, Artificial Sequence
  Synthetic
ttcaatcagcggtataatcagg

SEQ ID NO: 49 - DNA, 20 bp, Artificial Sequence
  Synthetic
tggggaagaaaagtgttttg

SEQ ID NO: 50 - DNA, 27 bp, Artificial Sequence
  Synthetic
agagaaagtatctacctaaatccacag

SEQ ID NO: 51 - DNA, 25 bp, Artificial Sequence
  Synthetic
cctgtctctgaaaataaagtcttgc

SEQ ID NO: 52 - DNA, 20 bp, Artificial Sequence
  Synthetic
tgctgagatcagccaaattc

SEQ ID NO: 53 - DNA, 21 bp, Artificial Sequence
  Synthetic
catgtcaaccttttgaacagc

SEQ ID NO: 54 - DNA, 27 bp, Artificial Sequence
  Synthetic
tgagagaaaacaatttaagtgacatac

SEQ ID NO: 55 - DNA, 23 bp, Artificial Sequence
  Synthetic
ggctcattcacaactatctttcc

SEQ ID NO: 56 - DNA, 24 bp, Artificial Sequence
  Synthetic
aaactcttccagccaaacataaac

SEQ ID NO: 57 - DNA, 23 bp, Artificial Sequence
  Synthetic
caggaactacctgaaactcatgg

SEQ ID NO: 58 - DNA, 21 bp, Artificial Sequence
  Synthetic
gggcttctaaacaactctgcc

SEQ ID NO: 59 - DNA, 22 bp, Artificial Sequence
  Synthetic
ctgctctgtgttgtagaaaccc

SEQ ID NO: 60 - DNA, 24 bp, Artificial Sequence
  Synthetic
tctcaagattttatccagaaaagg

SEQ ID NO: 61 - DNA, 27 bp, Artificial Sequence
  Synthetic
ggtgaaagttgtaaatctttgtaacac

SEQ ID NO: 62 - DNA, 26 bp, Artificial Sequence
  Synthetic
agatagctaaattcatgcatcataag

SEQ ID NO: 63 - DNA, 19 bp, Artificial Sequence
  Synthetic
aaaaccatgtgatggcgtg

SEQ ID NO: 64 - DNA, 20 bp, Artificial Sequence
  Synthetic
cactccagaggcagtagcag

SEQ ID NO: 65 - DNA, 21 bp, Artificial Sequence
  Synthetic
gaaaggcagtaaaggtcatgc

SEQ ID NO: 66 - DNA, 27 bp, Artificial Sequence
  Synthetic
tgttctaactcagaggaatacacaaac

SEQ ID NO: 67 - DNA, 20 bp, Artificial Sequence
  Synthetic
aaatggaaacttgcaccctg

SEQ ID NO: 68 - DNA, 18 bp, Artificial Sequence
  Synthetic
acaggcatgaaccaccac

SEQ ID NO: 69 - DNA, 22 bp, Artificial Sequence
  Synthetic
cgaaagcctctctaattttgtg

SEQ ID NO: 70 - DNA, 20 bp, Artificial Sequence
  Synthetic
cctatgcaatcggtctttgc

SEQ ID NO: 71 - DNA, 20 bp, Artificial Sequence
  Synthetic
gagtcgcctgtcaccatttc

SEQ ID NO: 72 - DNA, 20 bp, Artificial Sequence
  Synthetic
atccgtctactcccacgttc

SEQ ID NO: 73 - DNA, 24 bp, Artificial Sequence
  Synthetic
tttagtttgattgctgcatatttc

SEQ ID NO: 74 - DNA, 22 bp, Artificial Sequence
  Synthetic
agtccattaggtacggtaagcc

SEQ ID NO: 75 - DNA, 22 bp, Artificial Sequence
  Synthetic
aaacccatagaaggggtatttg

SEQ ID NO: 76 - DNA, 22 bp, Artificial Sequence
  Synthetic
tctgtgccaacaatgttttacc

SEQ ID NO: 77 - DNA, 24 bp, Artificial Sequence
  Synthetic
aaagattcaggcaatgtttgttag

SEQ ID NO: 78 - DNA, 25 bp, Artificial Sequence
  Synthetic
tgacagtaagatacagtctatcggg

SEQ ID NO: 79 - DNA, 26 bp, Artificial Sequence
  Synthetic
ggaatccagtgtttcttttaaatacc

SEQ ID NO: 80 - DNA, 21 bp, Artificial Sequence
  Synthetic
tcagatccaggaagaggaaag

SEQ ID NO: 81 - DNA, 20 bp, Artificial Sequence
  Synthetic
atggctacgacccagttacc

SEQ ID NO: 82 - DNA, 23 bp, Artificial Sequence
  Synthetic
aaactgttccaatacatggaagg

SEQ ID NO: 83 - DNA, 21 bp, Artificial Sequence
  Synthetic
cagttaaaggcatttcctgtg

SEQ ID NO: 84 - DNA, 21 bp, Artificial Sequence
  Synthetic
ctcaccaatgccagagtaagc

SEQ ID NO: 85 - DNA, 22 bp, Artificial Sequence
  Synthetic
gcaacagataactcagattgcc

SEQ ID NO: 86 - DNA, 22 bp, Artificial Sequence
  Synthetic
gtcaagcaagttcttcatcagc

SEQ ID NO: 87 - DNA, 19 bp, Artificial Sequence
  Synthetic
agcttggcaacagagcaag

SEQ ID NO: 88 - DNA, 20 bp, Artificial Sequence
  Synthetic
ccacaagtgcaaaggggtag

SEQ ID NO: 89 - DNA, 20 bp, Artificial Sequence
  Synthetic
ctcctccccaactccatttc

SEQ ID NO: 90 - DNA, 20 bp, Artificial Sequence
  Synthetic
caagcttccatcccactcac

SEQ ID NO: 91 - DNA, 19 bp, Artificial Sequence
  Synthetic
ctcagacactggcatggtg

SEQ ID NO: 92 - DNA, 20 bp, Artificial Sequence
  Synthetic
tgggtgaaaagagcagtcag

SEQ ID NO: 93 - DNA, 20 bp, Artificial Sequence
  Synthetic
cgttctggtaaggacaaggg

SEQ ID NO: 94 - DNA, 21 bp, Artificial Sequence
  Synthetic
aggaatcccaaagttccaaac

SEQ ID NO: 95 - DNA, 20 bp, Artificial Sequence
  Synthetic
tcacttgtgccctgactttc

SEQ ID NO: 96 - DNA, 21 bp, Artificial Sequence
  Synthetic
tcatggggttatagggaggtc

SEQ ID NO: 97 - DNA, 18 bp, Artificial Sequence
  Synthetic
tgcttgccacaggtctcc

SEQ ID NO: 98 - DNA, 20 bp, Artificial Sequence
  Synthetic
agcagtaaggagattccccg

SEQ ID NO: 99 - DNA, 20 bp, Artificial Sequence
  Synthetic
tggttgggagtagatggagc

SEQ ID NO: 100 - DNA, 20 bp, Artificial Sequence
  Synthetic
accaggagccattgtctttg

SEQ ID NO: 101 - DNA, 25 bp, Artificial Sequence
  Synthetic
aacttgaaccatcttttaactcagg

SEQ ID NO: 102 - DNA, 20 bp, Artificial Sequence
  Synthetic
agctgcctttgaccatgaag

SEQ ID NO: 103 - DNA, 20 bp, Artificial Sequence
  Synthetic
gatttgaattcccgttgtcc

SEQ ID NO: 104 - DNA, 21 bp, Artificial Sequence
  Synthetic
cagcatttcacagatatgggc

SEQ ID NO: 105 - DNA, 67 bp, Artificial Sequence
  Synthetic
agatcggaagagcgtaatgatacggcgaccaccgacactctttccctacacgacgctcttccgatct

SEQ ID NO: 106 - DNA, 49 bp, Artificial Sequence
  Synthetic
agatcggaagagctcgtatgccgtcttctgcttggagctcttccgatct

SEQ ID NO: 107 - DNA, 49 bp, Artificial Sequence
  Synthetic
agatcggaagagctccaagcagaagacggcatacgagctcttccgatct

SEQ ID NO: 108 - DNA, 73 bp, Artificial Sequence
  Synthetic
tttagatcggaagagcgtaatgatacggcgaccaccgacactctttccctacacgacgctcttccgatctaaa

SEQ ID NO: 109 - DNA, 20 bp, Artificial Sequence
  Synthetic
aatgatacggcgaccaccga

SEQ ID NO: 110 - DNA, 20 bp, Artificial Sequence
  Synthetic
caagcagaagacggcatacg

SEQ ID NO: 111 - DNA, 50 bp, Artificial Sequence
  Synthetic
tgggctcggggagcgccagcctgagaggagcgcgtgagcgtcgcgggagc

SEQ ID NO: 112 - DNA, 50 bp, Artificial Sequence
  Synthetic
aaccctccttcacaatagccacgtcgctcatggtgcccgaggctcccgcg

SEQ ID NO: 113 - DNA, 50 bp, Artificial Sequence
  Synthetic
acctggcggccacgctacttcctcctcaagaatgatggcaccttcattgg

SEQ ID NO: 114 - DNA, 50 bp, Artificial Sequence
  Synthetic
gttgaggggagcctcacgttggtccacatcctgcggccgctccttgtagc

SEQ ID NO: 115 - DNA, 50 bp, Artificial Sequence
  Synthetic
ctgatgaagacggagcggccccggcccaacaccttcatcatccgctgcct

SEQ ID NO: 116 - DNA, 50 bp, Artificial Sequence
  Synthetic
ctccacatggaaggtgcgttcgatgacagtggtccactgcaggcagcgga

SEQ ID NO: 117 - DNA, 50 bp, Artificial Sequence
  Synthetic
tgtggctgacggcctcaagaagcaggaggaggaggagatggacttccggt

SEQ ID NO: 118 - DNA, 50 bp, Artificial Sequence
  Synthetic
ccatctcttcagcccctgagttgtcactgggtgagcccgaccggaagtcc

SEQ ID NO: 119 - DNA, 50 bp, Artificial Sequence
  Synthetic
cctgaagctgctgggcaagggcactttcggcaaggtgatcctggtgaagg

SEQ ID NO: 120 - DNA, 50 bp, Artificial Sequence
  Synthetic
tcttgaggatcttcatggcgtagtagcggcctgtggccttctccttcacc

SEQ ID NO: 121 - DNA, 50 bp, Artificial Sequence
  Synthetic
acgaggtggcccacacactcaccgagaaccgcgtcctgcagaactccagg

SEQ ID NO: 122 - DNA, 50 bp, Artificial Sequence
  Synthetic
cactcaccgagaaccgcgtcctgcagaactccaggcaccccttcctcaca

SEQ ID NO: 123 - DNA, 50 bp, Artificial Sequence
  Synthetic
gccctgaagtactctttccagacccacgaccgcctctgctttgtcatgga

SEQ ID NO: 124 - DNA, 50 bp, Artificial Sequence
  Synthetic
agacccacgaccgcctctgctttgtcatggagtacgccaacgggggcgag

SEQ ID NO: 125 - DNA, 50 bp, Artificial Sequence
  Synthetic
cgggagcgtgtgttctccgaggaccgggcccgcttctatggcgctgagat

SEQ ID NO: 126 - DNA, 50 bp, Artificial Sequence
  Synthetic
cacgttcttctccgagtgcaggtagtccagggctgacacaatctcagcgc

SEQ ID NO: 127 - DNA, 50 bp, Artificial Sequence
  Synthetic
atgctggacaaggacgggcacattaagatcacagacttcgggctgtgcaa

SEQ ID NO: 128 - DNA, 50 bp, Artificial Sequence
  Synthetic
ggtgtgccgcaaaaggtcttcatggtggcaccgtccttgatcccctcctt

SEQ ID NO: 129 - DNA, 50 bp, Artificial Sequence
  Synthetic
agtggactggtgggggctgggcgtggtcatgtacgagatgatgtgcggtc

SEQ ID NO: 130 - DNA, 50 bp, Artificial Sequence
  Synthetic
catgaggatgagctcaaaaagcttctcatggtcctggttgtagaagggca

SEQ ID NO: 131 - DNA, 50 bp, Artificial Sequence
  Synthetic
agatccgcttcccgcgcacgcttggtcccgaggccaagtccttgctttca

SEQ ID NO: 132 - DNA, 50 bp, Artificial Sequence
  Synthetic
gcttggcgggggctccgaggacgccaaggagatcatgcagcatcgcttct

SEQ ID NO: 133 - DNA, 50 bp, Artificial Sequence
  Synthetic
cttcttctcgtacacgtgctgccacacgataccggcaaagaagcgatgct

SEQ ID NO: 134 - DNA, 50 bp, Artificial Sequence
  Synthetic
cccacccttcaagccccaggtcacgtcggagactgacaccaggtattttg

SEQ ID NO: 135 - DNA, 50 bp, Artificial Sequence
  Synthetic
ggtcaggtggtgtgatggtgatcatctgggccgtgaactcctcatcaaaa

SEQ ID NO: 136 - DNA, 50 bp, Artificial Sequence
  Synthetic
atgacagcatggagtgtgtggacagcgagcgcaggccccacttcccccag

SEQ ID NO: 137 - DNA, 50 bp, Artificial Sequence
  Synthetic
gcgcagtccaccgccgcctcaggccgtgccgctggccgagtaggagaact

SEQ ID NO: 138 - DNA, 50 bp, Artificial Sequence
  Synthetic
tgaaaatgactgaatataaacttgtggtagttggagctggtggcgtaggc

SEQ ID NO: 139 - DNA, 50 bp, Artificial Sequence
  Synthetic
attcgtccacaaaatgattctgaattagctgtatcgtcaaggcactcttg

SEQ ID NO: 140 - DNA, 50 bp, Artificial Sequence
  Synthetic
gtctcttggatattctcgacacagcaggtcaagaggagtacagtgcaatg

SEQ ID NO: 141 - DNA, 50 bp, Artificial Sequence
  Synthetic
tggcaaatacacaaagaaagccctccccagtcctcatgtactggtccctc

SEQ ID NO: 142 - DNA, 50 bp, Artificial Sequence
  Synthetic
tgtacctatggtcctagtaggaaataaatgtgatttgccttctagaacag

SEQ ID NO: 143 - DNA, 50 bp, Artificial Sequence
  Synthetic
aggaattccataacttcttgctaagtcctgagcctgttttgtgtctactg

SEQ ID NO: 144 - DNA, 50 bp, Artificial Sequence
  Synthetic
tgccttctatacattagttcgagaaattcgaaaacataaagaaaagatga

SEQ ID NO: 145 - DNA, 50 bp, Artificial Sequence
  Synthetic
ttacacactttgtctttgacttctttttcttctttttaccatctttgctc

SEQ ID NO: 146 - DNA, 50 bp, Artificial Sequence
  Synthetic
ttgatgcccccaagaatcctagtagaatgtttactaccaaatggaatgat

SEQ ID NO: 147 - DNA, 50 bp, Artificial Sequence
  Synthetic
ctttatggttattaatgtagcctcacggaggcattctaaagtcactatca

SEQ ID NO: 148 - DNA, 50 bp, Artificial Sequence
  Synthetic
gtgttactcaagaagcagaaagggaagaattttttgatgaaacaagacga

SEQ ID NO: 149 - DNA, 50 bp, Artificial Sequence
  Synthetic
gttcaattacttttaaaaagggttgaaaaagccgaaggtcacaaagtcgt

SEQ ID NO: 150 - DNA, 50 bp, Artificial Sequence
  Synthetic
aggacttccgaagaaatattctgaacgtttgtaaagaagctgtggatctt

SEQ ID NO: 151 - DNA, 50 bp, Artificial Sequence
  Synthetic
gaggatagacatacattgctctactatgaggtgaattgaggtccctaaga

SEQ ID NO: 152 - DNA, 50 bp, Artificial Sequence
  Synthetic
aaataatgacaagcagaagtatactctgaaaatcaaccatgactgtgtac

SEQ ID NO: 153 - DNA, 50 bp, Artificial Sequence
  Synthetic
gttcagaggatagcaacatacttcgagtttttttcctgattgcttcagca

SEQ ID NO: 154 - DNA, 50 bp, Artificial Sequence
  Synthetic
gttttagaatatcagggcaagtatattttaaaagtgtgtggatgtgatga

SEQ ID NO: 155 - DNA, 50 bp, Artificial Sequence
  Synthetic
caatttgatgttgatggctaaagaaagcctttattctcaactgccaatgg

SEQ ID NO: 156 - DNA, 50 bp, Artificial Sequence
  Synthetic
ctccattcatatatggtgtagctgtggaaatgcgtctggaataagatggc

SEQ ID NO: 157 - DNA, 50 bp, Artificial Sequence
  Synthetic
atccctttgggttataaatagtgcactcagaataaaaattctttgtgcaa

SEQ ID NO: 158 - DNA, 50 bp, Artificial Sequence
  Synthetic
atctatgttcgaacaggtatctaccatggaggagaacccttatgtgacaa

SEQ ID NO: 159 - DNA, 50 bp, Artificial Sequence
  Synthetic
ctgggattggaacaaggtactctttgagtgttcacattgtcacataaggg

SEQ ID NO: 160 - DNA, 50 bp, Artificial Sequence
  Synthetic
atgaatggctgaattatgatatatacattcctgatcttcctcgtgctgct

SEQ ID NO: 161 - DNA, 50 bp, Artificial Sequence
  Synthetic
tagcaccctttcggcctttaacagagcaaatggaaaggcaaagtcgagca

SEQ ID NO: 162 - DNA, 50 bp, Artificial Sequence
  Synthetic
taaacttgtttgattacacagacactctagtatctggaaaaatggctttg

SEQ ID NO: 163 - DNA, 50 bp, Artificial Sequence
  Synthetic
tagggttcagcaaatcttctaatccatgaggtactggccaaagattcaaa

SEQ ID NO: 164 - DNA, 50 bp, Artificial Sequence
  Synthetic
ggagtttgactggttcagcagtgtggtaaagttcccagatatgtcagtga

SEQ ID NO: 165 - DNA, 50 bp, Artificial Sequence
  Synthetic
taaatcctgcttctcgggatacagaccaattggcatgctcttcaatcact

SEQ ID NO: 166 - DNA, 50 bp, Artificial Sequence
  Synthetic
agagacaatgaattaagggaaaatgacaaagaacagctcaaagcaatttc

SEQ ID NO: 167 - DNA, 50 bp, Artificial Sequence
  Synthetic
aaaatctttctcctgctcagtgatttcagagagaggatctcgtgtagaaa

SEQ ID NO: 168 - DNA, 50 bp, Artificial Sequence
  Synthetic
acactattgtgtaactatccccgaaattctacccaaattgcttctgtctg

SEQ ID NO: 169 - DNA, 50 bp, Artificial Sequence
  Synthetic
ccaaattgcttctgtctgttaaatggaattctagagatgaagtagcccag

SEQ ID NO: 170 - DNA, 50 bp, Artificial Sequence
  Synthetic
aacctgaacaggctatggaacttctggactgtaattacccagatcctatg

SEQ ID NO: 171 - DNA, 50 bp, Artificial Sequence
  Synthetic
catctgttaaatatttttccaagcaccgaacagcaaaacctcgaaccata

SEQ ID NO: 172 - DNA, 50 bp, Artificial Sequence
  Synthetic
taaaatatgaacaatatttggataacttgcttgtgagatttttactgaag

SEQ ID NO: 173 - DNA, 50 bp, Artificial Sequence
  Synthetic
aatgccaaaagaaaaagtgcccaatcctttgattagtcaatgctttcttc

SEQ ID NO: 174 - DNA, 50 bp, Artificial Sequence
  Synthetic
gcctgcttttggagtcctattgtcgtgcatgtgggatgtatttgaagcac

SEQ ID NO: 175 - DNA, 50 bp, Artificial Sequence
  Synthetic
cagttaagttaatgagcttttccattgcctcgacttgcctattcaggtgc

SEQ ID NO: 176 - DNA, 50 bp, Artificial Sequence
  Synthetic
gatgaagtttttagttgagcaaatgaggcgaccagatttcatggatgctc

SEQ ID NO: 177 - DNA, 50 bp, Artificial Sequence
  Synthetic
tttcctagttgatgagcagggtttagaggagacagaaagccctgtagagc

SEQ ID NO: 178 - DNA, 50 bp, Artificial Sequence
  Synthetic
cgaattatgtcctctgcaaaaaggccactgtggttgaattgggagaaccc

SEQ ID NO: 179 - DNA, 50 bp, Artificial Sequence
  Synthetic
aaagatgatctcattgttctgaaacagtaactctgacatgatgtctgggt

SEQ ID NO: 180 - DNA, 50 bp, Artificial Sequence
  Synthetic
atttacggcaagatatgctaacacttcaaattattcgtattatggaaaat

SEQ ID NO: 181 - DNA, 50 bp, Artificial Sequence
  Synthetic
attattcgtattatggaaaatatctggcaaaatcaaggtcttgatcttcg

SEQ ID NO: 182 - DNA, 50 bp, Artificial Sequence
  Synthetic
gtgggacttattgaggtggtgcgaaattctcacactattatgcaaattca

SEQ ID NO: 183 - DNA, 50 bp, Artificial Sequence
  Synthetic
tgtgtggctgttgaactgcagtgcacctttcaagccgcctttgcactgaa

SEQ ID NO: 184 - DNA, 50 bp, Artificial Sequence
  Synthetic
ccattgacctgtttacacgttcatgtgctggatactgtgtagctaccttc

SEQ ID NO: 185 - DNA, 50 bp, Artificial Sequence
  Synthetic
ctttcaccatgatgttactattgtgacgatctccaattcccaaaatgaag

SEQ ID NO: 186 - DNA, 50 bp, Artificial Sequence
  Synthetic
tggatcacaagaagaaaaaatttggttataaacgagaacgtgtgccattt

SEQ ID NO: 187 - DNA, 50 bp, Artificial Sequence
  Synthetic
cttgggctcctttactaatcactattaagaaatcctgtgtcaaaacaaat

SEQ ID NO: 188 - DNA, 50 bp, Artificial Sequence
  Synthetic
atgccaatctcttcataaatcttttctcaatgatgcttggctctggaatg

SEQ ID NO: 189 - DNA, 50 bp, Artificial Sequence
  Synthetic
ctcagttttatctaaggctagggtctttcgaatgtatgcaatgtcatcaa

SEQ ID NO: 190 - DNA, 50 bp, Artificial Sequence
  Synthetic
tttcatgaaacaaatgaatgatgcacatcatggtggctggacaacaaaaa

SEQ ID NO: 191 - DNA, 50 bp, Artificial Sequence
  Synthetic
ttcagccacaggctcccagacatgacagccatcatcaaagagatcgttag

SEQ ID NO: 192 - DNA, 50 bp, Artificial Sequence
  Synthetic
ggtcaagtctaagtcgaatccatcctcttgatatctccttttgtttctgc

SEQ ID NO: 193 - DNA, 50 bp, Artificial Sequence
  Synthetic
atatttatccaaacattattgctatgggatttcctgcagaaagacttgaa

SEQ ID NO: 194 - DNA, 50 bp, Artificial Sequence
  Synthetic
cttactacatcatcaatattgttcctgtatacgccttcaagtctttctgc

SEQ ID NO: 195 - DNA, 50 bp, Artificial Sequence
  Synthetic
ttaaggtttttggattcaaagcataaaaaccattacaagatatacaatct

SEQ ID NO: 196 - DNA, 50 bp, Artificial Sequence
  Synthetic
gtttttggattcaaagcataaaaaccattacaagatatacaatctgtaag

SEQ ID NO: 197 - DNA, 50 bp, Artificial Sequence
  Synthetic
ttttagttgtgctgaaagacattatgacaccgccaaatttaattgcagag

SEQ ID NO: 198 - DNA, 50 bp, Artificial Sequence
  Synthetic
ttgtgctgaaagacattatgacaccgccaaatttaattgcagaggtaggt

SEQ ID NO: 199 - DNA, 50 bp, Artificial Sequence
  Synthetic
agctagaacttatcaaacccttttgtgaagatcttgaccaatggctaagt

SEQ ID NO: 200 - DNA, 50 bp, Artificial Sequence
  Synthetic
caccagttcgtccctttccagctttacagtgaattgctgcaacatgattg

SEQ ID NO: 201 - DNA, 50 bp, Artificial Sequence
  Synthetic
gtgcatatttattacatcggggcaaatttttaaaggcacaagaggcccta

SEQ ID NO: 202 - DNA, 50 bp, Artificial Sequence
  Synthetic
gcgctatgtgtattattatagctacctgttaaagaatcatctggattata

SEQ ID NO: 203 - DNA, 50 bp, Artificial Sequence
  Synthetic
ggaatagtttcaaacatcatcttgtgaaacaacagtgccactggtctata

SEQ ID NO: 204 - DNA, 50 bp, Artificial Sequence
  Synthetic
atatattcctccaattcaggacccacacgacgggaagacaagttcatgta

SEQ ID NO: 205 - DNA, 50 bp, Artificial Sequence
  Synthetic
tactttgatatcaccacacacaggtaacggctgagggaactcaaagtaca

SEQ ID NO: 206 - DNA, 50 bp, Artificial Sequence
  Synthetic
tcttcataccaggaccagaggaaacctcagaaaaagtagaaaatggaagt

SEQ ID NO: 207 - DNA, 50 bp, Artificial Sequence
  Synthetic
cttgtcattatctgcacgctctatactgcaaatgctatcgatttcttgat

SEQ ID NO: 208 - DNA, 50 bp, Artificial Sequence
  Synthetic
ctagtacttactttaacaaaaaatgatcttgacaaagcaaataaagacaa

SEQ ID NO: 209 - DNA, 50 bp, Artificial Sequence
  Synthetic
gaggctagcagttcaacttctgtaacaccagatgttagtgacaatgaacc

SEQ ID NO: 210 - DNA, 50 bp, Artificial Sequence
  Synthetic
attctctggatcagagtcagtggtgtcagaatatctataatgatcaggtt

SEQ ID NO: 211 - DNA, 50 bp, Artificial Sequence
  Synthetic
ccagactgccttccgggtcactgccatggaggagccgcagtcagatccta

SEQ ID NO: 212 - DNA, 50 bp, Artificial Sequence
  Synthetic
ttccataggtctgaaaatgtttcctgactcagagggggctcgacgctagg

SEQ ID NO: 213 - DNA, 50 bp, Artificial Sequence
  Synthetic
ggactgactttctgctcttgtctttcagacttcctgaaaacaacgttctg

SEQ ID NO: 214 - DNA, 50 bp, Artificial Sequence
  Synthetic
acttcctgaaaacaacgttctggtaaggacaagggttgggctggggacct

SEQ ID NO: 215 - DNA, 50 bp, Artificial Sequence
  Synthetic
ggacgatattgaacaatggttcactgaagacccaggtccagatgaagctc

SEQ ID NO: 216 - DNA, 50 bp, Artificial Sequence
  Synthetic
ggtgcaggggccgccggtgtaggagctgctggtgcaggggccacgggggg

SEQ ID NO: 217 - DNA, 50 bp, Artificial Sequence
  Synthetic
atcttctgtcccttcccagaaaacctaccagggcagctacggtttccgtc

SEQ ID NO: 218 - DNA, 50 bp, Artificial Sequence
  Synthetic
ctgccctgtgcagctgtgggttgattccacacccccgcccggcacccgcg

SEQ ID NO: 219 - DNA, 50 bp, Artificial Sequence
  Synthetic
acctccgtcatgtgctgtgactgcttgtagatggccatggcgcggacgcg

SEQ ID NO: 220 - DNA, 50 bp, Artificial Sequence
  Synthetic
cctcctcagcatcttatccgagtggaaggaaatttgcgtgtggagtattt

SEQ ID NO: 221 - DNA, 50 bp, Artificial Sequence
  Synthetic
ctcatagggcaccaccacactatgtcgaaaagtgtttctgtcatccaaat

SEQ ID NO: 222 - DNA, 50 bp, Artificial Sequence
  Synthetic
ctgactgtaccaccatccactacaactacatgtgtaacagttcctgcatg

SEQ ID NO: 223 - DNA, 50 bp, Artificial Sequence
  Synthetic
cttccagtgtgatgatggtgaggatgggcctccggttcatgccgcccatg

SEQ ID NO: 224 - DNA, 50 bp, Artificial Sequence
  Synthetic
acagctttgaggtgcgtgtttgtgcctgtcctgggagagaccggcgcaca

SEQ ID NO: 225 - DNA, 50 bp, Artificial Sequence
  Synthetic
gcagctcgtggtgaggctcccctttcttgcggagattctcttcctctgtg

SEQ ID NO: 226 - DNA, 50 bp, Artificial Sequence
  Synthetic
cactgcccaacaacaccagctcctctccccagccaaagaagaaaccactg

SEQ ID NO: 227 - DNA, 50 bp, Artificial Sequence
  Synthetic
ctccccagccaaagaagaaaccactggatggagaatatttcacccttcag

SEQ ID NO: 228 - DNA, 50 bp, Artificial Sequence
  Synthetic
tgggcgtgagcgcttcgagatgttccgagagctgaatgaggccttggaac

SEQ ID NO: 229 - DNA, 50 bp, Artificial Sequence
  Synthetic
tgagccctgctcccccctggctccttcccagcctgggcatccttgagttc

SEQ ID NO: 230 - DNA, 50 bp, Artificial Sequence
  Synthetic
ccacctgaagtccaaaaagggtcagtctacctcccgccataaaaaactca

SEQ ID NO: 231 - DNA, 50 bp, Artificial Sequence
  Synthetic
agaagtggagaatgtcagtctgagtcaggcccttctgtcttgaacatgag

SEQ ID NO: 232 - DNA, 34 bp, Artificial Sequence
  Synthetic
taattgctcgaaggggtccacatccgccacgcgt

SEQ ID NO: 233 - DNA, 34 bp, Artificial Sequence
  Synthetic
acgcgtggcggatgtggaccccttcgagcaatta

SEQ ID NO: 234 - DNA, 69 bp, Artificial Sequence
  Synthetic
tgggctcggggagcgccagcctgagaggagcgcgtacgcgtggcggatgtggaccccttcgagcaatta

SEQ ID NO: 235 - DNA, 69 bp, Artificial Sequence
  Synthetic
aaccctccttcacaatagccacgtcgctcatggtgacgcgtggcggatgtggaccccttcgagcaatta

SEQ ID NO: 236 - DNA, 69 bp, Artificial Sequence
  Synthetic
acctggcggccacgctacttcctcctcaagaatgaacgcgtggcggatgtggaccccttcgagcaatta

SEQ ID NO: 237 - DNA, 69 bp, Artificial Sequence
  Synthetic
gttgaggggagcctcacgttggtccacatcctgcgacgcgtggcggatgtggaccccttcgagcaatta

SEQ ID NO: 238 - DNA, 69 bp, Artificial Sequence
  Synthetic
ctgatgaagacggagcggccccggcccaacaccttacgcgtggcggatgtggaccccttcgagcaatta

SEQ ID NO: 239 - DNA, 69 bp, Artificial Sequence
  Synthetic
ctccacatggaaggtgcgttcgatgacagtggtccacgcgtggcggatgtggaccccttcgagcaatta

SEQ ID NO: 240 - DNA, 69 bp, Artificial Sequence
  Synthetic
tgtggctgacggcctcaagaagcaggaggaggaggacgcgtggcggatgtggaccccttcgagcaatta

SEQ ID NO: 241 - DNA, 69 bp, Artificial Sequence
  Synthetic
ccatctcttcagcccctgagttgtcactgggtgagacgcgtggcggatgtggaccccttcgagcaatta

SEQ ID NO: 242 - DNA, 69 bp, Artificial Sequence
  Synthetic
cctgaagctgctgggcaagggcactttcggcaaggacgcgtggcggatgtggaccccttcgagcaatta

SEQ ID NO: 243 - DNA, 69 bp, Artificial Sequence
  Synthetic
tcttgaggatcttcatggcgtagtagcggcctgtgacgcgtggcggatgtggaccccttcgagcaatta

SEQ ID NO: 244 - DNA, 69 bp, Artificial Sequence
  Synthetic
acgaggtggcccacacactcaccgagaaccgcgtcacgcgtggcggatgtggaccccttcgagcaatta

SEQ ID NO: 245 - DNA, 69 bp, Artificial Sequence
  Synthetic
cactcaccgagaaccgcgtcctgcagaactccaggacgcgtggcggatgtggaccccttcgagcaatta

SEQ ID NO: 246 - DNA, 69 bp, Artificial Sequence
  Synthetic
gccctgaagtactctttccagacccacgaccgcctacgcgtggcggatgtggaccccttcgagcaatta

SEQ ID NO: 247 - DNA, 69 bp, Artificial Sequence
  Synthetic
agacccacgaccgcctctgctttgtcatggagtacacgcgtggcggatgtggaccccttcgagcaatta

SEQ ID NO: 248 - DNA, 69 bp, Artificial Sequence
  Synthetic
cgggagcgtgtgttctccgaggaccgggcccgcttacgcgtggcggatgtggaccccttcgagcaatta

SEQ ID NO: 249 - DNA, 69 bp, Artificial Sequence
  Synthetic
cacgttcttctccgagtgcaggtagtccagggctgacgcgtggcggatgtggaccccttcgagcaatta

SEQ ID NO: 250 - DNA, 69 bp, Artificial Sequence
  Synthetic
atgctggacaaggacgggcacattaagatcacagaacgcgtggcggatgtggaccccttcgagcaatta

SEQ ID NO: 251 - DNA, 69 bp, Artificial Sequence
  Synthetic
ggtgtgccgcaaaaggtcttcatggtggcaccgtcacgcgtggcggatgtggaccccttcgagcaatta

SEQ ID NO: 252 - DNA, 69 bp, Artificial Sequence
  Synthetic
agtggactggtgggggctgggcgtggtcatgtacgacgcgtggcggatgtggaccccttcgagcaatta

SEQ ID NO: 253 - DNA, 69 bp, Artificial Sequence
  Synthetic
catgaggatgagctcaaaaagcttctcatggtcctacgcgtggcggatgtggaccccttcgagcaatta

SEQ ID NO: 254 - DNA, 69 bp, Artificial Sequence
  Synthetic
agatccgcttcccgcgcacgcttggtcccgaggccacgcgtggcggatgtggaccccttcgagcaatta

SEQ ID NO: 255 - DNA, 69 bp, Artificial Sequence
  Synthetic
gcttggcgggggctccgaggacgccaaggagatcaacgcgtggcggatgtggaccccttcgagcaatta

SEQ ID NO: 256 - DNA, 69 bp, Artificial Sequence
  Synthetic
cttcttctcgtacacgtgctgccacacgataccggacgcgtggcggatgtggaccccttcgagcaatta

SEQ ID NO: 257 - DNA, 69 bp, Artificial Sequence
  Synthetic
cccacccttcaagccccaggtcacgtcggagactgacgcgtggcggatgtggaccccttcgagcaatta

SEQ ID NO: 258 - DNA, 69 bp, Artificial Sequence
  Synthetic
ggtcaggtggtgtgatggtgatcatctgggccgtgacgcgtggcggatgtggaccccttcgagcaatta

SEQ ID NO: 259 - DNA, 69 bp, Artificial Sequence
  Synthetic
atgacagcatggagtgtgtggacagcgagcgcaggacgcgtggcggatgtggaccccttcgagcaatta

SEQ ID NO: 260 - DNA, 69 bp, Artificial Sequence
  Synthetic
gcgcagtccaccgccgcctcaggccgtgccgctggacgcgtggcggatgtggaccccttcgagcaatta

SEQ ID NO: 261 - DNA, 69 bp, Artificial Sequence
  Synthetic
tgaaaatgactgaatataaacttgtggtagttggaacgcgtggcggatgtggaccccttcgagcaatta

SEQ ID NO: 262 - DNA, 69 bp, Artificial Sequence
  Synthetic
attcgtccacaaaatgattctgaattagctgtatcacgcgtggcggatgtggaccccttcgagcaatta

SEQ ID NO: 263 - DNA, 69 bp, Artificial Sequence
  Synthetic
gtctcttggatattctcgacacagcaggtcaagagacgcgtggcggatgtggaccccttcgagcaatta

SEQ ID NO: 264 - DNA, 69 bp, Artificial Sequence
  Synthetic
tggcaaatacacaaagaaagccctccccagtcctcacgcgtggcggatgtggaccccttcgagcaatta

SEQ ID NO: 265 - DNA, 69 bp, Artificial Sequence
  Synthetic
tgtacctatggtcctagtaggaaataaatgtgattacgcgtggcggatgtggaccccttcgagcaatta

SEQ ID NO: 266 - DNA, 69 bp, Artificial Sequence
  Synthetic
aggaattccataacttcttgctaagtcctgagcctacgcgtggcggatgtggaccccttcgagcaatta

SEQ ID NO: 267 - DNA, 69 bp, Artificial Sequence
  Synthetic
tgccttctatacattagttcgagaaattcgaaaacacgcgtggcggatgtggaccccttcgagcaatta

SEQ ID NO: 268 - DNA, 69 bp, Artificial Sequence
  Synthetic
ttacacactttgtctttgacttctttttcttctttacgcgtggcggatgtggaccccttcgagcaatta

SEQ ID NO: 269 - DNA, 69 bp, Artificial Sequence
  Synthetic
ttgatgcccccaagaatcctagtagaatgtttactacgcgtggcggatgtggaccccttcgagcaatta

SEQ ID NO: 270 - DNA, 69 bp, Artificial Sequence
  Synthetic
ctttatggttattaatgtagcctcacggaggcattacgcgtggcggatgtggaccccttcgagcaatta

SEQ ID NO: 271 - DNA, 69 bp, Artificial Sequence
  Synthetic
gtgttactcaagaagcagaaagggaagaattttttacgcgtggcggatgtggaccccttcgagcaatta

SEQ ID NO: 272 - DNA, 69 bp, Artificial Sequence
  Synthetic
gttcaattacttttaaaaagggttgaaaaagccgaacgcgtggcggatgtggaccccttcgagcaatta

SEQ ID NO: 273 - DNA, 69 bp, Artificial Sequence
  Synthetic
aggacttccgaagaaatattctgaacgtttgtaaaacgcgtggcggatgtggaccccttcgagcaatta

SEQ ID NO: 274 - DNA, 69 bp, Artificial Sequence
  Synthetic
gaggatagacatacattgctctactatgaggtgaaacgcgtggcggatgtggaccccttcgagcaatta

SEQ ID NO: 275 - DNA, 69 bp, Artificial Sequence
  Synthetic
aaataatgacaagcagaagtatactctgaaaatcaacgcgtggcggatgtggaccccttcgagcaatta

SEQ ID NO: 276 - DNA, 69 bp, Artificial Sequence
  Synthetic
gttcagaggatagcaacatacttcgagtttttttcacgcgtggcggatgtggaccccttcgagcaatta

SEQ ID NO: 277 - DNA, 69 bp, Artificial Sequence
  Synthetic
gttttagaatatcagggcaagtatattttaaaagtacgcgtggcggatgtggaccccttcgagcaatta

SEQ ID NO: 278 - DNA, 69 bp, Artificial Sequence
  Synthetic
caatttgatgttgatggctaaagaaagcctttattacgcgtggcggatgtggaccccttcgagcaatta

SEQ ID NO: 279 - DNA, 69 bp, Artificial Sequence
  Synthetic
ctccattcatatatggtgtagctgtggaaatgcgtacgcgtggcggatgtggaccccttcgagcaatta

SEQ ID NO: 280 - DNA, 69 bp, Artificial Sequence
  Synthetic
atccctttgggttataaatagtgcactcagaataaacgcgtggcggatgtggaccccttcgagcaatta

SEQ ID NO: 281 - DNA, 69 bp, Artificial Sequence
  Synthetic
atctatgttcgaacaggtatctaccatggaggagaacgcgtggcggatgtggaccccttcgagcaatta

SEQ ID NO: 282 - DNA, 69 bp, Artificial Sequence
  Synthetic
ctgggattggaacaaggtactctttgagtgttcacacgcgtggcggatgtggaccccttcgagcaatta

SEQ ID NO: 283 - DNA, 69 bp, Artificial Sequence
  Synthetic
atgaatggctgaattatgatatatacattcctgatacgcgtggcggatgtggaccccttcgagcaatta

SEQ ID NO: 284 - DNA, 69 bp, Artificial Sequence
  Synthetic
tagcaccctttcggcctttaacagagcaaatggaaacgcgtggcggatgtggaccccttcgagcaatta

SEQ ID NO: 285 - DNA, 69 bp, Artificial Sequence
  Synthetic
taaacttgtttgattacacagacactctagtatctacgcgtggcggatgtggaccccttcgagcaatta

SEQ ID NO: 286 - DNA, 69 bp, Artificial Sequence
  Synthetic
tagggttcagcaaatcttctaatccatgaggtactacgcgtggcggatgtggaccccttcgagcaatta

SEQ ID NO: 287 - DNA, 69 bp, Artificial Sequence
  Synthetic
ggagtttgactggttcagcagtgtggtaaagttccacgcgtggcggatgtggaccccttcgagcaatta

SEQ ID NO: 288 - DNA, 69 bp, Artificial Sequence
  Synthetic
taaatcctgcttctcgggatacagaccaattggcaacgcgtggcggatgtggaccccttcgagcaatta

SEQ ID NO: 289 - DNA, 69 bp, Artificial Sequence
  Synthetic
agagacaatgaattaagggaaaatgacaaagaacaacgcgtggcggatgtggaccccttcgagcaatta

SEQ ID NO: 290 - DNA, 69 bp, Artificial Sequence
  Synthetic
aaaatctttctcctgctcagtgatttcagagagagacgcgtggcggatgtggaccccttcgagcaatta

SEQ ID NO: 291 - DNA, 69 bp, Artificial Sequence
  Synthetic
acactattgtgtaactatccccgaaattctacccaacgcgtggcggatgtggaccccttcgagcaatta

SEQ ID NO: 292 - DNA, 69 bp, Artificial Sequence
  Synthetic
ccaaattgcttctgtctgttaaatggaattctagaacgcgtggcggatgtggaccccttcgagcaatta

SEQ ID NO: 293 - DNA, 69 bp, Artificial Sequence
  Synthetic
aacctgaacaggctatggaacttctggactgtaatacgcgtggcggatgtggaccccttcgagcaatta

SEQ ID NO: 294 - DNA, 69 bp, Artificial Sequence
  Synthetic
catctgttaaatatttttccaagcaccgaacagcaacgcgtggcggatgtggaccccttcgagcaatta

SEQ ID NO: 295 - DNA, 69 bp, Artificial Sequence
  Synthetic
taaaatatgaacaatatttggataacttgcttgtgacgcgtggcggatgtggaccccttcgagcaatta

SEQ ID NO: 296 - DNA, 69 bp, Artificial Sequence
  Synthetic
aatgccaaaagaaaaagtgcccaatcctttgattaacgcgtggcggatgtggaccccttcgagcaatta

SEQ ID NO: 297 - DNA, 69 bp, Artificial Sequence
  Synthetic
gcctgcttttggagtcctattgtcgtgcatgtgggacgcgtggcggatgtggaccccttcgagcaatta

SEQ ID NO: 298 - DNA, 69 bp, Artificial Sequence
  Synthetic
cagttaagttaatgagcttttccattgcctcgactacgcgtggcggatgtggaccccttcgagcaatta

SEQ ID NO: 299 - DNA, 69 bp, Artificial Sequence
  Synthetic
gatgaagtttttagttgagcaaatgaggcgaccagacgcgtggcggatgtggaccccttcgagcaatta

SEQ ID NO: 300 - DNA, 69 bp, Artificial Sequence
  Synthetic
tttcctagttgatgagcagggtttagaggagacagacgcgtggcggatgtggaccccttcgagcaatta

SEQ ID NO: 301 - DNA, 69 bp, Artificial Sequence
  Synthetic
cgaattatgtcctctgcaaaaaggccactgtggttacgcgtggcggatgtggaccccttcgagcaatta

SEQ ID NO: 302 - DNA, 69 bp, Artificial Sequence
  Synthetic
aaagatgatctcattgttctgaaacagtaactctgacgcgtggcggatgtggaccccttcgagcaatta

SEQ ID NO: 303 - DNA, 69 bp, Artificial Sequence
  Synthetic
atttacggcaagatatgctaacacttcaaattattacgcgtggcggatgtggaccccttcgagcaatta

SEQ ID NO: 304 - DNA, 69 bp, Artificial Sequence
  Synthetic
attattcgtattatggaaaatatctggcaaaatcaacgcgtggcggatgtggaccccttcgagcaatta

SEQ ID NO: 305 - DNA, 69 bp, Artificial Sequence
  Synthetic
gtgggacttattgaggtggtgcgaaattctcacacacgcgtggcggatgtggaccccttcgagcaatta

SEQ ID NO: 306 - DNA, 69 bp, Artificial Sequence
  Synthetic
tgtgtggctgttgaactgcagtgcacctttcaagcacgcgtggcggatgtggaccccttcgagcaatta

SEQ ID NO: 307 - DNA, 69 bp, Artificial Sequence
  Synthetic
ccattgacctgtttacacgttcatgtgctggatacacgcgtggcggatgtggaccccttcgagcaatta

SEQ ID NO: 308 - DNA, 69 bp, Artificial Sequence
  Synthetic
ctttcaccatgatgttactattgtgacgatctccaacgcgtggcggatgtggaccccttcgagcaatta

SEQ ID NO: 309 - DNA, 69 bp, Artificial Sequence
  Synthetic
tggatcacaagaagaaaaaatttggttataaacgaacgcgtggcggatgtggaccccttcgagcaatta

SEQ ID NO: 310 - DNA, 69 bp, Artificial Sequence
  Synthetic
cttgggctcctttactaatcactattaagaaatccacgcgtggcggatgtggaccccttcgagcaatta

SEQ ID NO: 311 - DNA, 69 bp, Artificial Sequence
  Synthetic
atgccaatctcttcataaatcttttctcaatgatgacgcgtggcggatgtggaccccttcgagcaatta

SEQ ID NO: 312 - DNA, 69 bp, Artificial Sequence
  Synthetic
ctcagttttatctaaggctagggtctttcgaatgtacgcgtggcggatgtggaccccttcgagcaatta

SEQ ID NO: 313 - DNA, 69 bp, Artificial Sequence
  Synthetic
tttcatgaaacaaatgaatgatgcacatcatggtgacgcgtggcggatgtggaccccttcgagcaatta

SEQ ID NO: 314 - DNA, 69 bp, Artificial Sequence
  Synthetic
ttcagccacaggctcccagacatgacagccatcatacgcgtggcggatgtggaccccttcgagcaatta

SEQ ID NO: 315 - DNA, 69 bp, Artificial Sequence
  Synthetic
ggtcaagtctaagtcgaatccatcctcttgatatcacgcgtggcggatgtggaccccttcgagcaatta

SEQ ID NO: 316 - DNA, 69 bp, Artificial Sequence
  Synthetic
atatttatccaaacattattgctatgggatttcctacgcgtggcggatgtggaccccttcgagcaatta

SEQ ID NO: 317 - DNA, 69 bp, Artificial Sequence
  Synthetic
cttactacatcatcaatattgttcctgtatacgccacgcgtggcggatgtggaccccttcgagcaatta

SEQ ID NO: 318 - DNA, 69 bp, Artificial Sequence
  Synthetic
ttaaggtttttggattcaaagcataaaaaccattaacgcgtggcggatgtggaccccttcgagcaatta

SEQ ID NO: 319 - DNA, 69 bp, Artificial Sequence
  Synthetic
gtttttggattcaaagcataaaaaccattacaagaacgcgtggcggatgtggaccccttcgagcaatta

SEQ ID NO: 320 - DNA, 69 bp, Artificial Sequence
  Synthetic
ttttagttgtgctgaaagacattatgacaccgccaacgcgtggcggatgtggaccccttcgagcaatta

SEQ ID NO: 321 - DNA, 69 bp, Artificial Sequence
  Synthetic
ttgtgctgaaagacattatgacaccgccaaatttaacgcgtggcggatgtggaccccttcgagcaatta

SEQ ID NO: 322 - DNA, 69 bp, Artificial Sequence
  Synthetic
agctagaacttatcaaacccttttgtgaagatcttacgcgtggcggatgtggaccccttcgagcaatta

SEQ ID NO: 323 - DNA, 69 bp, Artificial Sequence
  Synthetic
caccagttcgtccctttccagctttacagtgaattacgcgtggcggatgtggaccccttcgagcaatta

SEQ ID NO: 324 - DNA, 69 bp, Artificial Sequence
  Synthetic
gtgcatatttattacatcggggcaaatttttaaagacgcgtggcggatgtggaccccttcgagcaatta

SEQ ID NO: 325 - DNA, 69 bp, Artificial Sequence
  Synthetic
gcgctatgtgtattattatagctacctgttaaagaacgcgtggcggatgtggaccccttcgagcaatta

SEQ ID NO: 326 - DNA, 69 bp, Artificial Sequence
  Synthetic
ggaatagtttcaaacatcatcttgtgaaacaacagacgcgtggcggatgtggaccccttcgagcaatta

SEQ ID NO: 327 - DNA, 69 bp, Artificial Sequence
  Synthetic
atatattcctccaattcaggacccacacgacgggaacgcgtggcggatgtggaccccttcgagcaatta

SEQ ID NO: 328 - DNA, 69 bp, Artificial Sequence
  Synthetic
tactttgatatcaccacacacaggtaacggctgagacgcgtggcggatgtggaccccttcgagcaatta

SEQ ID NO: 329 - DNA, 69 bp, Artificial Sequence
  Synthetic
tcttcataccaggaccagaggaaacctcagaaaaaacgcgtggcggatgtggaccccttcgagcaatta

SEQ ID NO: 330 - DNA, 69 bp, Artificial Sequence
  Synthetic
cttgtcattatctgcacgctctatactgcaaatgcacgcgtggcggatgtggaccccttcgagcaatta

SEQ ID NO: 331 - DNA, 69 bp, Artificial Sequence
  Synthetic
ctagtacttactttaacaaaaaatgatcttgacaaacgcgtggcggatgtggaccccttcgagcaatta

SEQ ID NO: 332 - DNA, 69 bp, Artificial Sequence
  Synthetic
gaggctagcagttcaacttctgtaacaccagatgtacgcgtggcggatgtggaccccttcgagcaatta

SEQ ID NO: 333 - DNA, 69 bp, Artificial Sequence
  Synthetic
attctctggatcagagtcagtggtgtcagaatatcacgcgtggcggatgtggaccccttcgagcaatta

SEQ ID NO: 334 - DNA, 69 bp, Artificial Sequence
  Synthetic
ccagactgccttccgggtcactgccatggaggagcacgcgtggcggatgtggaccccttcgagcaatta

SEQ ID NO: 335 - DNA, 69 bp, Artificial Sequence
  Synthetic
ttccataggtctgaaaatgtttcctgactcagaggacgcgtggcggatgtggaccccttcgagcaatta

SEQ ID NO: 336 - DNA, 69 bp, Artificial Sequence
  Synthetic
ggactgactttctgctcttgtctttcagacttcctacgcgtggcggatgtggaccccttcgagcaatta

SEQ ID NO: 337 - DNA, 69 bp, Artificial Sequence
  Synthetic
acttcctgaaaacaacgttctggtaaggacaagggacgcgtggcggatgtggaccccttcgagcaatta

SEQ ID NO: 338 - DNA, 69 bp, Artificial Sequence
  Synthetic
ggacgatattgaacaatggttcactgaagacccagacgcgtggcggatgtggaccccttcgagcaatta

SEQ ID NO: 339 - DNA, 69 bp, Artificial Sequence
  Synthetic
ggtgcaggggccgccggtgtaggagctgctggtgcacgcgtggcggatgtggaccccttcgagcaatta

SEQ ID NO: 340 - DNA, 69 bp, Artificial Sequence
  Synthetic
atcttctgtcccttcccagaaaacctaccagggcaacgcgtggcggatgtggaccccttcgagcaatta

SEQ ID NO: 341 - DNA, 69 bp, Artificial Sequence
  Synthetic
ctgccctgtgcagctgtgggttgattccacaccccacgcgtggcggatgtggaccccttcgagcaatta

SEQ ID NO: 342 - DNA, 69 bp, Artificial Sequence
  Synthetic
acctccgtcatgtgctgtgactgcttgtagatggcacgcgtggcggatgtggaccccttcgagcaatta

SEQ ID NO: 343 - DNA, 69 bp, Artificial Sequence
  Synthetic
cctcctcagcatcttatccgagtggaaggaaatttacgcgtggcggatgtggaccccttcgagcaatta

SEQ ID NO: 344 - DNA, 69 bp, Artificial Sequence
  Synthetic
ctcatagggcaccaccacactatgtcgaaaagtgtacgcgtggcggatgtggaccccttcgagcaatta

SEQ ID NO: 345 - DNA, 69 bp, Artificial Sequence
  Synthetic
ctgactgtaccaccatccactacaactacatgtgtacgcgtggcggatgtggaccccttcgagcaatta

SEQ ID NO: 346 - DNA, 69 bp, Artificial Sequence
  Synthetic
cttccagtgtgatgatggtgaggatgggcctccggacgcgtggcggatgtggaccccttcgagcaatta

SEQ ID NO: 347 - DNA, 69 bp, Artificial Sequence
  Synthetic
acagctttgaggtgcgtgtttgtgcctgtcctgggacgcgtggcggatgtggaccccttcgagcaatta

SEQ ID NO: 348 - DNA, 69 bp, Artificial Sequence
  Synthetic
gcagctcgtggtgaggctcccctttcttgcggagaacgcgtggcggatgtggaccccttcgagcaatta

SEQ ID NO: 349 - DNA, 69 bp, Artificial Sequence
  Synthetic
cactgcccaacaacaccagctcctctccccagccaacgcgtggcggatgtggaccccttcgagcaatta

SEQ ID NO: 350 - DNA, 69 bp, Artificial Sequence
  Synthetic
ctccccagccaaagaagaaaccactggatggagaaacgcgtggcggatgtggaccccttcgagcaatta

SEQ ID NO: 351 - DNA, 69 bp, Artificial Sequence
  Synthetic
tgggcgtgagcgcttcgagatgttccgagagctgaacgcgtggcggatgtggaccccttcgagcaatta

SEQ ID NO: 352 - DNA, 69 bp, Artificial Sequence
  Synthetic
tgagccctgctcccccctggctccttcccagcctgacgcgtggcggatgtggaccccttcgagcaatta

SEQ ID NO: 353 - DNA, 69 bp, Artificial Sequence
  Synthetic
ccacctgaagtccaaaaagggtcagtctacctcccacgcgtggcggatgtggaccccttcgagcaatta

SEQ ID NO: 354 - DNA, 69 bp, Artificial Sequence
  Synthetic
agaagtggagaatgtcagtctgagtcaggcccttcacgcgtggcggatgtggaccccttcgagcaatta

(19) United States
(12) Patent Application Publication
(10) Pub. No.: US 2012/0015821 A1
(43) Pub. Date: Jan. 19, 2012

(54) Methods of Generating Gene Specific Libraries

(75) Inventor: Christopher Raymond, Seattle, WA (US)

(73) Assignee: Life Technologies Corporation, Carlsbad, CA (US)

(21) Appl. No.: 13/044,214

(22) Filed: Mar. 9, 2011

(30) Foreign Application Priority Data
Sep. 9, 2009 (US) PCT/US2009/056380

(51) Int. Cl. C40B 50/06; C40B 20/00; C40B 30/04

(52) U.S. Cl. 506/2; 506/26; 506/9

(57) ABSTRACT

The invention provides compositions and methods for generating a target enriched, sequencing ready library for resequencing at least one target region of interest from a nucleic acid containing sample.

### BACKGROUND

The ability to sequence deoxyribonucleic acid (DNA) accurately and rapidly is revolutionizing biology and medicine. The pharmacogenomics challenge is to comprehensively identify the genes and functional polymorphisms associated with the variability in drug response. Screens for numerous genetic markers performed for populations large enough to yield statistically significant data are needed before associations can be made between a given genotype and a particular disease.

The study of complex genomes and, in particular, the search for the genetic basis of disease in humans, requires genotyping on a massive scale, which is demanding in terms of cost, time, and labor. Such costly demands are even greater when the methodology employed involves serial analysis of individual DNA samples, i.e., separate reactions for individual samples. Resequencing of polymorphic areas in the genome that are linked to disease development will contribute greatly to the understanding of diseases such as cancer and therapeutic development. Thus, there is a need for accurate, high-throughput methods for generating nucleic acid libraries for selective resequencing of target regions of the genome and/or transcriptome for pharmacogenetics applications and genetic disease association studies.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present invention provides a method of generating a population of DNA molecules, each DNA molecule comprising a nucleic acid insert region flanked by a first primer binding region and a second primer binding region, the method comprising (a) fragmenting a starting population of DNA molecules into a population of fragmented insert DNA molecules; (b) combining in a ligation reaction, the population of fragmented insert DNA molecules of step (a) with (i) a plurality of first stem-loop linker oligonucleotides comprising a sequence that is complementary to a first primer binding region, and (ii) a plurality of second stem-loop linker oligonucleotides comprising a sequence that is complementary to a second primer binding region; (c) contacting the ligation reaction of step (b) with a polymerase under conditions suitable to synthesize the complementary strands corresponding to the first and second stem-loop linkers, thereby generating a plurality of double-stranded DNA molecules, each DNA molecule comprising an insert region flanked by a first primer binding region and a second primer binding region; and (d) performing a polymerase chain reaction on the double-stranded molecules of step (c) with a plurality of first PCR primers that bind to the first primer binding region and a plurality of second PCR primers that bind to the second primer binding region to selectively amplify the population of DNA molecules comprising an insert fragment flanked by a first stem-loop linker oligonucleotide and a second stem-loop linker oligonucleotide. The methods according to this aspect of the invention are useful, for example, to generate sequencing-ready libraries of DNA molecules that may be used as templates in a high-throughput sequencing platform.

In another aspect, the present invention provides a method of enriching a library for target nucleic acid regions of interest. The method according to this aspect of the invention comprises (a) contacting a library of DNA molecules comprising a subpopulation of nucleic acid target insert sequences of interest flanked by a first primer binding region and a second primer binding region within a larger population of nucleic acid insert sequences flanked by the first primer binding region and the second primer binding region with a set of capture probes, the set of capture probes comprising a plurality of capture oligonucleotides, each comprising a first target sequence-specific binding region and a second capture reagent binding region, under conditions that allow binding between the capture oligonucleotides and the nucleic acid target regions of interest, to form a plurality of complexes between target regions of interest and capture probes; (b) contacting the mixture of step (a) with a capture reagent and separating the capture reagent bound complex from the mixture; and (c) eluting the target regions of interest flanked by the first primer binding region and the second primer binding region from the capture reagent bound complex. In some embodiments, the method further comprises amplifying the eluted target regions of interest flanked by the first primer binding region and the second primer binding region with a forward PCR primer and a reverse PCR primer that bind to the first and second primer binding regions to generate a library that is enriched for target regions of interest.

In another aspect, the invention provides a method of generating a target enriched, sequencing ready library for resequencing at least one target region of interest from a nucleic acid containing sample. The method according to this aspect of the invention comprises (a) providing a library comprising fragmented nucleic acid molecules flanked by a first primer binding region and a second primer binding region; and (b) enriching the library for target sequences with a set of capture probes comprising a plurality of capture oligonucleotides, each comprising a first target-specific binding region and a second capture reagent binding region, thereby generating an enriched sequencing ready library for resequencing at least one target region of interest.

The methods of the invention can be used to create populations of nucleic acid molecules (also referred to in the art as “libraries” of nucleic acid molecules) useful for a variety of purposes, such as resequencing a target region of interest.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an embodiment of a method for generating a population of DNA molecules comprising a nucleic acid insert region flanked by a first primer binding region and a second primer binding region, as described in Example 1;

FIG. 2A shows the densities for groups of bar codes (rows) for each amplicon of five genes (columns), demonstrating that the bar-coded population of DNA molecules comprising a nucleic acid insert region flanked by a first primer binding region and a second primer binding region generated sequence that was equivalent to non-bar-coded population of DNA molecules, as described in Example 1;

FIG. 2B shows both the expected and observed distribution of sequencing reads, demonstrating the accurate association of bar-coded sequence results with the correct samples in accordance with an embodiment of a method for generating a population of DNA molecules comprising a nucleic acid insert region flanked by a first primer binding region and a second primer binding region, as described in Example 1;

FIG. 3 is a flowchart showing the steps of a method of generating a sequence ready library from a starting population of DNA molecules, with the optional steps of enrichment of the library for target sequences using solution-based capture methods, in accordance with various embodiments of the methods of the invention;

FIG. 4 illustrates an embodiment of a method for enriching a population of DNA molecules comprising a nucleic acid insert region flanked by a first primer binding region and a second primer binding region for target regions of interest using capture probes comprising a capture binding region that directly binds to a capture reagent, as described in Example 3;

FIG. 5 illustrates an embodiment of a method for enriching a population of DNA molecules for target regions of interest using capture probes comprising a capture binding region that indirectly binds to a capture reagent, as described in Example 4;

FIG. 6 is a flow chart of the steps of solution-based capture in accordance with various embodiments of the methods of the invention;

FIG. 7 illustrates the sequencing read depth for the exons in the exemplary gene target PIK3CA obtained from a library that was enriched using indirect solution capture with capture oligos that were complementary to these exons, demonstrating high read densities (e.g., 1,000 reads) along all of the targeted exons, as described in Example 4;

FIG. 8 illustrates the sequencing read depth for the exons in the exemplary gene target AKT 1 gene in a 77-gene experiment, as described in Example 5;

FIG. 9 graphically illustrates the percent of target bases sequenced at a specific sequencing read depth from a library that was enriched with three rounds of solution-based capture in accordance with an embodiment of the methods of the invention, as described in Example 5;

FIG. 10A illustrates a read density map for determining the copy number variation of a region on a chromosome from sequence analysis of a sequence ready library generated according to an embodiment of a method of the invention, as described in Example 6;

FIG. 10B shows the results of an experiment carried out to measure the copy number variation from a region of chromosome 14 in a normal human subject using the sequence ready library generated according to an embodiment of a method of the invention, as described in Example 6;

FIG. 11A shows the results of transcriptional analysis of a cardiovascular risk locus on a 1500 Kb region of chromosome 9p21 containing two identified SNPs, (SNPA and SNPB) showing plus strand transcription that includes the associated SNPA and SNPB appears to span approximately 800 Kb, with the arrows showing potential transcription units, as described in Example 7; and

FIG. 11B shows the generation of a sequencing-ready library generated from not-so-random primer amplified from the whole transcriptome and enriched for the risk associated locus encompassing SNPA and SNPB shown in FIG. 11A with capture probes (arrows), as described in Example 7.

### DETAILED DESCRIPTION

This section presents a detailed description of the many different aspects and embodiments that are representative of the inventions disclosed herein. This description is by way of several exemplary illustrations of varying detail and specificity. Other features and advantages of these embodiments are apparent from the additional descriptions provided herein, including the different examples. The provided examples illustrate different components and methodology useful in practicing various embodiments of the invention. The examples are not intended to limit the claimed invention. Based on the present disclosure, the ordinary skilled artisan can identify and employ other components and methodology useful for practicing the present invention.

### I. DEFINITIONS

Unless defined otherwise, all technical and scientific terms used herein have the meaning commonly understood by one of ordinary skill in the art to which this invention belongs. Practitioners are particularly directed to Sambrook et al., “Molecular Cloning: A Laboratory Manual,” 2d ed., Cold Spring Harbor Press, Plainsview, N.Y. (1989); and Ausubel et al., “Current Protocols in Molecular Biology,” (Supplement 47), John Wiley & Sons, New York (1999), for definitions and terms of the art.

It is contemplated that the use of the term “about” in the context of the present invention is to connote inherent problems with precise measurement of a specific element, characteristic, or other trait. Thus, the term “about,” as used herein in the context of the claimed invention, simply refers to an amount or measurement that takes into account single or collective calibration and other standardized errors generally associated with determining that amount or measurement. For example, a concentration of “about” 100 mM of Tris can encompass an amount of 100 mM±0.5 mM, if 0.5 mM represents the collective error bars in arriving at that concentration. Thus, any measurement or amount referred to in this application can be used with the term “about” if that measurement or amount is susceptible to errors associated with calibration or measuring equipment, such as a scale, pipetteman, pipette, graduated cylinder, etc.

The use of the word “a” or “an” when used in conjunction with the term “comprising” in the claims and/or the specification may mean “one,” but it is also consistent with the meaning of “one or more,” “at least one,” and “one or more than one.”

As used herein, the term “nucleic acid molecule” encompasses both deoxyribonucleotides and ribonucleotides and refers to a polymeric form of nucleotides including two or more nucleotide monomers. The nucleotides can be naturally occurring, artificial, and/or modified nucleotides.

As used herein, an “isolated nucleic acid” is a nucleic acid molecule that exists in a physical form that is non-identical to any nucleic acid molecule of identical sequence as found in nature; “isolated” does not require, although it does not prohibit, that the nucleic acid so described has itself been physically removed from its native environment. For example, a nucleic acid can be said to be “isolated” when it includes nucleotides and/or internucleoside bonds not found in nature. When instead composed of natural nucleosides in phosphodiester linkage, a nucleic acid can be said to be “isolated” when it exists at a purity not found in nature, where purity can be adjudged with respect to the presence of nucleic acids of other sequences, with respect to the presence of proteins, with respect to the presence of lipids, or with respect to the presence of any other component of a biological cell, or when the nucleic acid lacks sequence that flanks an otherwise identical sequence in an organism's genome, or when the nucleic acid possesses sequence not identically present in nature. As so defined, “isolated nucleic acid” includes nucleic acids integrated into a host cell chromosome at a heterologous site, recombinant fusions of a native fragment to a heterologous sequence, recombinant vectors present as episomes, or as integrated into a host cell chromosome.

As used herein, “subject” refers to an organism or to a cell sample, tissue sample, or organ sample derived therefrom, including, for example, cultured cell lines, biopsy, blood sample, or fluid sample containing a cell. For example, an organism may be an animal, including but not limited to, an animal such as a cow, a pig, a mouse, a rat, a chicken, a cat, a dog, etc., and is usually a mammal, such as a human.

As used herein, the term “specifically bind” refers to two components (e.g., target-specific binding region and target) that are bound (e.g., hybridized, annealed, complexed) to one another sufficiently that the intended capture and enrichment steps can be conducted. As used herein, the term “specific” refers to the selective binding of two components (e.g., target-specific binding region and target) and not generally to other components unintended for binding to the subject components.

As used herein, the term “high stringency hybridization conditions” means any condition in which hybridization will occur when there is at least 95%, preferably about 97% to 100%, nucleotide complementarity (identity) between the nucleic acid sequences of the nucleic acid molecule and its binding partner. However, depending upon the desired purpose, the hybridization conditions may be “medium stringency hybridization,” which can be selected that require less complementarity, such as from about 50% to about 90%, (e.g., 60%, 70%, 80%, 85%). The comparison of sequences and determination of percent identity between two sequences can be accomplished using a mathematical algorithm of Karlin and Altschul (Proc. Natl. Acad. Sci. USA 87:2264-2268 (1990)), modified as in Karlin and Altschul (Proc. Natl. Acad. Sci. USA 90:5873-5877 (1993)). Such an algorithm is incorporated into the NBLAST and XBLAST programs of Altschul et al. (J. Mol. Biol. 215:403-410 (1990)).

As used herein, the term “complementary” refers to nucleic acid sequences that are capable of base-pairing according to the standard Watson-Crick complementary rules. That is, the larger purines will base pair with the smaller pyrimidines to form combinations of guanine paired with cytosine (G:C) and adenine paired with either thymine (A:T) in the case of DNA, or adenine paired with uracil (A:U) in the case of RNA.

As used herein, the term “target” refers to a nucleic acid molecule or polynucleotide whose presence and/or amount and/or sequence is desired to be determined and that has an affinity for a given target capture probe. Examples of targets include regions of genomic DNA, PCR amplified products derived from RNA or DNA, DNA derived from RNA or DNA, ESTs, cDNA, and mutations, variants, or modifications thereof.

As used herein, the term “resequencing” refers to a technique that determines the sequence of a genome of an organism using a reference sequence that has already been determined. It should be understood that resequencing may be performed on both the entire genome/transcriptome of an organism or a portion of the genome/transcriptome large enough to include the genetic change of the organism as a result of selection. Resequencing may be carried out using various sequencing methods, such as any sequencing platform amenable to producing DNA sequencing reads that can be aligned back to a reference genome, and is typically based on highly parallel technologies such as, for example, dideoxy “Sanger” sequencing, pyrosequencing on beads (e.g., as described in U.S. Pat. No. 7,211,390, assigned to 454 Life Sciences Corporation, Brandord, Conn.), ligation based sequencing on beads (e.g., Applied Biosystems Inc./Invitrogen), sequencing on glass slides (e.g., Illumina Genome Analyzer System, based on technology described in WO 98/44151 (Mayer, P., and Farinelli L.), microarrays or fluorescently labeled micro-beads.

### II. ASPECTS AND EMBODIMENTS OF THE INVENTION

In accordance with the foregoing, in one aspect, the invention provides a method of generating a population of DNA molecules (i.e., a library) that may be used for resequencing analysis. Each DNA molecule in the population of DNA molecules comprises a nucleic acid insert region flanked by a first primer binding region and a second primer binding region. The method comprises (a) fragmenting a starting population of DNA molecules into a population of fragmented insert DNA molecules; and (b) combining in a ligation reaction, the population of fragmented insert DNA molecules of step (a) with (i) a plurality of first stem-loop linker oligonucleotides comprising a sequence that is complementary to a first primer binding region, and (ii) a plurality of second stem-loop linker oligonucleotides comprising a sequence that is complementary to a second primer binding region; (c) contacting the ligation reaction of step (b) with a polymerase under conditions suitable to synthesize the complementary strands corresponding to the first and second stem-loop linkers, thereby generating a plurality of double-stranded DNA molecules, each DNA molecule comprising an insert region flanked by a first primer binding region and a second primer binding region; and (d) performing a polymerase chain reaction on the double-stranded molecules of step (c) with a plurality of first PCR primers that bind to the first primer binding region and a plurality of second PCR primers that bind to the second primer binding region to selectively amplify the population of DNA molecules comprising an insert fragment flanked by a first stem-loop linker oligonucleotide and a second stem-loop linker oligonucleotide.

The methods of this aspect of the invention can be used to generate a library suitable for genomic or transcriptome analysis such as, for example, resequencing analysis of the fragmented inserts.

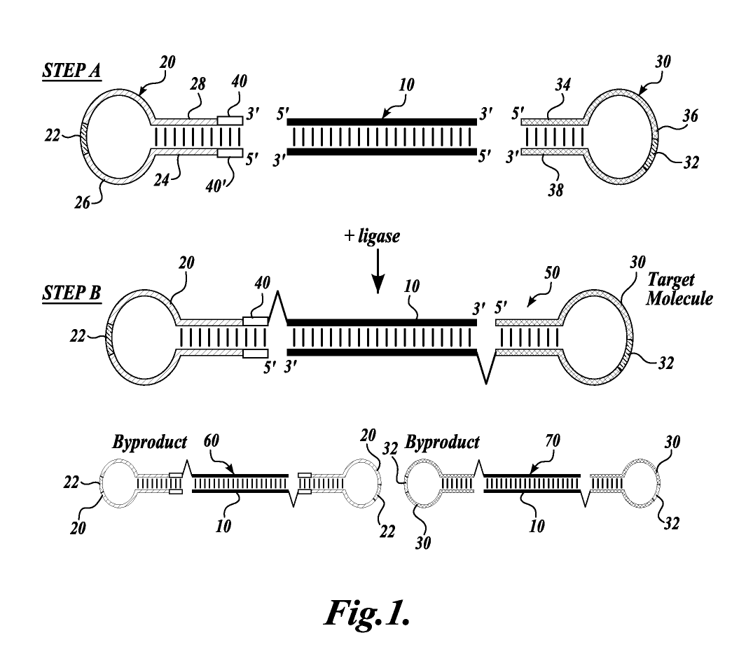

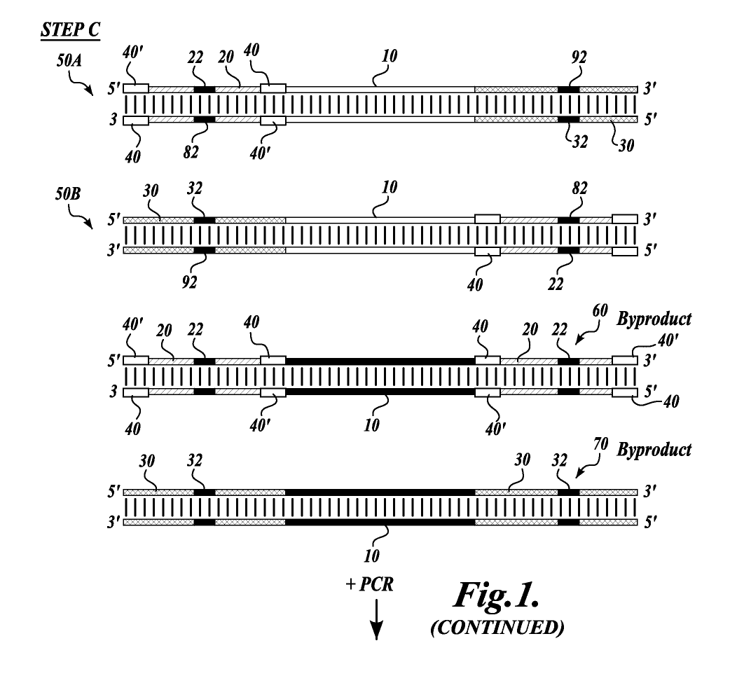

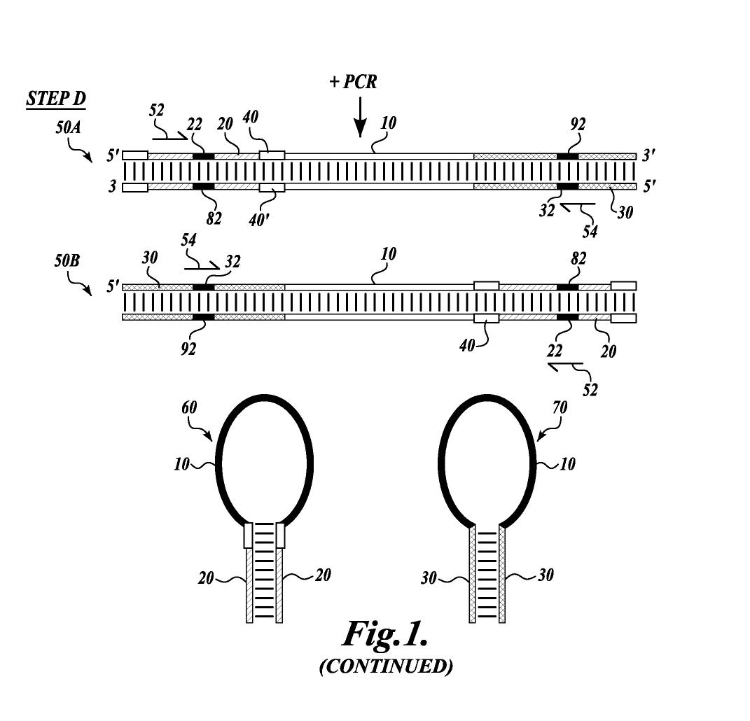

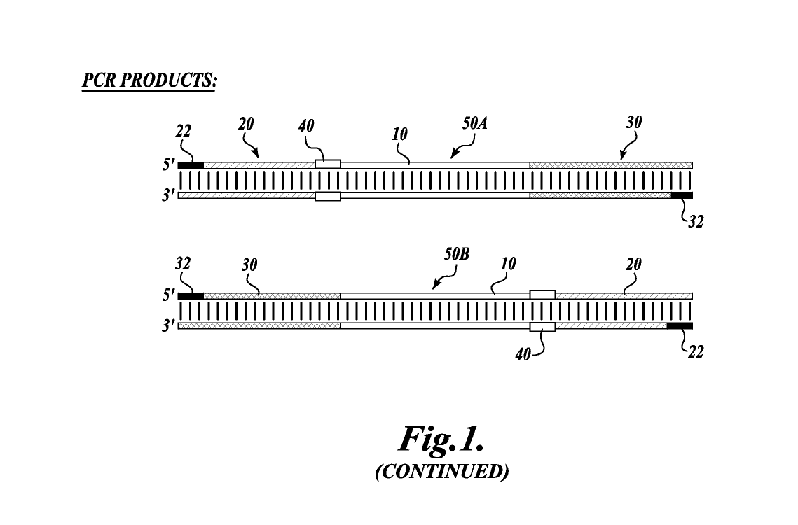

FIG. 1, step D (PCR products) illustrates exemplary DNA molecules 50A, 50B generated according to the methods of this aspect of the invention comprising an insert fragment 10 flanked by a first stem-loop linker oligonucleotide 20 and a second stem-loop linker oligonucleotide 30.

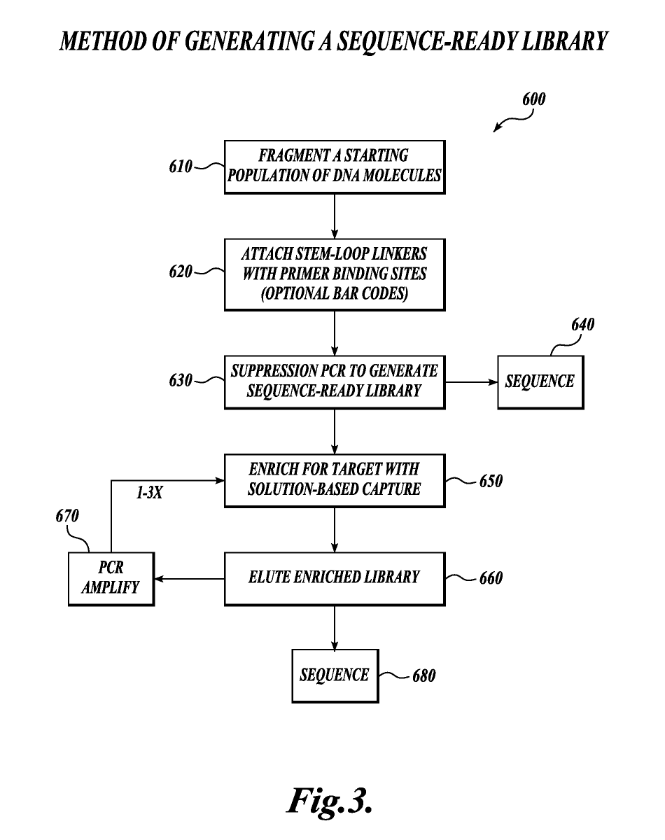

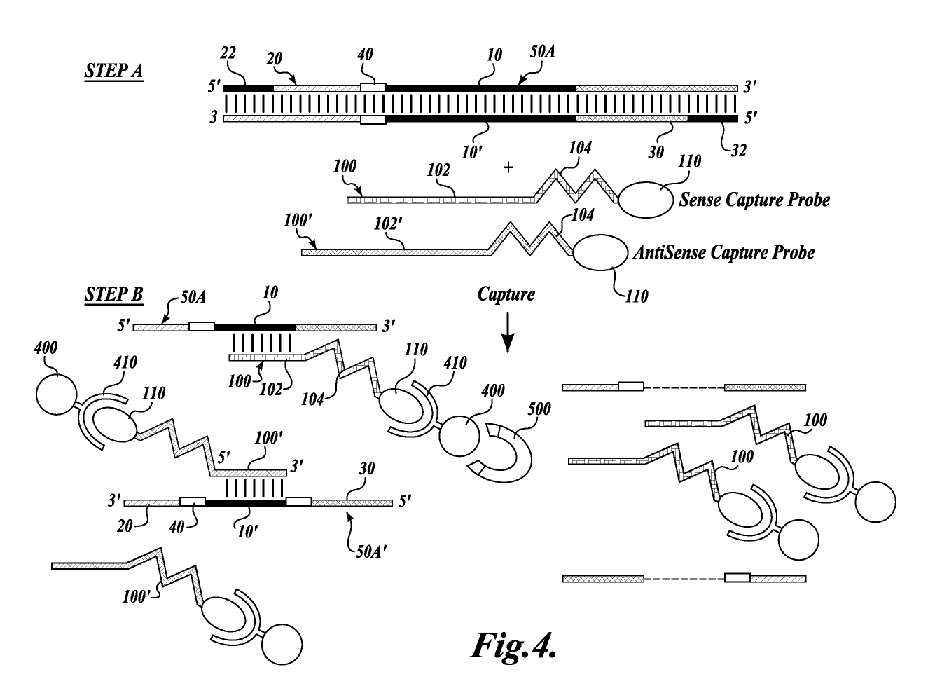

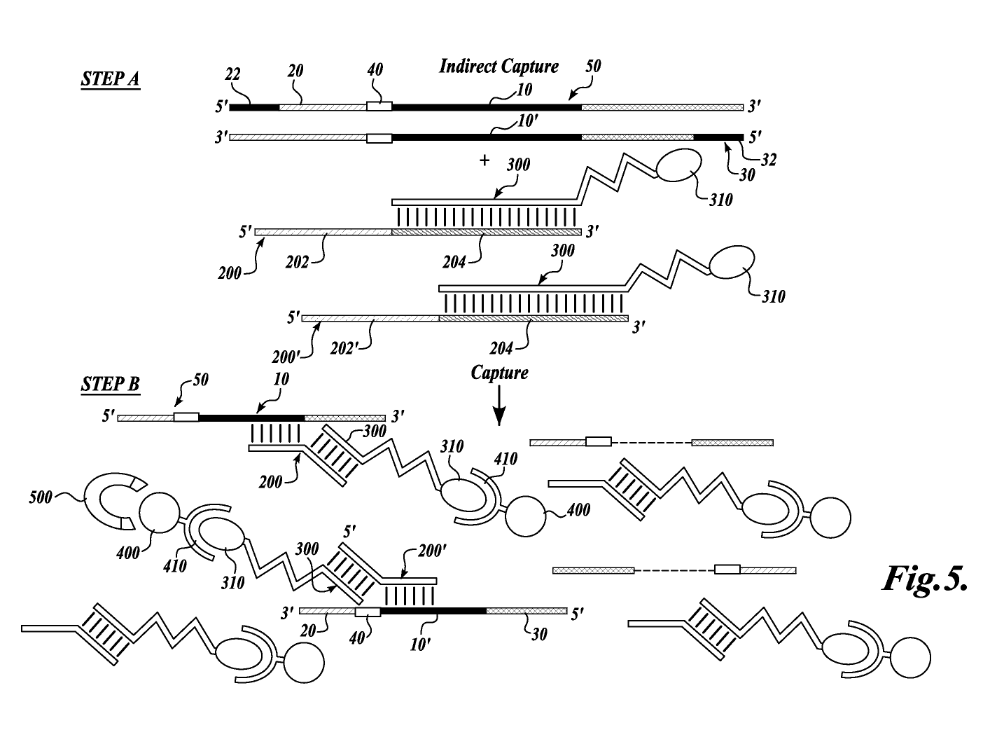

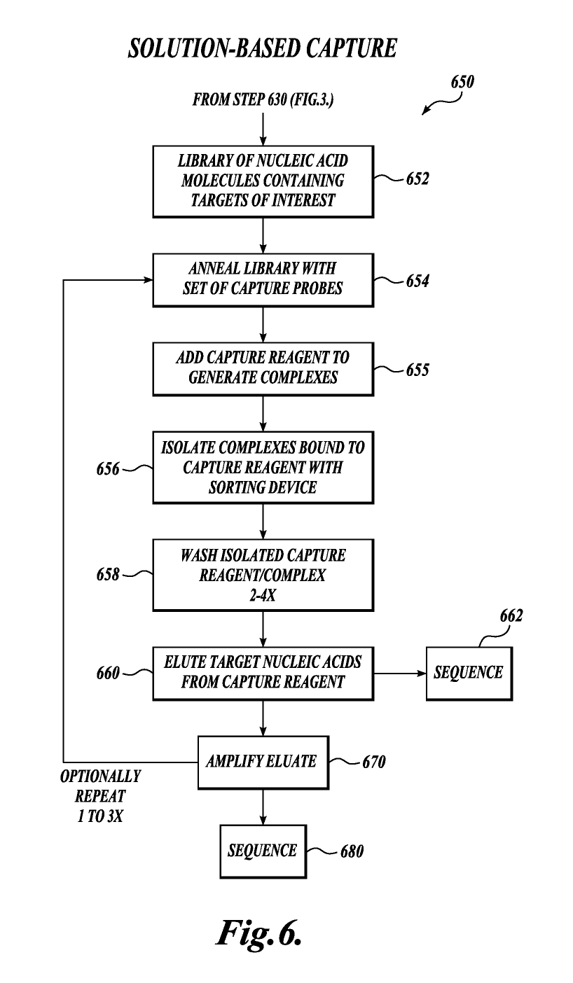

FIG. 3 illustrates an exemplary embodiment of the method of generating a sequencing-ready library 600 comprising a plurality of DNA molecules 50A, 50B according to this aspect of the invention. As shown in FIG. 3, at step 610, a starting population of DNA molecules containing one or more target sequence(s) of interest is fragmented. At step 620, a plurality of first stem-loop linker oligonucleotides, each comprising a sequence that is complementary to a first primer binding region, and a plurality of second stem-loop linker oligonucleotides, each comprising a sequence that is complementary to a second primer binding region, are ligated to the ends of the DNA fragments (inserts). At step 630, the ligation mixture is filled in and PCR amplified with primers that bind to the first and second primer binding regions to generate a population of double-stranded DNA molecules, each DNA molecule comprising an insert region flanked by a first primer binding region and a second primer binding region (i.e., a library). At step 640, the library can be optionally sequenced or may be enriched for the target sequences of interest according to steps 650-670 shown in FIG. 3, FIG. 6, and further described herein.

Starting Populations of Nucleic Acid Molecules

Examples of starting populations of nucleic acid molecules containing one or more target sequence(s) of interest for use in the methods of this aspect of the invention include genomic DNA, mRNA, tRNA, rRNA, cRNA, oligonucleotides, DNA derived from RNA or DNA, ESTs, cDNA, cDNA generated from not-so-random primed total RNA (e.g., as described in Example 7), PCR amplified products derived from RNA or DNA, microRNA, shRNA, siRNA, and mutations, variants, or modifications thereof.

The starting nucleic acid molecules may be isolated from a subject, such as a cell sample, tissue sample, or organ sample derived therefrom, including, for example, cultured cell lines, biopsy, blood sample, or fluid sample containing a cell. The subject may be an animal, including but not limited to, an animal such as a cow, a pig, a mouse, a rat, a chicken, a cat, a dog, etc., and is usually a mammal, such as a human.

As used herein, the term “target nucleotide” refers to a nucleic acid molecule or polynucleotide in a starting population of nucleic acid molecules having a target sequence whose presence and/or amount and/or nucleotide sequence is desired to be determined and that has an affinity for a given target capture probe.

As used herein, the term “target sequence” refers generally to a nucleic acid sequence on a single strand of nucleic acid. The target sequence may be a portion of a gene, a regulatory sequence, genomic DNA, cDNA, RNA including mRNA and rRNA, or others. The target sequence may be a target sequence from a sample or a secondary target such as a product of an amplification reaction.

In some embodiments, the starting population of nucleic acid molecules comprises PCR products amplified from a plurality of target-specific amplicons from a nucleic acid containing sample, as described in Example 1. In other embodiments, the starting population of nucleic acid molecules comprises total genomic DNA, as described in Example 2. In some embodiments, the starting population of nucleic acid molecules represents the whole transcriptome, as described in Example 7.

The starting population of nucleic acid molecules is fragmented into a population of fragmented insert DNA molecules of one or more specific size range(s). In one embodiment, for mammalian-sized genomes, fragments are generated from at least about 1 genome-equivalent of starting DNA, such as at least about 10 genome-equivalents of DNA, such as at least about 100 genome-equivalents of DNA, such as at least about 1,000 genome-equivalents of DNA, such as at least about 10,000 genome-equivalents of DNA, such as at least about 100,000 genome-equivalents of DNA, such as at least about 300,000 genome-equivalents of DNA.

This fragmentation may be accomplished by methods known in the art, including chemical, enzymatic, and mechanical fragmentation. In one embodiment, the fragments are from about 10 to about 10,000 nucleotides in length. In another embodiment, the fragments are from about 50 to about 2,000 nucleotides in length. In another embodiment, the fragments are from about 10-1,000, 10-800, 10-500, 50-500, 50-250, 50-150 nucleotides in length. In another embodiment, the fragments are less than 500 nucleotides in length, such as less than 400 nucleotides, less than 300 nucleotides, less than 200 nucleotides, or less than 150 nucleotides in length. In one embodiment, the fragmentation is accomplished mechanically through the use of sonication. In one embodiment, the fragmentation is accomplished by digestion with DNase I, which induces random double-stranded breaks in DNA in the absence of Mg⁺⁺ and in the presence of Mn⁺⁺, as described in Example 1. In some embodiments, the method may include the step of size selecting the fragments via standard methods such as column purification or isolation from an agarose gel.

In some embodiments, the fragmented DNA molecules are blunt-end polished prior to ligation to the stem-loop linkers. The blunt-end polishing step may be accomplished by incubation with a suitable enzyme, such as T4 polymerase (which has both 3′ to 5′ exonuclease activity and 5′ to 3′ polymerase activity). The fragmented DNA molecules may be optionally phosphorylated, for example, using T4 polynucleotide kinase, prior to ligation to the stem-loop linkers.

Stem-Loop Oligonucleotide Linkers

As shown in FIG. 1, step A, the first stem-loop linker oligonucleotide 20 comprises a 5′ region 24 with a sequence that is complementary to a sequence located in the 3′ region 28 that forms a stem structure, and an intervening region 26 between the 5′ and 3′ region that forms a loop structure. Also located in the first stem-loop linker oligonucleotide 20 is a sequence 22 that is complementary to a first primer binding region 82 that may be positioned in the intervening region 26 or in the stem region. Under non-denaturing conditions, the 5′ region 24 and 3′ region 28 hybridize together, resulting in the stem-loop linker oligonucleotide 20 structure with a double-stranded stem 24 and 28 with an intervening region 26 that forms a loop structure.

Similarly, as further shown in FIG. 1 at step A, the second stem-loop linker oligonucleotide 30 comprises a 5′ region 34 having a sequence that is complementary to a sequence located in the 3′ region 38 that forms a stem structure, and an intervening region 36 between the 5′ and 3′ region that forms a loop structure. Also located in the second stem-loop linker oligonucleotide 30 is a sequence 32 that is complementary to a second primer binding region 92 that may be positioned in the intervening region 36 or in the stem region. Under non-denaturing conditions, the 5′ region 34 and 3′ region 38 hybridize together, resulting in the stem-loop linker oligonucleotide 30 structure with a double-stranded stem 34 and 38 with an intervening region 36 that forms a loop structure.

The length of each stem-loop linker 20, 30 is typically at least 40 nucleotides, such as at least 45 nucleotides, at least 50 nucleotides, at least 55 nucleotides, at least 60 nucleotides, at least 65 nucleotides, at least 70 nucleotides, up to a maximum length of about 200 nucleotides. In some embodiments of the methods, the stem-loop linkers are each from about 45 nucleotides to about 70 nucleotides in length.

The 5′ complementary region 24 and the 3′ complementary region 28 in the first stem-loop linker 20, and the 5′ complementary regions 34 and the 3′ complementary region 38 in the second stem-loop linker 30, can be from about 5 nucleotides to 100 nucleotide or greater, such as 10 nucleotides, 15 nucleotides, 20 nucleotides or more in length, and may be designed using a variety of different sequences that result in hybridization between the complementary regions on each stem-loop linker, resulting in a local region of double-stranded DNA (i.e., a stem). For example, stem sequences may be utilized that are from 15 to 18 nucleotides in length with equal representation of G:C and A:T base pairs. Such stem sequences are predicted to form stable dsDNA structures below their predicted melting temperatures of ˜45° C.

The intervening loop regions 26, 36 in the first and second stem-loop linkers can be from about 10 nucleotides in length, 20 nucleotides, 30 nucleotides, 40 nucleotides or more in length. In order to facilitate subsequent PCR amplification and sequencing, in some embodiments the intervening loop region 26, 36 includes a nucleic acid sequence 22, 32 ranging in size from about 10 nucleotides to about 30 nucleotides that is complementary to a first and second PCR primer binding sequences 82, 92. The regions complementary to a first and second primer binding sequence may be contained within any other part of the stem-loop linker.

The first 82 and second 92 PCR primer binding regions contain sequences that are distinct from one another and designed for providing a universal first primer binding site and a universal second primer binding site in the plurality of DNA molecules in a sequence-ready library, for binding to a first and second PCR primer to enable PCR amplification of an intervening insert sequence.

In some embodiments, the stem-loop linker oligonucleotides further comprise one or more additional features such as a restriction enzyme site and/or an anchor probe binding site for attachment to a sequencing platform, such as a flow cell for massive parallel sequencing (e.g., Illumina, Inc.). For example, the Illumina Genome Analyzer System is based on technology described in WO 98/44151, hereby incorporated by reference, wherein DNA molecules are bound to a sequencing platform (flow cell) via an anchor probe binding site (otherwise referred to as a flow cell binding site) and amplified in situ on a glass slide. The DNA molecules are then annealed to a sequencing primer and sequenced in parallel base-by-base using a reversible terminator approach. The Illumina Genome Analyzer System utilizes flow-cells with 8 channels, generating sequencing reads of 18 to 36 bases in length, generating >1.3 Gbp of high quality data per run (see http://www.illumina.com).

In some embodiments, the first 20 and second 30 stem-loop linkers, each contains an anchor probe binding site for binding to a sequencing platform (e.g., a flow cell as described above). In some embodiments, the first 82 and second 92 PCR primer binding sites comprise a sequence that is also used as an anchor probe binding site for binding to a sequencing platform. In some embodiments, at least one of the first 20 or second 30 stem-loop linker oligonucleotides further comprises a sequence for annealing to a sequencing primer. In some embodiments, the first 20 stem-loop linker oligonucleotide comprises a sequence for annealing to a sequencing primer.

Stem-Loop Linker Oligonucleotides Comprising Molecular Bar Codes

In some embodiments, at least one of the stem-loop linker oligonucleotides (e.g., either 20 or 30) further comprises one or more molecular bar code sequences (e.g., a nucleotide tag with a length of 1, 2, 3, 4 or more nucleotides) that can be utilized to identify the origin of insert sequences 10 in mixtures of bar-coded samples. In some embodiments, the molecular bar code sequences are used to create groups of polynucleotides that share a common feature. For example, such features can include the source/sample of origin, the processing conditions used to generate the polynucleotide, etc., as further described in Example 1.

Ligation of Stem-Loop Linkers to Insert Fragments

In accordance with the methods of this aspect of the invention, the double-stranded nucleic acid fragments 10 are combined with the first 20 and second 30 stem-loop linker oligonucleotides in a ligation reaction with a suitable enzyme, such as T4 DNA ligase. As shown in FIG. 1, Step A, the stem region of each stem-loop linker 20, 30 forms a blunt-ended, double-stranded DNA segment suitable for ligation to the blunt-ended, double-stranded nucleic acid fragments 10, resulting in a ligated structure having the 3′ end of a stem-loop linker 20 or 30 covalently joined to the 5′ end of the double-stranded DNA insert 10. A pre-PCR fill-in reaction with a suitable polymerase, such as Taq polymerase, is used to copy the sequence information from the ligated insert:stem-loop linker to the complementary strand, resulting in the fill-in ligation products shown in FIG. 1, step C.

As shown in FIG. 1, Step C, the ligation reaction results in a mixture of ligation products including the target ligation products comprising inserts 10 flanked on each end by a pair of heterogeneous stem-loop linkers 20, 30 in a first orientation 50A and a second orientation 50B, as well as ligation byproducts comprising inserts 10 flanked on each end by a pair of homogenous stem-loop linkers 20, 20 shown as ligation byproducts 60 or 30, 30, shown as ligation byproducts 70.

Suppression PCR to Selectively Amplify Target Ligation Products

As shown in FIG. 1, Step C, the initial population of ligation products includes a mixture of inserts flanked by heterogeneous linker ends 50A, 50B and inserts flanked by homogenous linker ends 60, 70. A phenomenon referred to as suppression PCR (P. D. Siebert et al., Nucleic Acids Res. 23:1087-1088 (1995)) is used to selectively enrich for the inserts flanked by heterogeneous linker ends 50A, 50B. As demonstrated in Example 1, it is difficult to amplify an extended stem-loop structure (e.g., greater than 40 nucleotides) because the double-stranded stem occludes the binding of PCR primers. Accordingly, as shown in FIG. 1, Step D, the unwanted ligation byproducts 60, 70 are refractive to PCR amplification because the first stem-loop linker oligonucleotide and second stem-loop linker oligonucleotide are greater than 40 nucleotides. Therefore, as shown in FIG. 3, step 630, the ligation mixture is amplified in a polymerase chain reaction (PCR) with a first PCR primer 52 that hybridizes to the first PCR primer binding site 82 and a second PCR primer 54 that hybridizes to the second PCR primer binding site 92 to generate a sequencing-ready library comprising a plurality of nucleic acid molecules 50A, 50B containing a plurality of inserts that are derived from the starting population of DNA molecules (as shown in FIG. 1, step D “PCR Products”).

Polymerase chain reaction (PCR) is a technique that is well known and involves the use of primer extension combined with thermal cycling to amplify a target sequence. In general, the greater the number of amplification cycles during the polymerase chain reaction, the greater the amount of amplified DNA product is obtained. In some embodiments, a desirable number of amplification cycles for use in the suppression PCR amplification (see FIG. 3) step 630 is from 2 to 60 cycles, such as from 10 to 30 cycles, such as about 20 cycles.

The resulting amplification product comprises a library of a plurality of double-stranded nucleic acid molecules 50A, 50B, each comprising a nucleic acid insert region flanked by a first primer binding region and a second primer binding region. The plurality of nucleic acid insert regions in the library includes one or more target sequences and can include enough different nucleic acid sequences to cover (i.e., represent) part or all of a source nucleic acid including, without limitation, a genome of an organism, a genomic locus, a cDNA library, a whole transcriptome of an organism, and the like. For example, such a library of double-stranded nucleic acid molecules may cover at least about 50%, or at least about 60%, or at least about 70%, or at least about 80%, or at least about 90%, or at least about 95% up to about 100% of the source nucleic acid.

Such libraries generated according to the methods of the invention may be applied directly to a flow cell sequencing platform, such as an Illumina Genome Analyzer, for sequence analysis or sequenced using other standard methods and are therefore referred to as “sequencing-ready” libraries.

In one embodiment, the methods of the invention are used to generate a sequencing-ready library for sequence analysis using the Illumina Genome Analyzer System and at least one of the linkers 20, 30 includes at least one anchor probe binding site (otherwise referred to as a flow cell binding site) and a sequence for annealing to a sequencing primer. Prior to sequence analysis, the library is denatured (i.e., in 0.2 M NaOH) for 5 minutes at room temperature) and bound to the flow cell.

Such sequence-ready libraries can be analyzed separately or, if modified to contain molecular bar codes, a plurality of libraries can be combined as a mixture into a single pool of libraries and analyzed. When a reaction is performed on a pooled bar-coded library, the reaction need only be performed once. When analyzed as a pool of libraries, the analysis can include detection (such as sequencing) of the molecular bar codes.

As shown in FIG. 3, a library or pool of libraries made according to the methods of the invention can be sequenced at step 640 or may be further enriched for target sequences of interest (as shown in FIG. 3, steps 650-670) using solution-based capture methods and analyzed as described in detail below.

Solution-Based Capture to Enrich a Library for Target Sequences of Interest

In another aspect, the present invention provides a method of enriching a library for target nucleic acid regions of interest. The method according to this aspect of the invention comprises (a) contacting a library of DNA molecules comprising a subpopulation of nucleic acid target insert sequences of interest flanked by a first primer binding region and a second primer binding region within a larger population of nucleic acid insert sequences flanked by the first primer binding region and the second primer binding region with a set of capture probes, the set of capture probes comprising a plurality of capture oligonucleotides, each comprising a first target sequence-specific binding region and a second capture reagent binding region, under conditions that allow binding between the capture oligonucleotides and the nucleic acid target regions of interest, to form a plurality of complexes between target regions of interest and capture probes; (b) contacting the mixture of step (a) with a capture reagent and separating the capture reagent bound complex from the mixture; and (c) eluting the target regions of interest flanked by the first primer binding region and the second primer binding region from the capture reagent bound complex.

Any library of DNA molecules comprising a subpopulation of nucleic acid target insert sequences of interest flanked by a first primer binding region and a second primer binding region within a larger population of nucleic acid insert sequences flanked by the first primer binding region and the second primer binding region may be enriched for target sequences using the methods of this aspect of the invention. In one embodiment of the method, a library of DNA molecules comprising a subpopulation of nucleic acid target insert sequences of interest flanked by a first primer binding region and a second primer binding region within a larger population of nucleic acid insert sequences flanked by the first primer binding region and the second primer binding region, generated using the methods of the invention, as shown in FIG. 3 (steps 610-630) and described, supra, is enriched using the methods of this aspect of the invention. The use of solution-based capture to enrich a library allows for the efficient creation of resequencing samples (sequence-ready libraries) that are largely composed of target sequences, as demonstrated in Examples 3-7.

Target Capture Probes

As shown in FIG. 4, in one embodiment, the sense 100 or antisense 100′ target capture probes, each comprises a target sequence-specific binding region 102, 102′ and a capture reagent binding region 104 attached to a moiety 110 for binding to a capture reagent 400. In operation, as shown in FIG. 4, step B, the target-specific binding region 102 of sense 100 or antisense 100′ target capture probes bind to a complementary or substantially complementary nucleic acid sequence contained in an insert region 10 or 10′ of a nucleic acid molecule 50 in the library. The moiety 110 (e.g., biotin) attached to the capture probe 100, 100′ is then contacted with a capture reagent 400 (e.g., a magnetic bead) having a binding region 410 (e.g., streptavidin coating) and the complex is pulled out of solution with a sorting device 500 (e.g., a magnet) that binds to the capture reagent 400.

The length of a capture probe is typically in the range of from 10 nucleotides to about 200 nucleotides, such as from about 20 nucleotides to about 150 nucleotides, such as from about 30 nucleotides to about 100 nucleotides, and such as from about 40 nucleotides to about 80 nucleotides.

The target-specific binding region 102,102′ of the target capture probe is typically from about 25 to about 150 nucleotides in length (e.g., 50 nucleotides, 100 nucleotides) and is chosen to specifically hybridize to a target sequence of interest. In one embodiment, the target-specific binding region comprises a sequence that is substantially complementary (i.e., at least 90% identical, at least 95% identical, at least 96% identical, at least 97% identical, at least 98% identical, at least 99% identical, or 100% identical) to a target sequence of interest.

In one embodiment, the capture probe is about 70 nucleotides in length, comprising a target-specific region of about 35 nucleotides in length.

One of skill in the art can use art-recognized methods to determine the features of a target binding region that will hybridize to the target with minimal non-specific hybridization. For example, one of skill can determine experimentally the features such as length, based composition, and degree of complementarity that will enable a nucleic acid molecule (e.g., the target-specific binding region of a target capture probe) to specifically hybridize to another nucleic acid molecule (e.g., the nucleic acid target) under conditions of selected stringency, while minimizing non-specific hybridization to other substances or molecules. For example, for an exon target of interest, a target gene sequence is retrieved from a public database such as GenBank, and the sequence is searched for stretches of from 25 to 150 bp with a complementary sequence having a GC content in the range of 45% to 55%. The identified sequence may also be scanned to ensure the absence of potential secondary structure and may also be searched against a public database (e.g., a BLAST search) to ensure a lack of complementarity to other genes.

The capture oligonucleotides may be designed to bind to a target region at selected positions spaced across the target region at various intervals. The capture oligo design and target selection process may also take into account genomic features of the target region such as genetic variation, G:C content, predicted oligo Tm, and the like.

In some embodiments, the methods of the invention are used to capture and sequence a modified or mutated target, such as to determine the presence of a particular single nucleotide polymorphism (SNP) or deletion, addition, or other modification. In accordance with such embodiments, the set of target capture probes are typically designed such that there is a very dense array of capture probes that are closely spaced together such that a single target sequence, which may contain a mutation, will be bound by multiple capture probes that overlap the target sequence. For example, capture probes may be designed that cover every base of a target region, on one or both strands, (i.e., head to tail) or that are spaced at intervals of every 2, 3, 4, 5, 10, 15, 20, 40, 50, 90, 100 or more bases across a sequence region.

As another example, the selection of the target capture probes over a target region of interest is based on the size of the target region. For example, for a target region of less than 100 nucleotides in length, capture probes (either sense, antisense, or both) are typically designed to hybridize to target sequences spaced apart by from 0 to 100 nucleotides, such as every 45 nucleotides. As another example, for a target region greater than 200 nucleotides, capture probes (either sense, antisense, or both) are typically designed to hybridize to target sequences spaced apart by from 0 to 200 nucleotides, such as at 45 to 65 nucleotide intervals. In one embodiment, for a target region greater than 200 nucleotides (e.g., a 200,000-nucleotide target region), a set of sense and antisense capture probes are designed that are each about 35 nucleotides in length and are spaced about 45 nucleotides apart across the target region (alternating sense/antisense) in order to saturate the region (e.g., “tile” across the region of interest).

In some embodiments of the method, a set of capture probes is designed to specifically bind to a plurality of target regions, such as the exons of a single gene or multiple genes, such as at least 5 genes, at least 10 genes, at least 20 genes, at least 50 genes, at least 75 genes, or more.

In some embodiments of the method, a set of capture probes is designed to specifically bind to target sequences across a genomic location, such as across a chromosomal region, and the capture probes are contacted with nucleic acid molecules from a total genomic library.

In some embodiments of the method, a set of capture probes is designed to specifically bind to target sequences across a genomic location, such as across a chromosomal region, and the capture probes are contacted with nucleic acids in a whole-transcriptome library in order to analyze the whole transcriptome across the chosen genomic locus, as described in Example 7.

In some embodiments of the method, a set of capture probes is designed to specifically bind to a genomic locus known to be associated with a clinical outcome or disease, or disease risk, for example, as described in Example 8.

As shown in FIG. 4, in one embodiment, the target capture probe 100, 100′ comprises a capture reagent binding region 104 attached to a moiety 110 for binding to a capture reagent 400. As will be understood by those of skill in the art, the solution-based capture method utilizes a binding interaction between a moiety 110 attached (directly or indirectly) to a capture probe 100, 100′ and a capture reagent 400 to enable the selective separation of captured sequences (bound to the capture probe) from the bulk solution of captured and uncaptured DNA molecules. The moiety 110 and capture reagent 400 may be any suitable binding partners such as, for example, biotin/streptavidin; epitope/antibody, or DNA hybridizing partners.

In one embodiment, the moiety 110 is biotin and the capture reagent 400 is a streptavidin-coated bead 400, which is sorted with a magnetic sorting device 500. Although the moiety 110 shown in FIG. 4 is located at the 5′ end of the capture probe, it will be understood by those of skill in the art that the moiety may alternatively be positioned at the 3′ end of the target capture probe 100.

As another example, the moiety 110 and capture reagent 400 may be an epitope/antibody pair, such as a digoxin moiety that is bound by digoxin antibodies or a fluoroscein moiety that is bound by fluoroscing antibodies, or other small epitope/antibody configurations.

As another example, the moiety 110 and capture reagent 400 may be DNA hybridization partners. For example, the moiety 110 on the capture probe may be a sequence that is complementary to an oligonucleotide affixed to beads 400.

As shown in FIG. 5, in another embodiment of the method of this aspect of the invention, the capture probes 200 comprise a target-sequence specific binding region 202, 202′ and a capture reagent binding region 204 that hybridizes to a universal adaptor oligonucleotide 300 comprising a moiety 310 that binds to a capture reagent 400. In operation, as shown in FIG. 5, step B, the target-specific binding region 202 of sense 200 or antisense 200′ target capture probes bind to a substantially complementary nucleic acid sequence contained in an insert region 10 or 10′ of a nucleic acid molecule 50 in the library. The universal adaptor oligonucleotide 300 is present at an equal concentration as the capture probes 200, and hybridize to the capture reagent binding region 204. The moiety 310 (e.g., biotin) attached to the universal oligo adaptor 300 is then contacted with a capture reagent 400 (e.g., a magnetic bead) having a binding region 410 (e.g., streptavidin coating) and the complex is pulled out of solution with a sorting device 500 (e.g., a magnet) that binds to the capture reagent 400.

As shown in FIG. 6, the methods of solution-based capture 650 include the step 652 of providing a library of nucleic acid molecules comprising nucleic acid target insert sequences of interest flanked by a first primer binding region on one end and a second primer binding region on the other end (e.g., produced as shown in step 630, from FIG. 3).

At step 654, the library of nucleic acid molecules 50A, 50B is annealed with a set of capture probes, each capture probe comprising a region that hybridizes to a target sequence contained in a library insert. In one embodiment, the capture probes 100 comprise a moiety 110 (e.g., biotinylated) for binding to a capture reagent 400 (e.g., streptavidin-coated beads). In another embodiment, the library of nucleic acid molecules 50A, 50B is annealed with a combination of a set of capture probes 200, each comprising a region 204 that hybridizes to a universal adaptor oligo 300 and an equimolar amount of universal adaptor oligos 300 comprising a moiety 310 for binding to a capture reagent 400.

The annealing step 654 is carried out by mixing a molar excess of capture probes (or capture probes plus universal adaptor oligos) with the library (or pool of bar-coded libraries) in a high salt solution comprising from 100 mM to 2 M NaCl (osmolarity=200 to 4,000 molar). An exemplary high salt solution for annealing is 10 mM Tris pH 7.6, 0.1 mM EDTA, 1 M NaCl (osmolarity=2,000 molar). The nucleic acid molecules in the mixture are then denatured (i.e., by heating to 94 degrees) and allowed to cool to room temperature. In one embodiment, the annealing step is carried out in a high salt solution comprising from 100 mM to 2 M NaCl with the addition of 0.1% triton X100 (or tween or NP40) nonionic detergent.

At step 655, an amount of capture reagent is added to the annealed mixture sufficient to generate a plurality of complexes, each containing a nucleic acid molecule, a capture probe (or a capture probe and a universal adaptor oligo), and a capture reagent. This step is carried out in a high salt solution comprising from 100 mM to 2 M NaCl (osmolarity=200 to 4,000 molar). An exemplary high salt solution for anneal is 10 mM Tris pH 7.6, 0.1 mM EDTA, 1 M NaCl (osmolarity=2,000 molar). The mixture is incubated at room temperature with mixing for about 15 minutes.

At step 656, the complexes formed in step 655 are isolated or separated from solution with a sorting device 500 (e.g., a magnet) that pulls or sorts the capture reagent 400 out of solution.

At step 658, the sorted complexes bound to the capture reagent 400 are washed with a low salt wash buffer (less than 10 mM NaCl, and more preferably no NaCl) to remove non-target nucleic acids. An exemplary low salt wash buffer is 10 mM Tris pH 7.6, 0.1 mM EDTA (osmolarity=10 millimolar). In some embodiments, the low salt wash optionally contains from 15% to 30% formamide, such as 25% formamide (osmolarity=6.3 molar). For each wash step, the capture reagent 400 bound to the complexes (i.e., magnetic beads) are resuspended in the low salt wash buffer and rocked for 5 minutes, then sorted again with the sorting device (magnet). The wash step may be repeated 2 to 4 times.

At step 660, the nucleic acid molecules containing the target sequences are eluted from the complexes bound to the capture reagent as follows. The washed complexes bound to the capture reagent 400 are resuspended in water, or in a low salt buffer (i.e., osmolarity less than 100 millimolar), heated to 94° C. for 30 seconds, the capture reagent (i.e., magnetic beads) are pulled out using a sorting device (i.e., magnet), and the supernatant (eluate) containing the target nucleic acid molecules is collected.

At step 670, the eluate is amplified in a PCR reaction with a first PCR primer that binds to the first primer binding site in the first linker and a second PCR primer that binds to the second primer binding site in the second linker, producing a once-enriched library that can be optionally sequenced at step 680.

As shown in FIG. 6, the once-enriched library may be further processed according to steps 654-670 using the same set of capture probes in each round of enrichment to generate a library that is twice-enriched or three-times enriched, etc., for the target sequences of interest prior to sequence analysis.

In one embodiment, the ratio of the concentration of the DNA target in the first and second round of enrichment to the concentration of capture oligo is a concentration of about 500 ng/ml DNA target to a concentration in the range of from about 1 nM to 10 nM of capture oligo. In one embodiment, the ratio of the concentration of DNA target in the third round of enrichment to concentration of capture oligo is a concentration of about 500 ng/ml of the twice-enriched library to a concentration of about 1 nM of capture oligo.

In one embodiment, the first round of enrichment (steps 654-670 shown in FIG. 6) is carried out with a first set of capture probes designed to target a first set of targets, followed by a second round of enrichment that is carried out with a second set of capture probes designed to target a second set of targets.

In one embodiment, the capture reagent (400) comprises streptavidin coated magnetic beads, each bead having a binding capacity of approximately 50 pmol of biotinylated double-stranded DNA/50 μl of beads. In one embodiment, at step 655, about 50 μl of the streptavidin coated magnetic beads are added to about 5 μg of the annealed nucleic acids (e.g., in the first and second rounds of enrichment). In one embodiment, at step 655, about 5 μl of the streptavidin coated magnetic beads are added to about 5 μg of the annealed nucleic acids (e.g., in the third round of enrichment).

As described in Examples 3-5, the solution-based capture methods according to the various embodiments described herein may be used to produce a level of target fragment specific enrichment in the range of 500- to 900-fold in the first round of enrichment, with a 50-fold higher level of enrichment in the second round (i.e., 25,000- to 45,000-fold total enrichment levels).

In one embodiment, the final round of enrichment may be carried out with a limiting amount of capture probe to library, in order to allow for the normalizing or leveling of target gene sequences in the enriched library, such that there will be a broad distribution in the frequency of amplified targets.

Oligonucleotide Synthesis

DNA synthesis of the various oligonucleotides of the invention (e.g., stem-loop linkers, capture probes, and universal adaptor oligonucleotides) can be carried out by any art-recognized chemistry, including phosphodiester, phosphotriester, phosphate triester, or N-phosphonate and phosphoramidite chemistries (see e.g., Froehler et al., Nucleic Acid Res. 14:5399-5407, 1986; McBride et al., Tetrahedron Lett. 24:246-248, 1983). Methods of oligonucleotide synthesis are well known in the art and generally involve coupling an activated phosphorous derivative on the 3′ hydroxyl group of a nucleotide with the 5′ hydroxyl group of the nucleic acid molecule (see, e.g., Gait, “Oligonucleotide Synthesis: A Practical Approach,” IRL Press, 1984).

In some embodiments, capture probes 100, 100′ are synthesized to include RNA residues (i.e., DNA/RNA hybrid molecules) and/or unnatural bases such as inosine that have altered base pairing and/or have modified backbone sequences such as thiophosphate.

The following examples merely illustrate the best mode now contemplated for practicing the invention but should not be construed to limit the invention.

### Example 1

This example describes the use of a PCR-based approach to generate a sequencing-ready library of the exon amplicons of 5 genes of interest, with an optional further modification to include the use of molecular bar code sequences.

Rationale

One application of highly-parallel sequencing technology such as the Illumina sequencing platform (Illumina, Inc., San Diego, Calif.) is the targeted resequencing of particular regions of a sequenced genome, such as the human genome. In this example, the targeted regions were the coding exons of 5 human genes—AKT1, KRAS, PIK3CA, PTEN, and TP53. PCR was used to retrieve 52 exonic regions derived from these 5 genes and methods are described herein for converting these DNA amplicons into fragmented samples flanked by linkers containing primer binding sites suitable for sequencing. The output of sequences from a system such as the Illumina platform is of sufficient quantity that it is conceivable to sequence several samples at once. To analyze samples simultaneously, each sample must be uniquely tagged. One method for tagging, validated in this example, is to append a specific sequence of nucleotides, with each attached sequence unique to each sample, between the sequencing initiation site and the fragmented library segments that are to be sequenced. In this way, the first few bases of sequence uniquely identify the sample while the remaining sequence will be derived from the target regions that are being analyzed in that sample. In this example, molecular bar code tags of 3 nucleotides were attached to unique sequencing libraries, and all 64 possible combinations of these codes were combined into a single sequencing library. Analysis of the output sequences confirmed that each code was uniquely associated with the appropriate library sequences. By extension, varying the code length to n bases makes it possible to generate 4⁽ⁿ⁾ codes.

This example demonstrates that the all of the regions included in pooled PCR fragments that were sequenced were successfully converted into fragments flanked by linkers that generated sequence information. Moreover, this example also shows that molecular bar codes can be used to multiplex samples into a single sequencing reaction from which sequence information unique to each sample can be subsequently extracted by computational analysis.

Selection and Initial Evaluation of Primer Pairs for Exon Amplification.

A. Selection of Primer Pairs

PCR primer pairs for the following 5 genes—AKT1, KRAS, PIK3CA, PTEN, and TP53—were selected using an exon primer selection software entitled “Exon Primer,” available on the UCSC Genome Bioinformatics browser at http://genome.ucsc.edu/. Five pairs of PCR primers per exon were initially selected for evaluation for PCR amplification of each exon in the 5 gene set.

PCR primers were chosen using the following criteria:

(1) A minimum distance of 35 bp between the primer and the exon/intron boundary, (resulting in a primer region of 70 bp).

(2) A maximal target exon size of 500 bp, with an overlap of 50 bp, such that exons larger than the maximal target size were divided into two primer sets. In the case where the introns were small, the primers were chosen to amplify across more than 1 exon.

(3) A target primer annealing temperature of 60° C., with a GC clamp, which is comprised of one or more G:C base pairs at the 3′ primer terminus and is intended to stabilize the termini of the primer:template duplex.

(4) A primer length of from 17 nt to 27 nt, such as from 24 to 27 nt.

(5) A maximum length of a mononucleotide repeat (e.g., AAAA) of 4 nt.

(6) Primer sequences were also masked against common repeat elements found in the human genome such that primer pairs with a potential to amplify multiple segments of the genome were removed.

Using the above criteria, an initial set of PCR primer was selected and tested as described below. Primers were delivered in 10 individual 96 well plates as 100 μl of a 100 μM stock. Stock primers were diluted 1:50 in water to create working primers that were 2 μM. Stock primers and working primers were stored at −20° C.

B. PCR Amplification of Exons

PCR reactions were carried out using the candidate set of primers as described below and the reactions were evaluated on agarose gel to determine if the correct sized PCR product was generated.

PCR Reaction Conditions:

3.5 μl H₂O

2 μl 5× buffer (supplied by the manufacturer with Expand High Fidelity PLUS, Roche Applied Sciences, Indianapolis, Ind.)

2 μl Forward exon-specific primer (2 μM)

2 μl Reverse exon-specific primer (2 μM)

0.2 μl genomic DNA (100 ng/μl)

0.2 μl dNTP (10 mM)

0.1 μl enzyme (Expand High Fidelity PLUS)

10 μl total

PCR Cycling Conditions:

1 Cycle
94° C. 2 minutes

10 Cycles:
94° C. for 30 sec
60° C. for 30 sec
72° C. for 1 min

25 Cycles:
94° C. for 30 sec
60° C. for 30 sec
72° C. for 1 min+10 sec/cycle
72° C. for 7 min
4° C. hold

Results

The results were analyzed on agarose gels for the presence of a PCR product of the expected size, and amount of product. The results are summarized below in TABLE 1.

TABLE 1
Summary of Initial Results Using Candidate PCR
Primer Pairs Tested for Exon Amplification

| | | Total | Total | Range of | | Percentage of exons |
|---|---|---|---|---|---|---|
| | | Number of | number of | expected | | that were amplified by |
| Target | Genbank Ref | Exon | primer | PCR product | | at least one primer |
| Gene | No. | Amplicons | pairs Tested | sizes | | pair of 5 tested |
| AKT1 | NM_001014431 | 14 | 70 | 224-701 | bp | 11/14 = 78% |
| KRAS | NM_004985 | 5 | 25 | 294-410 | bp | 3/5 = 60% |
| PIK3CA | NM_006218 | 21 | 93 | 213-656 | bp | 1/21 = 5% |
| PTEN | NM_000314 | 9 | 45 | 200-1000 | bp | 2/9 = 22% |
| TP53 | NM_000546 | 11 | 50 | 257-677 | bp | 6/11 = 54% |

| | | | | |
|---|---|---|---|---|
| Total: | Total: | Total: | Size Range | Average exon |
| 5 Genes | 60 Exon | 283 primer | of amplicon: | amplification success |
| | Amplicons | pairs tested | 200 bp to | rate per gene tested: |
| | | | 1000 bp | 44% |

As summarized in TABLE 1, for many exons, all PCR primer pairs attempted failed in the first PCR reactions attempted. For some exons, only one PCR primer pair or a few PCR primer pairs gave any PCR product. Therefore, it was concluded that the PCR reaction conditions needed to be varied in order to increase the success rate and robustness of the reaction.

C. Methods of Increasing Yield and Specificity of PCR Products

Methods

PCR reaction conditions were varied to test the effect of MgCl₂ concentration (1.5 mM or 3.0 mM) DMSO (5%) and Betaine (1.5M) on exon PCR product yield and specificity using the candidate set of primer pairs for the target gene AKT1, which were designed as described above.

10 μl PCR reactions were set up as described in TABLE 2 below. PCR Cycling conditions were as shown above, with a 55° C. degree annealing temperature. For the sample set shown in TABLE 2, 5 primer pairs were tested that previously produced results that ranged from good to no product from the AKT1 primers, as summarized in TABLE 1.

TABLE 2
PCR Conditions and Results for AKT Exon-Specific Amplification

| | | | | | Results: | |
|---|---|---|---|---|---|---|
| Sample | gDNA | | DMSO | Betaine | Product amplified (5 | Results: |
| Set | (template) | MgCl₂ | (5%) | (1.5M) | primer pairs tested) | Product yield |
| 1 | 4 ng | 1.5 mM | − | − | no product | no product |
| | (low) | (low) | | | (all 5 primer pairs) | (all 5 primer pairs) |
| 2 | 4 ng | 1.5 mM | + | − | yes-single band | low-medium |
| | | | | | (all 5 primer pairs) | (all 5 primer pairs) |
| 3 | 4 ng | 1.5 mM | − | + | no product | no product |
| | | | | | (all 5 primer pairs) | (all 5 primer pairs) |
| 4 | 20 ng | 1.5 mM | − | − | no product | no product |
| | (high) | | | | (all 5 primer pairs) | (all 5 primer pairs) |
| 5 | 20 ng | 1.5 mM | + | − | yes-single band | medium-high |
| | | | | | (all 5 primer pairs) | (all 5 primer pairs) |
| 6 | 20 ng | 1.5 mM | − | + | no product | no product |
| | | | | | (all 5 primer pairs) | (all 5 primer pairs) |
| 7 | 4 ng | 3.0 mM | − | − | yes, but with multiple bands | low-medium |
| | | (high) | | | (4 of 5 primer pairs) | (4 of 5 primer pairs) |
| 8 | 4 ng | 3.0 mM | + | − | yes-single band | medium-high |
| | | | | | (all 5 primer pairs) | (all 5 primer pairs) |
| 9 | 4 ng | 3.0 mM | − | + | yes-single band | Medium |
| | | | | | (4 of 5 primer pairs) | (4 of 5 primer pairs) |
| 10 | 20 ng | 3.0 mM | − | − | yes, but multiple bands | Medium |
| | | | | | (all 5 primer pairs) | (all 5 primer pairs) |
| 11 | 20 ng | 3.0 mM | + | − | yes-single band | High |
| | | | | | (all 5 primer pairs) | (all 5 primer pairs) |
| 12 | 20 ng | 3.0 mM | − | + | yes-single band | High |
| | | | | | (all 5 primer pairs) | (all 5 primer pairs) |

Results

The PCR reactions described above in TABLE 2 were analyzed on a 2% agarose gel with respect to the expected product size, presence of single or multiple (non-specific) bands, and the amount of product. As shown in TABLE 2, it was observed that at low concentrations of MgCl₂ (e.g., 1.5 mM), only the PCR reactions containing DMSO produced product, regardless of the amount of template. At the higher concentration of MgCl₂ tested (3.0 mM), all PCR reactions produced product; however, non-specific products were observed in PCR reactions without additives (DMSO or Betaine), which were suppressed in the presence of either 5% DMSO or 1.5 M Betaine. Therefore, it was concluded that DMSO was the most reliable additive and enhanced yield and specificity of the product. MgCl₂ at 3.0 mM also increased yield in combination with DMSO. Therefore, high MgCl₂ (3.0 mM) and either 1.5 M Betaine or 5% DMSO was chosen as the best combination for exon amplification.

The same set of primers that generated the results summarized in TABLE 1 were used in PCR reactions with high MgCl₂ (3.0 mM) and 5% DMSO with 20 ng template and 55° C. annealing temperature. Under these conditions, at least one of the 5 primer pairs for each exon produced a single PCR band of the expected size (>98% success rate).

The set of PCR primer pairs that was determined to successfully amplify the 60 exon amplicons of the 5 target genes is provided below in TABLE 3.

TABLE 3
Exon-Specific Primer Pairs and PCR Conditions
Used to Amplify Exon Amplicons

| | | | | | DMSO | | Betaine | |
|---|---|---|---|---|---|---|---|---|
| | | | | | (5%) | | (1.5 M) | |
| | | Left Primer | Right Primer | | 55° | 60° | 55° | 60° |
| Gene | Exon | 5′ to 3′ | 5′ to 3′ | Size | C. | C. | C. | C. |
| AKT | 1 | CATCCATCAGAGGGGAA | CCAGCCGTTGGACAAATC | 668 | | | X | |
| | | ATG | (SEQ ID NO: 2) | | | | | |
| | | (SEQ ID NO: 1) | | | | | | |
| AKT | 2 | AGCTTAGAGGGATGGCA | CAGACCCTGGGGCTACTA | 334 | | | | X |
| | | GC | CC | | | | | |
| | | (SEQ ID NO: 3) | (SEQ ID NO: 4) | | | | | |
| AKT | 3 | GACGGGTAGAGTGTGCG | AGCCAGTGCTTGTTGCTTG | 304 | | | X | |
| | | TG | (SEQ ID NO: 6) | | | | | |
| | | (SEQ ID NO: 5) | | | | | | |
| AKT | 4 | GAGAGAGGAAGAGATGG | GAGGATGGCTACAGGCAG | 352 | | | | X |
| | | GGC | AG | | | | | |
| | | (SEQ ID NO: 7) | (SEQ ID NO: 8) | | | | | |
| AKT | 5 | GCTCCTGATCTGGTACAG | TCCTCTGACATGGGGAAG | 378 | | X | | |
| | | GC | AG | | | | | |
| | | (SEQ ID NO: 9) | (SEQ ID NO: 10) | | | | | |
| AKT | 6-7 | GTAGGCCACCAGGTGTG | CATCGTCCCCTAGAGACA | 481 | | | X | |
| | | AAG | GC | | | | | |
| | | (SEQ ID NO: 11) | (SEQ ID NO: 12) | | | | | |
| AKT | 8 | GCGACGTGGTATCAAGC | GTCTGGTGCCATGGAGAG | 264 | | | X | |
| | | AG | TAG | | | | | |
| | | (SEQ ID NO: 13) | (SEQ ID NO: 14) | | | | | |
| AKT | 9-10 | TCTGAGACTTTCCAGGCC | CTTGGGGCACAGAGAGGA | 561 | | | | X |
| | | C | C | | | | | |
| | | (SEQ ID NO: 15) | (SEQ ID NO: 16) | | | | | |
| AKT | 11 | CCTTGATGCCGAGTCCTG | CCTGAGGCTTTGGAGATC | 407 | | | | X |
| | | (SEQ ID NO: 17) | AG | | | | | |
| | | | (SEQ ID NO: 18) | | | | | |
| AKT | 12 | GGCCCTACATCACAGGA | AGTGTGGATATGTGGGGA | 230 | | | X | |
| | | GG | GC | | | | | |
| | | (SEQ ID NO: 19) | (SEQ ID NO: 20) | | | | | |
| AKT | 13 | ATCCAGGTGCTTTGAAG | CATTGGCACTCTCCAAAA | 331 | | X | | |
| | | GTC | GG | | | | | |
| | | (SEQ ID NO: 21) | (SEQ ID N0: 22) | | | | | |
| AKT | 14 | GTCCCTGTGTCAATCTGT | CTGGCTGACAGAGTGAGG | 598 | | | | X |
| | | GG | G | | | | | |
| | | (SEQ ID N0: 23) | (SEQ ID N0: 24) | | | | | |
| KRA | 1 | GGAACGCATCGATAGCT | CCCTAATTCATTCACTCGC | 347 | | | X | |
| S | | CTG | C | | | | | |
| | | (SEQ ID N0: 25) | (SEQ ID N0: 26) | | | | | |
| KRA | 2 | CGATACACGTCTGCAGTC | TGGTCCTGCACCAGTAAT | 342 | | X | | |
| S | | AAC | ATG | | | | | |
| | | (SEQ ID N0: 27) | (SEQ ID N0: 28) | | | | | |
| KRA | 3 | TTGTCCGTCATCTTTGGA | TGCATGGCATTAGCAAAG | 410 | | X | | |
| S | | GC | AC | | | | | |
| | | (SEQ ID N0: 29) | (SEQ ID N0: 30) | | | | | |
| KRA | 4 | GTTGTGGACAGGTTTTGA | GGATTAAGAAGCAATGCC | 387 | | | X | |
| S | | AAG | CTC | | | | | |
| | | (SEQ ID N0: 31) | (SEQ ID N0: 32) | | | | | |
| KRA | 5 | CTGTACACATGAAGCCA | CAGTCTGCATGGAGCAGG | 294 | | X | | |
| S | | TCG | (SEQ ID N0: 34) | | | | | |
| | | (SEQ ID N0: 33) | | | | | | |
| PIK3 | 1 | GCTGAGGTGTCGGGCTG | GAGTCTCCGGCACCCAC | 292 | | | | X |
| CA | | (SEQ ID N0: 35) | (SEQ ID N0: 36) | | | | | |
| PIK3 | 2 | TTTCTGCTTTGGGACAAC | TTTAAGATTACGAAGGTA | 530 | | X | | |
| CA | | C | TTGGTTTAG | | | | | |
| | | (SEQ ID N0: 37) | (SEQ ID N0: 38) | | | | | |
| PIK3 | 3 | AATCTACAGAGTTCCCTG | TCAGTATAAGCAGTCCCT | 432 | | X | | |
| CA | | TTTGC | GCC | | | | | |
| | | (SEQ ID N0: 39) | (SEQ ID N0: 40) | | | | | |
| PIK3 | 4 | ACTTGTTGAAATTTCTCC | CAGAGCCTGCAGTGAGCC | 473 | | | | X |
| CA | | CTTG | (SEQ ID N0: 42) | | | | | |
| | | (SEQ ID NO: 41) | | | | | | |
| PIK3 | 5 | TAGAACTACAGTTTCAA | CGGAGATTTGGATGTTCTC | 634 | | X | | |
| CA | | AAGTTGACC | C | | | | | |
| | | (SEQ ID N0: 43) | (SEQ ID N0: 44) | | | | | |
| PIK3 | 6 | AAGGCAGCAACTAATTT | CTGCTAAACACTAATATA | 320 | | X | | |
| CA | | TGG | ACCTTTGG | | | | | |
| | | (SEQ ID N0: 45) | (SEQ ID N0: 46) | | | | | |
| PIK3 | 7 | TGGTTGATCTTTGTCTTC | TTCAATCAGCGGTATAAT | 268 | | X | | |
| CA | | GTG | CAGG | | | | | |
| | | (SEQ ID NO: 47) | (SEQ ID NO: 48) | | | | | |
| PIK3 | 8-9 | TGGGGAAGAAAAGTGTT | AGAGAAAGTATCTACCTA | 517 | | X | | |
| CA | | TTG | AATCCACAG | | | | | |
| | | (SEQ ID NO: 49) | (SEQ ID NO: 50) | | | | | |
| PIK3 | 10 | CCTGTCTCTGAAAATAAA | TGCTGAGATCAGCCAAAT | 371 | | X | | |
| CA | | GTCTTGC | TC | | | | | |
| | | (SEQ ID NO: 51) | (SEQ ID NO: 52) | | | | | |
| PIK3 | 11 | CATGTCAACCTTTTGAAC | TGAGAGAAAACAATTTAA | 214 | | X | | |
| CA | | AGC | GTGACATAC | | | | | |
| | | (SEQ ID NO: 53) | (SEQ ID NO: 54) | | | | | |
| PIK3 | 12-13 | GGCTCATTCACAACTATC | AAACTCTTCCAGCCAAAC | 656 | | X | | |
| CA | | TTTCC | ATAAAC | | | | | |
| | | (SEQ ID NO: 55) | (SEQ ID NO: 56) | | | | | |
| PIK3 | 14 | CAGGAACTACCTGAAAC | GGGCTTCTAAACAACTCT | 424 | | X | | |
| CA | | TCATGG | GCC | | | | | |
| | | (SEQ ID NO: 57) | (SEQ ID NO: 58) | | | | | |
| PIK3 | 15 | CTGCTCTGTGTTGTAGAA | TCTCAAGATTTTATCCAGA | 335 | | X | | |
| CA | | ACCC | AAAGG | | | | | |
| | | (SEQ ID NO: 59) | (SEQ ID NO: 60) | | | | | |
| PIK3 | 16 | GGTGAAAGTTGTAAATC | AGATAGCTAAATTCATGC | 293 | | X | | |
| CA | | TTTGTAACAC | ATCATAAG | | | | | |
| | | (SEQ ID NO: 61) | (SEQ ID NO: 62) | | | | | |
| PIK3 | 17 | AAAACCATGTGATGGCG | CACTCCAGAGGCAGTAGC | 393 | | | X | |
| CA | | TG | AG | | | | | |
| | | (SEQ ID NO: 63) | (SEQ ID NO: 64) | | | | | |
| PIK3 | 18 | GAAAGGCAGTAAAGGTC | TGTTCTAACTCAGAGGAA | 382 | | X | | |
| CA | | ATGC | TACACAAAC | | | | | |
| | | (SEQ ID NO: 65) | (SEQ ID NO: 66) | | | | | |
| PIK3 | 19-20 | AAATGGAAACTTGCACC | ACAGGCATGAACCACCAC | 584 | | | | X |
| CA | | CTG | (SEQ ID NO: 68) | | | | | |
| | | (SEQ ID NO: 67) | | | | | | |
| PIK3 | 21 | CGAAAGCCTCTCTAATTT | CCTATGCAATCGGTCTTTG | 452 | | X | | |
| CA | | TGTG | C | | | | | |
| | | (SEQ ID NO: 69) | (SEQ ID NO: 70) | | | | | |
| PTE | 1 | GAGTCGCCTGTCACCATT | ATCCGTCTACTCCCACGTT | 601 | | X | | |
| N | | TC | C | | | | | |
| | | (SEQ ID NO: 71) | (SEQ ID NO: 72) | | | | | |
| PTE | 2 | TTTAGTTTGATTGCTGCA | AGTCCATTAGGTACGGTA | 301 | | X | | |
| N | | TATTTC | AGCC | | | | | |
| | | (SEQ ID NO: 73) | (SEQ ID NO: 74) | | | | | |
| PTE | 3 | AAACCCATAGAAGGGGTA | TCTGTGCCAACAATGTTTT | 418 | | X | | |
| N | | TTTG | ACC | | | | | |
| | | (SEQ ID NO: 75) | (SEQ ID NO: 76) | | | | | |
| PTE | 4 | AAAGATTCAGGCAATGT | TGACAGTAAGATACAGTC | 200 | | X | | |
| N | | TTGTTAG | TATCGGG | | | | | |
| | | (SEQ ID NO: 77) | (SEQ ID NO: 78) | | | | | |
| PTE | 5 | GGAATCCAGTGTTTCTTT | TCAGATCCAGGAAGAGGA | 407 | | X | | |
| N | | TAAATACC | AAG | | | | | |
| | | (SEQ ID NO: 79) | (SEQ ID NO: 80) | | | | | |
| PTE | 6 | ATGGCTACGACCCAGTT | AAACTGTTCCAATACATGG | 280 | | X | | |
| N | | ACC | AAGG | | | | | |
| | | (SEQ ID NO: 81) | (SEQ ID NO: 82) | | | | | |
| PTE | 7 | CAGTTAAAGGCATTTCCT | CTCACCAATGCCAGAGTA | 359 | | X | | |
| N | | GTG | AGC | | | | | |
| | | (SEQ ID NO: 83) | (SEQ ID NO: 84) | | | | | |
| PTE | 8 | GCAACAGATAACTCAGAT | GTCAAGCAAGTTCTTCATC | 515 | | X | | |
| N | | TGCC | AGC | | | | | |
| | | (SEQ ID NO: 85) | (SEQ ID NO: 86) | | | | | |
| PTE | 9 | AGCTTGGCAACAGAGCA | CCACAAGTGCAAAGGGGT | 894 | | | | X |
| N | | AG | AG | | | | | |
| | | (SEQ ID NO: 87) | (SEQ ID NO: 88) | | | | | |
| TP53 | 1 | CTCCTCCCCAACTCCATT | CAAGCTTCCATCCCACTCA | 421 | | | X | |
| | | TC | C | | | | | |
| | | (SEQ ID NO: 89) | (SEQ ID NO: 90) | | | | | |
| TP53 | 2-3 | CTCAGACACTGGCATGG | TGGGTGAAAAGAGCAGTC | 448 | | X | | |
| | | TG | AG | | | | | |
| | | (SEQ ID NO: 91) | (SEQ ID NO: 92) | | | | | |
| TP53 | 4 | CGTTCTGGTAAGGACAA | AGGAATCCCAAAGTTCCA | 485 | | X | | |
| | | GGG | AAC | | | | | |
| | | (SEQ ID NO: 93) | (SEQ ID NO: 94) | | | | | |
| TP53 | 5-6 | TCACTTGTGCCCTGACTT | TCATGGGGTTATAGGGAG | 545 | | X | | |
| | | TC | GTC | | | | | |
| | | (SEQ ID NO: 95) | (SEQ ID NO: 96) | | | | | |
| TP53 | 7 | TGCTTGCCACAGGTCTCC | AGCAGTAAGGAGATTCCC | 321 | | X | | |
| | | (SEQ ID NO: 97) | CG | | | | | |
| | | | (SEQ ID NO: 98) | | | | | |
| TP53 | 8-9 | TGGTTGGGAGTAGATGG | ACCAGGAGCCATTGTCTTT | 539 | | X | | |
| | | AGC | G | | | | | |
| | | (SEQ ID NO: 99) | (SEQ ID NO: 100) | | | | | |
| TP53 | 10 | AACTTGAACCATCTTTTA | AGCTGCCTTTGACCATGA | 276 | | X | | |
| | | ACTCAGG | AG | | | | | |
| | | (SEQ ID NO: 101) | (SEQ ID NO: 102) | | | | | |
| TP53 | 11 | GATTTGAATTCCCGTTGT | CAGCATTTCACAGATATG | 598 | | X | | |
| | | CC | GGC | | | | | |
| | | (SEQ ID NO: 103) | (SEQ ID NO: 104) | | | | | |

D. DNase I Fragmentation of PCR Exon Amplicon Pool

The 51 exon amplicons were PCR amplified from genomic DNA using the primer pairs and conditions shown in TABLE 3. These PCR products were then pooled and purified over QiaQuick® columns (Qiagen), which removes DNA fragments less than approximately 40 bp. The purified pooled PCR products were present at 50 ng/μl in a size range of approximately 50 bp to 900 bp.

DNase I Digestion

It was determined that bovine pancreatic deoxyribonuclease I (DNase I) induces random double-stranded breaks in DNA in the absence of Mg⁺⁺ and in the presence of Mn⁺⁺ (Anderson, S., Nucleic Acids Res. 9(13):3015-3027 (1981); Melgar, E., et al., J. Biol. Chem. 243(17):4409-16 (1968)). Therefore, bovine pancreatic DNase I (New England Biolabs Catalog #M0303S) was used to randomly fragment the pool of exon amplicons to generate a sequencing library as described below.

Bovine pancreatic DNase I treatment was tested over a range of concentrations of 0.004 U, 0.002 U, and 0.001 U per μl (in the absence of Mg++ and in the presence of MnCl₂) in order to identify the DNase I digestion conditions suitable to result in an average fragment size range of about 50 to about 500 bp from the PCR amplified exon pool.

DNase I Digestion:

2 μl 50 ng DNA (PCR amplified exon pool) per reaction:

1 μl 10× buffer (500 mM Tris pH 7.6, 0.5 mg/ml acetylated BSA)

1.25 μl 40 mM MnCl₂

4.75 μl H₂O

1.0 μl Bovine Pancreatic DNase I (N.E.B. #M0303S) (2 U/μl diluted to 0.004,

0.002, and 0.001 U/μl)

10.0 μl

The Dnase I reaction was incubated at room temperature for 10 minutes, stopped with 0.2 volume of 100 mM EDTA, and run on an agarose gel to determine the size range resulting from the Dnase I digestion.

Results

Agarose gel analysis showed that the range of Dnase I enzyme concentrations tested resulted in digested products ranging in size from a complete digestion (e.g., di- or tri-nucleotides in length) to a slight fragmentation of the exon amplicon pool (e.g., 850 nt in length, data not shown). From this analysis, it was determined that the range of 1:1,000 to 1:1,500 dilutions of Dnase I (2 U/μl stock) treatment resulted in the production of DNA fragments in the desired range of about 50 to about 500 bp.

The Dnase I reaction was then scaled up to digest 10 μg total pooled PCR fragments under the conditions described above. The Dnase I digested material was run over a Qiaquick® column (removing fragments smaller than about 50 bp). The purified DNA was then concentrated with Ethanol precipitation, by combing the 200 μl purified DNA, 20 μl of 3M Sodium Acetate, 3 μl of Glyco-blue, and 500 μl 100% ETOH. A total of 4.5 μg DNA was recovered (45 ng/μl in 100 μl total volume).

E. Blunt-End Polishing the Dnase I Digested Fragments

40 μl (1.8 μg) of the purified, Dnase I digested fragment pool was end polished with the Quick Blunting® Kit (New England Biolabs, Catalog #E1201L), according to the manufacturer's instructions. The Quick Blunting® Kit includes a reaction mixture with T4 polymerase (which has both 3′ to 5′ exonuclease activity and 5′ to 3′ polymerase activity) and T4 polynucleotide kinase (for phosphorylation of the blunt-ended DNA for subsequent ligation to the stem-loop adaptors), resulting in a final fragment concentration of 40 ng/μl.

Blunt-End Polishing Reaction:

10 μA purified DNase I treated DNA (45 ng/μl)

2 μl 10× blunt buffer (supplied with kit)

5.2 μl H₂O

2 μl 1 mM dNTP

0.8 μl enzyme (mixture of T4 polymerase plus T4 polynucleotide kinase)

20 μl total

The reaction mixture was incubated at room temperature for 30 minutes, then at 70° C. for 10 minutes. This blunt-end polished DNA was ligated to the stem-loop adaptors as follows.

F. Ligation of Stem-Loop Linkers to Fragments

Rationale

To facilitate subsequent PCR amplification and sequencing, oligonucleotide linkers containing PCR primer binding sites (referred to as stem-loop linkers) were ligated to blunt-ended library fragments. The oligo linkers were designed as single DNA oligonucleotides capable of self-annealing to form a stem-loop secondary structure. The stem forms a blunt ended dsDNA segment suitable for ligation to the blunt-end library fragments. In this example, stem sequences were utilized that were 15 to 18 nucleotides in length with roughly equal representation of G:C and A:T base pairs. Such stem sequences are predicted to form stable dsDNA structures below their predicted melting temperatures of ˜45° C. Moreover, the formation of the ligatable dsDNA stem is a self:self intermolecular reaction that is highly efficient and each adaptor has only one dsDNA termini capable of ligation. In principle, self-annealing stem structures that range in size from 5 nucleotides to >100 nucleotides may be included in the stem loop adaptor.

As shown in FIG. 1 at step A, a pair of stem-loop linker oligonucleotides, shown as a first stem-loop linker 20 and a second stem-loop linker 30, was designed for ligation to the ends of each DNase I digested and blunt end-polished double-stranded DNA fragment 10. This ligation reaction generated a mixture of ligation products including the target molecules 50A and 50B comprising a plurality of DNA inserts 10 flanked by the first stem-loop linker 20 at one end and the second stem-loop linker 30 at the other end, as well as unwanted byproduct ligation products 60, 70 comprising a plurality of DNA inserts 10 flanked at both ends by either the first stem-loop linker 20 or flanked at both ends by the second stem-loop linker 30, as shown in FIG. 1 at step D.

As further shown in FIG. 1 at step A, the first stem-loop linker oligonucleotide 20 comprises a 5′ region 24 with a sequence that is complementary to a sequence located in the 3′ region 28 and an intervening region 26 between the 5′ and 3′ region that forms a loop structure. Also located in the first stem-loop linker oligonucleotide 20 is a sequence 22 that is complementary to a first primer binding region 82 that may be positioned in the intervening region 26 or in the stem region. Under non-denaturing conditions, the 5′ region 24 and 3′ region 28 hybridize together, resulting in the stem-loop linker oligonucleotide 20 structure with a double-stranded stem 24 and 28 with an intervening region 26 that forms a loop structure.

Similarly, as further shown in FIG. 1 at step A, the second stem-loop linker oligonucleotide 30 comprises a 5′ region 34 having a sequence that is complementary to a sequence located in the 3′ region 38 and an intervening region 36 between the 5′ and 3′ region that forms a loop structure. Also located in the second stem-loop linker oligonucleotide 30 is a sequence 32 that is complementary to a second primer binding region 92 that may be positioned in the intervening region 36 or in the stem region.

Under non-denaturing conditions, the 5′ region 34 and 3′ region 38 hybridize together, resulting in the stem-loop linker oligonucleotide 30 structure with a double-stranded stem 34 and 38 with an intervening region 36 that forms a loop structure.

The sequences 22, 32 are complementary to the first and second primer binding regions 82, 92, which contain primer binding sites for binding to forward and reverse PCR primers, as described in more detail below.

The total length of each stem-loop linker 20, 30 is typically at least 40 nucleotides, such as at least 45 nucleotides, at least 50 nucleotides, at least 55 nucleotides, at least 60 nucleotides, at least 65 nucleotides, at least 70 nucleotides, up to a maximum length of about 200 nucleotides. In some embodiments of the methods described herein, the stem-loop linkers are from about 45 nucleotides in length to about 70 nucleotides in length.

The use of 5′ and 3′ stem-loop linkers is a key element of the library construction since they provide universal primer binding sites for subsequent PCR and may contain primer binding sites/anchors for sequencing cluster generation and they can be used to introduce bar-codes for sample multiplexing.

As described in more detail below, suppression PCR may be used to prepare a sequencing-ready library enriched for the target molecules 50A and 50B comprising heterogeneous stem-loop adaptors at each end of the insert, as shown in the PCR products in FIG. 1 at step D.

As further illustrated in FIG. 1, step A, at least one of the stem-loop linkers (e.g., 20 may optionally include a bar code sequence 40. As shown in FIG. 1, the bar code sequence 40 may be positioned at the 3′ end of the linker 20, so that it is adjacent the insert 10 after ligation. As shown in FIG. 1, a complementary sequence 40′ is present on the 5′ end of the linker 20.

An exemplary set of stem-loop linkers 20, 30, shown below, were used in the following experiment.

First Stem-Loop Linker #1 (20)

(SEQ ID NO: 105)
5′AGATCGGAAGAGCGTAATGATACGGCGACCACCGACACTCTTTCCCTA
CACGACGCTCTTCCGATCT3′

SEQ ID NO:105 has a total length of 67 nucleotides, and consists of a 5′ 15 nucleotide stem hybridizing region 24 (underlined), a 37 nucleotide intervening loop region 26 and a 3′ 15 nucleotide stem hybridizing region 28 (underlined), with a sequence 22 complementary to the first PCR primer binding region 82 shown in italics.

Second Stem-Loop Linker #1 (30)

(SEQ ID NO: 106)
5′AGATCGGAAGAGCTCGTATGCCGTCTTCTGCTTGGAGCTCTTCCGATC
T3′.

SEQ ID NO:106 has a total length of 49 nucleotides, and consists of a 5′ 15 nucleotide stem hybridizing region 34 (underlined), a 19 nucleotide intervening loop region 36 and a 3′ 15 nucleotide stem hybridizing region 38 (underlined), with a sequence 32 complementary to the second PCR primer binding region 92 shown in italics.

Second Stem-Loop Linker #2 (30)

(SEQ ID NO: 107)
5′AGATCGGAAGAGCTCCAAGCAGAAGACGGCATACGAGCTCTTCCGATC
T3′.

SEQ ID NO:107 is a total length of 49 nucleotides, and consists of a 15 nucleotide stem hybridizing region 34 (underlined), a 19 nucleotide intervening loop region 36, and a 3′ 15 nucleotide stem hybridizing region 38 (underlined), with a sequence 32 complementary to the second PCR primer binding region 92 shown in italics.

Following fragmentation of PCR products, a pair of first 20 and second 30 stem-loop linker oligonucleotides were ligated to the blunt end-polished fragments 10 as follows.

Dephosphorylation of Stem-Loop Linkers

A test experiment was carried out to determine the conditions for ligation of stem-loop linkers to a double-stranded DNA fragment with phosphorylated blunt ends.

A test vector pCR2.1 (Invitrogen, Carlsbad Calif.) was digested with PvuII to generate blunt ends. Stem-loop linkers (SEQ ID NO:105 and SEQ ID NO:107) and Antarctic alkaline phosphatase (New England Biolabs, Catalog #M0289S) at a ratio of 30- to 50-fold enzyme to linker, were incubated in dephosphorylation buffer for one hour at 37° C. The dephosphorylation enzyme was heat inactivated at 65° C. for 5 minutes. The PvuII digested plasmid (1 μl) was ligated with the dephosphorylated stem-loop linkers (SEQ ID NO:105 and SEQ ID NO:107) (4 μl) in a 20 μl ligation reaction, the ligations were PCR amplified (25 cycles) and an aliquot of the PCR reaction was examined on an agarose gel.

Results

It was observed that at the highest amount of phosphatase treated linker (8 μg and 4 μg) some linker: dimer PCR band was present (data not shown). However, dephosphorylation of the stem-loop linkers and dilution of the stem-loop linkers prior to ligation completely eliminated the linker dimer PCR artifact.

G. Ligation of Dephosphorylated Stem-Loop Linkers with Blunt End-Polished DNase I Treated Exon Amplicon Pools

A series of ligation reactions were set up to determine the ability to ligate stem-loop linkers with blunt end-polished DNase I fragmented exon amplicon pools to generate a sequencing library.

It was determined that dephosphorylation of the stem-loop linkers (e.g., SEQ ID NO:105 and SEQ ID NO:107) followed by ligation of the dephosphorylated stem-loop linkers (SEQ ID NOS:105 and 107) to the DNase I digested blunt-end filled-in exon amplicon pool resulted in a ligated configuration with a stem-loop linker oligonucleotide ligated to the 5′ end of a first strand of a double-stranded fragment and a stem-loop linker oligonucleotide ligated to the 5′ end of a second strand of the double-stranded fragment that is the reverse complement of the first strand, as shown in FIG. 1 at step B.

Ligation Mixture:

10 μl 2× buffer (N.E.B. Quick ligation Kit #M2200S)

2 μl genomic DNA, DNAseI treated and blunt-end polished (40 ng/μl)

4 μl dephosphorylated forward stem-loop adaptor (10 μM) (SEQ ID NO:105)

4 μl dephosphorylated reverse stem-loop adaptor (10 μM) (SEQ ID NO:107)

1 μl Quick Ligase enzyme (N.E.B. Quick ligation Kit #M2200S)

20 μl total

The ligation mixture was incubated for 10 minutes at room temperature, diluted with 180 μl of TEzero (10 mM Tris pH 7.6 and 0.1 mM EDTA), and was used as a template in the suppression PCR reaction described below.

Pre-PCR Fill-in Reaction

As further shown in FIG. 1 at step B, the first stem-loop linker 20 adds information to the 5′ end of the double-stranded insert 10; however, this information is on the wrong strand to be useful in PCR amplification, therefore this information needs to be copied over to the 3′ end to create a primer binding site. This was accomplished by a pre-PCR fill-in reaction using Taq polymerase. As described below, the reaction mixture was incubated for 1 minute at 72° C. prior to standard PCR in order to transfer the linker information over to the complementary strand, resulting in the fill-in products 50 and 50′ shown in FIG. 1B, step C.

H. Suppression PCR to Selectively Amplify Target Ligation Products

Rationale

One of the primary goals of the adaptor ligation is to enrich the library for target molecules 50A and 50B, as shown in FIG. 1, step D (PCR products), that possess a different stem-loop linker 20, 30 on each end of the insert 10. During the ligation reaction, the stem-loop linkers attach randomly to library fragments, resulting in an initial population of ligation products where half the ligation products have the same linker termini on each end (homogeneous linker ends) and half the ligation products possess different linker termini (heterogeneous linker ends). The phenomenon of suppression PCR (P. D. Siebert et al., Nucleic Acids Res. 23:1087-1088 (1995)) was used in this example to selectively enrich for library fragments with heterogeneous adaptor termini. Briefly described, suppression PCR refers to the phenomenon that DNA segments that contain perfect inverted repeats at their termini longer than 40 nucleotides are poor substrates for amplification by PCR. The conceptual model is that these molecules form spontaneous intramolecular stem-loop structures that occlude PCR primer binding and subsequent amplification. The empirical observation is that molecules with perfect inverted repeat termini nt amplify poorly relative to similar DNA fragments with heterogeneous ends. Here, we exploit the fact that our stem loop adaptors add either 50, 67, or 73 nucleotides of additional sequence to the ends of ligated DNA fragments. In molecules with homogenous ends, these added sequences are long enough to evoke suppression PCR effects; hence, molecules with heterogeneous ends (e.g., 50A, 50B) are preferentially amplified and therefore the library is enriched for the sequencing-ready target molecules 50A, 50B, by the PCR reaction that follows ligation of the stem-loop linkers, resulting in a library enriched for sequencing-ready target molecules.

As further shown in FIG. 1 at step A, the ligation of first stem-loop linkers 20 (e.g., SEQ ID NO:105) and second stem-loop linkers 30 (e.g., SEQ ID NO:106) to blunt end fragments 10 would be expected to result in the following mixture of ligation products—approximately 50% target molecules 50A, 50B with heterogeneous ends (including 25% first linker-insert-second primer 50A and 25% second primer-insert-first primer 50B); and 50% byproducts (including 25% first primer-insert-first primer 60 and 25% second primer-insert-second primer 70). In order to remove the 50% byproduct ligation products 60, 70 with the same primer sequence at both ends, suppression PCR was used as described below in order to selectively amplify the target 50A, 50B ligation products to generate a library of nucleic acid molecules that are suitable for direct use as sequencing templates (i.e., sequence ready).

It is known that an extended stem loop structure (e.g., greater than 40 nucleotides) is difficult to amplify because the double-stranded stem occludes binding of primers. This phenomenon has been termed “suppression PCR effects.” As shown in FIG. 1 at step D, the unwanted 50% ligation byproducts 60, 70 are refractive to PCR amplification because the first stem-loop linker oligonucleotide (e.g., SEQ ID NO:105) and second stem-loop linker oligonucleotide (e.g., SEQ ID NO:106) are long (i.e., greater than 40 nucleotides) and result in a stem-loop structure with the fragment insert 10 as the intervening region with the stem formed by hybridizing linker regions. Therefore, a post-ligation PCR amplification step is used to selectively enrich the ligation products having the desired target structure 50A, 50B with heterogeneous linker termini (shown as PCR products in FIG. 1, step D), as follows.

With reference to FIG. 1, step D, a first PCR primer 52 that hybridizes to the first PCR primer binding site 82 and a second PCR primer 54 that hybridizes to the second PCR primer binding site 92 generated in the second strand during the PCR fill-in reaction of linkers 20 and 30, respectively, are used to selectively amplify the ligation products with the target structure 50A, 50B.

First PCR primer 52:
(SEQ ID NO: 109)
5′-AATGATACGGCGACCACCGA-3′
Second PCR primer 54:
(SEQ ID NO: 110)
5′-CAAGCAGAAGACGGCATACG-3′

PCR Reaction Mixture (with 5% DMSO):

10 μl DNA template (ligation mixture from Step G above)

20 μl 5× buffer (supplied by the manufacturer with the EXPAND^{Plus}® Kit, Roche)

10 μl 25 mM MgCl₂

10 μl 10 μM First PCR primer (SEQ ID NO:109)

10 μl 10 μM Second PCR primer (SEQ ID NO:110)

5 μl DMSO

5 μl dNTPs (10 mM in each dNTP)

30 μl H₂O

1 μl Taq Polymerase (native Taq 5 U/μl, Invitrogen)

1 μl EXPAND^{PLUS}® Polymerase (5 U/μl, Roche)

100 μl total

PCR Cycling Conditions:

1 Cycle:

72° C. for 1 minute; 94° C. for 2 minutes. (Note: This step copies the sequence from the ligated stem-loop linker to the complementary strand.)

10 Cycles:
94° C. for 30 sec
60° C. for 30 sec
72° C. for 1 minute

10 Cycles:
94° C. for 30 sec
60° C. for 30 sec
72° C. for 1 minute plus 10 sec/cycle

1 Cycle:
72° C. for 7 minutes
4° C. hold

I. Construction of PCR Pools

Eight unique PCR pools were constructed as follows.

Amplicons from the 5 genes—AKT1, KRAS, PIK3CA, PTEN, and TP53—were generated as described above and pooled in eight unique configurations. As shown below in TABLE 4, each pool in the set of 8 pools has a unique composition of exonic amplicons. Each of these eight unique pools was fragmented, blunt-ended, and then each pool was itself attached to a set of eight bar-coded stem-loop linkers that were synthesized, using the stem-loop first linker (SEQ ID NO:105), with an additional 3 nucleotide sequence tag (molecular bar code) added to the 3′ end of the stem-loop linker. In this way, each of 8 unique pools was attached to a set of eight bar codes, generating the complete set of 64 bar coded samples shown in TABLE 5.

TABLE 4
Compositions of Amplicon Pools

| | | Pool | Pool | Pool | Pool | Pool | Pool | Pool | Pool |
|---|---|---|---|---|---|---|---|---|---|
| Gene | Exon | 1 | 2 | 3 | 4 | 5 | 6 | 7 | 8 |
| AKT1 | 1 | -- | | | | | | | |
| AKT1 | 3 | | -- | | | | | | |
| AKT1 | 6-7 | | | -- | | | | | |
| AKT1 | 8 | | | | -- | | | | |
| AKT1 | 12 | | | | | -- | | | |
| KRAS | 1 | | | | | | -- | | |
| KRAS | 4 | | | | | | | -- | |
| PIK3CA | 17 | | | | | | | | -- |
| TP53 | 1 | -- | | | | | | | |
| AKT1 | 2 | | -- | | | | | | |
| AKT1 | 4 | | | -- | | | | | |
| AKT1 | 9-10 | | | | -- | | | | |
| AKT1 | 11 | | | | | -- | | | |
| AKT1 | 14 | | | | | | -- | | |
| PIK3CA | 1 | | | | | | | -- | |
| PIK3CA | 4 | | | | | | | | -- |
| PTEN | 9 | -- | | | | | | | |
| PIK3CA | 19-20 | | -- | | | | | | |
| AKT1 | 5 | | | -- | | | | | |
| AKT1 | 13 | | | | -- | | | | |
| KRAS | 2 | | | | | -- | | | |
| KRAS | 3 | | | | | | -- | | |
| KRAS | 5 | | | | | | | -- | |
| PIK3CA | 2 | | | | | | | | -- |
| PIK3CA | 3 | -- | | | | | | | |
| PIK3CA | 5 | | -- | | | | | | |
| PIK3CA | 6 | | | -- | | | | | |
| PIK3CA | 7 | | | | -- | | | | |
| PIK3CA | 8-9 | | | | | -- | | | |
| PIK3CA | 10 | | | | | | -- | | |
| PIK3CA | 11 | | | | | | | -- | |
| PIK3CA | 12-13 | | | | | | | | -- |
| PIK3CA | 14 | -- | | | | | | | |
| PIK3CA | 15 | | -- | | | | | | |
| PIK3CA | 16 | | | -- | | | | | |
| PIK3CA | 18 | | | | -- | | | | |
| PIK3CA | 21 | | | | | -- | | | |
| PTEN | 1 | | | | | | -- | | |
| PTEN | 2 | | | | | | | -- | |
| PTEN | 3 | | | | | | | | -- |
| PTEN | 4 | -- | | | | | | | |
| PTEN | 5 | | -- | | | | | | |
| PTEN | 6 | | | -- | | | | | |
| PTEN | 7 | | | | -- | | | | |
| PTEN | 8 | -- | -- | -- | -- | | -- | -- | -- |
| TP53 | 2-3 | -- | -- | -- | -- | -- | | -- | -- |
| TP53 | 4 | -- | -- | -- | -- | -- | -- | | -- |
| TP53 | 5-6 | -- | -- | -- | -- | -- | -- | -- | |
| TP53 | 7 | | -- | -- | -- | -- | -- | -- | -- |
| TP53 | 8-9 | -- | | -- | -- | -- | -- | -- | -- |
| TP53 | 10 | -- | -- | | -- | -- | -- | -- | -- |
| TP53 | 11 | -- | -- | -- | | -- | -- | -- | -- |

Note:
the symbol “--” indicates the pool is missing this PCR product.

For example, one representative bar-coded forward stem-loop linker oligonucleotide, designated as the first bar code in Pool #1 (“AAA”) in TABLE 5 (shown in italics) is added to SEQ ID NO:105, resulting in the following sequence:

(SEQ ID NO: 108)
5′TTTAGATCGGAAGAGCGTAATGATACGGCGACCACCGACACTCTTTC
CCTACACGACGCTCTTCCGATCTAAA3′.

This set of eight unique samples was matched with all 64 3 nucleotide codes in groups of eight, as shown below in TABLE 5.

TABLE 5
Bar Codes

| | 1st | 2nd | 3rd | 4th | 5th | 6th | 7th | 8th |
|---|---|---|---|---|---|---|---|---|
| | bar | bar | bar | bar | bar | bar | bar | bar |
| | code | code | code | code | code | code | code | code |
| Pool 1 | AAA | AGA | CAA | CGA | GAA | GGA | TAA | TGA |
| codes | | | | | | | | |
| Pool 2 | AAC | AGC | CAC | CGC | GAC | GGC | TAC | TGC |
| codes | | | | | | | | |
| Pool 3 | AAG | AGG | CAG | CGG | GAG | GGG | TAG | TGG |
| codes | | | | | | | | |
| Pool 4 | AAT | AGT | CAT | CGT | GAT | GGT | TAT | TGT |
| codes | | | | | | | | |
| Pool 5 | ACA | ATA | CCA | CTA | GCA | GTA | TCA | TTA |
| codes | | | | | | | | |
| Pool 6 | ACC | ATC | CCC | CTC | GCC | GTC | TCC | TTC |
| codes | | | | | | | | |
| Pool 7 | ACG | ATG | CCG | CTG | GCG | GTG | TCG | TTG |
| codes | | | | | | | | |
| Pool 8 | ACT | ATT | CCT | CTT | GCT | GTT | TCT | TTT |
| codes | | | | | | | | |

The 8 pools were made by generating amplicons for the 5 selected genes, as described in Example 1, which were used to make eight unique pools by (1) leaving out one of eight rows of PCR fragments and pooling 20 μl of the remaining samples, (2) adding an additional 100 μl of weakly amplified products (unless they were designated to be left out), and (3) adding 200 μl of a unique PCR fragment to each pool. The pools were purified over four Qiaquick® columns. The samples were eluted in 60 μl of elution buffer per column, yielding about 200 μl. DNA quantitation by nanodrop revealed a DNA concentration range of 120 to 150 ng/μl, with a total yield of 24-30 μg.

Dephosphorylation of Stem-Loop Adaptors with Bar Code Tags

Sixty-four bar-coded stem-loop linker oligonucleotides were synthesized that contained the sequence of SEQ ID NO:105 plus three additional nucleotides added to the 3′ end of SEQ ID NO:105 as shown in TABLE 5, for example, the first bar code (“AAA”) in Pool #1=SEQ ID NO:108.

The 64 bar-coded stem-loop linker oligos were suspended in water to 100 μM, then an aliquot of 10 μM was made by adding 20 μl stock oligo to 180 μl water.

Phosphatase Reaction

5 μl (10 μM stem-loop linker)

5 μl 10× dephosphorylation buffer

5 μl phosphatase enzyme

35 μl H₂O

The reaction was incubated at 37° C. for one hour followed by incubation at 65° C. for 5 minutes.

Preparation of Amplicon Pools for Ligation

Eight pools comprising various combinations of amplicons were mixed as shown in TABLE 4. The amplicon pools were treated with DNase I in the presence of Mn⁺⁺ as described in Example 1 to yield DNase I digested fragments, which were then purified over Qiaquick® columns (Qiagen Corp.) to generate a pool of fragments in the size range averaging in length from about 50 bp to about 500 bp. The purified fragments were then filled in as described in Example 1 with the Quick Blunting® Kit (New England Biolabs, Catalog #E1201L) according to the manufacturer's instructions. The Quick Blunting® Kit includes a reaction mixture with T4 polymerase (which has both 3′ to 5′ exonuclease activity and 5′ to 3′ polymerase activity) and T4 polynucleotide kinase (for phosphorylation of the blunt-ended DNA for subsequent ligation to the stem-loop linkers). The reaction was incubated at room temperature for 30 minutes then at 70° C. for 10 minutes.

Ligations of Stem-Loop Linkers to Amplicon Fragment Pools

For each pool (of 8 pools), a master mix was first prepared:

20 μl of blunt end (filled-in), fragmented amplicon pool DNA

40 μl of second stem-loop linker #1 (SEQ ID NO:106)

100 μl 2× ligation buffer

160 μl total volume of master mix

16 μl of the master mix was aliquoted into each of a series of 8 bar-coded forward stem-loop linkers:

(e.g., pool 1=SEQ ID NO:105+ first to eighth bar code sequence shown in TABLE 5). One μl of ligase was then added to each tube and incubated for 10 minutes. The 20 μl ligation mix was then diluted 10-fold into TEzero and 2 μl of this was added to subsequent 20 μl PCR reactions as follows.

Post-Ligation PCR Reactions to Selectively Amplify the Target Ligation Products (Suppression PCR)

80×20 μl PCR reactions were run as follows:

2 μl diluted ligation mix (e.g., for pool 1: SEQ ID NO:105+3 nucleotide linkers first to eighth bar code sequences—pool 1 amplicons—SEQ ID NO:106, opposite orientation, and ligation byproducts)

4 μl 5× buffer (supplied by the manufacturer with the EXPANDₚₗᵤₛ® kit, Roche)

1.2 μl 25 mM MgCl₂

0.4 μl dNTPs (10 mM each dNTP)

1 μl DMSO

2 μl (4 μM) First PCR primer:
(SEQ ID NO: 109)
5′-AATGATACGGCGACCACCGA-3′
2 μl (4 μM) Second PCR primer:
(SEQ ID NO: 110)
5′-CAAGCAGAAGACGGCATACG-3′

1.0 μl enzyme (1:1 blend of Roche Expand^{Plus}® and InVitrogen Taq)

7 μl water

20 μl total

PCR Cycling Conditions:

1 Cycle:

72° C. for 1 minute; 94° C. for 1 minute. (Note: This step copies the sequence from the ligated stem-loop linker to the complementary strand.)

10 Cycles:
94° C. 30 sec
55° C. or 60° C. 30 sec
72° C. 30 sec

15 Cycles:
94° C. 30 sec
55° C. or 60° C. 30 sec
72° C. 30 sec+10 sec/cycle

72° C. 7 minutes

4° C. hold

5 μl of each of the PCR products were analyzed on an agarose gel. 10 μl aliquots of the remaining material was pooled into a single tube, purified over a QiaQuick® column and submitted for sequencing.

Results

Agarose gel analysis showed that the amplicon pools prior to DNase I digestion had discrete banding patterns. As expected, after DNase I digestion and Qiaquick® purification, a smear was observed without a discrete banding pattern, with a cut-off in size of fragments smaller than 40 bp (due to the column purification step). Importantly, it was observed that the additional bar code sequence added to the stem-loop linkers did not change the ligation reaction, as determined from a side-by-side comparison of ligation products on an agarose gel.

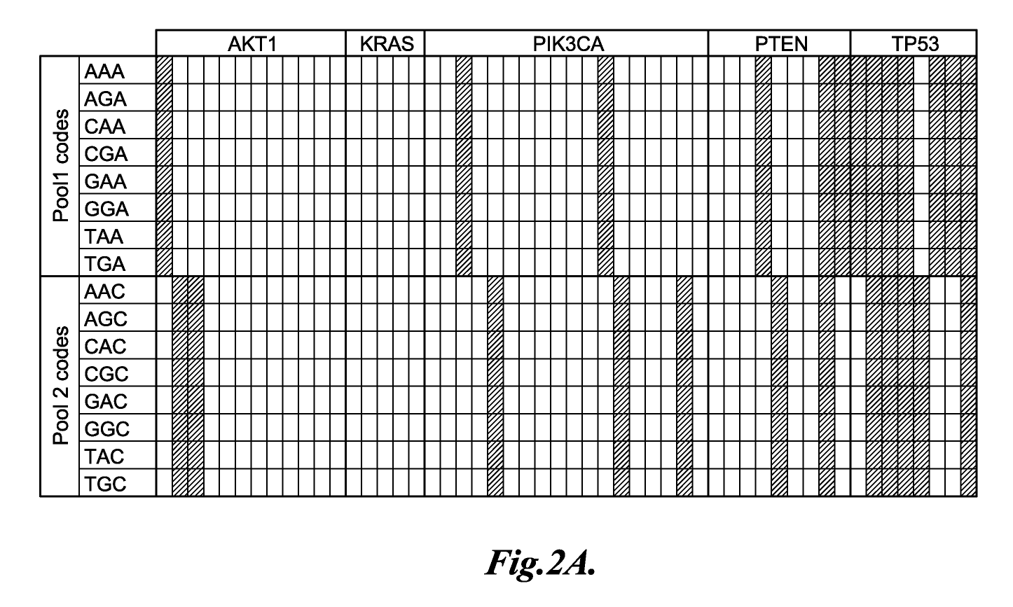

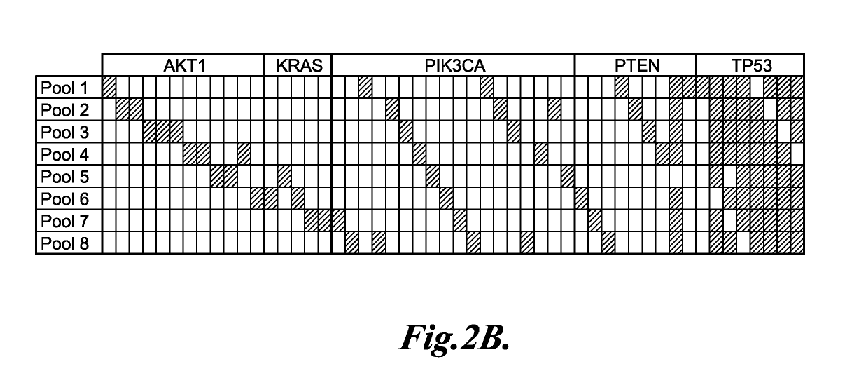

The 64 individual samples were pooled and sequenced on an Illumina GA® sequencing instrument. A total of 3,901,100 sequencing reads were obtained that could be uniquely aligned back to the target regions. To determine if the bar codes were accurately associated with the correct samples, the reads were sorted in two dimensions, as shown in FIG. 2A. In FIG. 2A, each row corresponds to the sequencing read density (i.e., number of sequencing reads) associated with a particular 3 nucleotide barcode sequence and each column corresponds to the sequencing reads associated with each gene exon region to which the sequence read aligned. In FIG. 2A, boxes are white (not shaded) if abundant sequencing reads were detected (≧80% of the average read counts over all bar codes) and black (shaded) if few reads were detected (≦10% of the average counts over all bar codes). FIG. 2A shows both the expected and observed distribution of reads, which exhibited an identical distribution and could therefore be represented in a single FIGURE. Notably, the pattern of abundant and underrepresented reads was perfectly consistent for all of the bar codes associated with pool 1 and pool 2, and, although not shown, for all eight groups of bar codes analyzed. These results demonstrate that all eight barcode sequences ligated to pool 1 or pool 2 DNA exhibited that same pattern of read densities (which was also true of the entire set of 64 codes used in this experiment—data not shown).

The results shown in FIG. 2A are summarized in FIG. 2B, in which the expected and observed pattern of read alignment densities for each pool of bar coded samples is shown. To obtain the sequencing read densities for the pools, the data from the eight bar codes that formed each pool were summed and analyzed relative to the average density of sequencing reads. Here again, the results can be shown as a single FIGURE because the expected and observed results were identical (i.e., the results shown in FIG. 2A matched the composition of the pools prepared as described in TABLE 4).

As noted above, a small but nonetheless significant percentage of bar coded reads aligned to exonic regions that were not present in pools (˜5% of the average read density relative to pools that included the exonic amplicon). This error rate in assigning bar codes is much higher than the intrinsic sequencing error rates observed throughout the data set, suggesting that incorrect read assignment arises from a different source. At present, it is believed that alkaline phosphatase treatment of the stem-loop ligation adaptors removes one or two bases from the 3 nucleotide code at rather significant frequencies. The consequence would be attachment of a truncated code that is subsequently misinterpreted. Thus, one way to reduce the observed error rate in assigning bar codes would be to purify the oligonucleotides to remove partially truncated barcode sequences prior to use using standard techniques well known in the art.

This example describes the use of a 3 nucleotide tag (molecular bar code) for each first stem-loop linker, resulting in 8 pools, each having 8 unique sequence tags per pool, for a total of 64 tagged sources. For example, pool 1 is a pool of the amplicons listed in TABLE 4 that were generated using first adaptor stem loop primer pool 1 codes: (AAA; AGA, CAA, CGA, GAA, GGA, TAA, and TGA). It will be understood by those of skill in the art that alternative arrangements of the length of the nucleotide tag can provide varying levels of complexity. For example, a 1 nucleotide tag provides a 4 plex; a 2 nucleotide tag provides a 16 plex, a 3 nucleotide tag provides a 64 plex; and a 4 nucleotide tag provides a 256 plex, etc.

As stated above, the output of sequence information from, for example, the Illumina GA2® sequencer, far exceeds the data requirements for analysis of individual samples. Multiplexing strategies are required to make full use of these emerging sequencing technologies and to increase the throughput of samples that can be analyzed. The results described in this example validate the feasibility of adding trinucleotide molecular barcodes to individual samples, facilitating the simultaneous analysis of 64 samples. Other configurations of bar code complexity (nucleotide length) can be applied to samples that require greater or lesser sequence coverage.

As shown in FIG. 3, this example demonstrates a method of generating a sequencing-ready library 600 comprising the steps of fragmenting a starting population of DNA molecules 610, attaching stem-loop linkers with primer binding sides and optional bar codes 620, and suppressing PCR 630 to generate the sequencing-ready library, which can be sequenced 640. In some embodiments of the method, the starting population of DNA molecules is PCR amplified target regions; therefore, the sequence ready library is already enriched for the sequencing target(s) of interest. As further shown in FIG. 3, in other embodiments of the method of generating a sequencing-ready library 600, the method further comprises the steps of solution-based capture 650 to enrich the library (e.g., a library generated from total genomic DNA or whole amplified transcriptome) for the sequencing targets of interest prior to sequencing, as described in Examples 3-8 and shown in FIG. 6.

### Example 2

This example describes the generation of a sequencing-ready library of genomic DNA inserts. Such libraries can be used for solution-based capture targeted resequencing methods as described below, for analysis of sequence-based chromosomal copy number variation or for biomarker screening/discovery.

Rationale

While PCR is ideally suited for the resequencing of a small number of targets in a modest number of samples, the logistical complexity of large-scale resequencing studies becomes unwieldy as target sizes and sample numbers expand. In fact, such experiments expand in size and complexity as a function of the number of amplicons and samples to be analyzed. To accommodate resequencing of hundreds of genes in hundreds of samples, a different experimental approach to targeted resequencing was required in which resequencing targets could be collected from each sample in a single procedure. To perform this procedure, a collection of oligonucleotides complementary to target resequencing regions is annealed to a whole genome fragment library. The collection of sequences bound to these probes can then be characterized by sequencing. The overall procedure, termed “solution-based capture,” is an alternative to PCR that can be scaled to very large resequencing regions. This example describes the construction and characterization of genomic DNA libraries to be used in such a procedure.

With reference to FIG. 3, this example describes an embodiment of the method of generating a sequencing-ready library 600 by fragmenting a starting population of genomic DNA 610, ligating stem-loop linkers to the DNA fragments 620, suppressing PCR to enrich the library for ligation products with heterogeneous linkers 630, and followed by one or more rounds of solution-based capture 650 to enrich the library for sequencing targets of interest.

In this example, genomic DNA was used as the starting material for the library, although cDNA could also be used as starting material to generate a library. With the exception of the starting material used to generate the inserts for the library, the process of generating the library using stem-loop linkers was nearly identical to that described in Example 1.

Methods

A. Genomic Library Construction

Library construction involved the generation of inserts by fragmentation of genomic DNA or cDNA, followed by blunt-end polishing and ligation of 5′ and 3′ stem-loop linkers to the blunt-end inserts. The 5′ and 3′ stem-loop linkers are key elements of the library construction because they provide universal anchors for subsequent PCR and optional sequencing cluster generation, they can be used to introduce bar-codes for sample multiplexing, as described in Example 1, and suppressing PCR may be used to enrich for a library containing heterogeneous stem-loop adaptors at each end of the insert, as shown in FIG. 1 step C, which can be used as templates for sequencing.

Preparation of Stem-Loop Adaptors

The sequence design of the stem-loop linkers is described in Example 1. An exemplary set of stem-loop linkers used in this example are SEQ ID NO:105 (first stem-loop linker #1) and SEQ ID NO:107 (second stem-loop linker #2).

The forward stem-loop linkers (SEQ ID NO:105) were bar coded as follows:

Four bar codes were used in this experiment, which were chosen to represent all four bases in each of the three base positions, and homopolymers were avoided.

In order to reduce the level of primer-dimer background material, prior to ligation, the stem-loop linkers were pre-treated with Antarctic alkaline phosphatase (New England Biolabs Catalog #M0289S), as described in Example 1.

100 μM stem-loop linkers (SEQ ID NO:105 and SEQ ID NO:107) were dephosphorylated and reconcentrated to approximately 10 μM as follows:

20 μl of 100 μM (SEQ ID NO:105)

20 μl of 100 μM (SEQ ID NO:107)

100 μl of 10× phosphatase buffer (supplied by manufacturer, New England Biolabs)

800 μl water

80 μl of Antarctic phosphatase.

The reaction was incubated at 37° C. for one hour and heat inactivated at 65° C. for 5 minutes. The reaction mixture was then split into two tubes and precipitated by adding 3 μl Glyco-blue (Ambion Catalog #AM9516), 60 μl of 3 M NaOAc pH 5.2, and 1200 μl of ethanol per tube, mixed and centrifuged at 12K at 4° C. for 20 minutes. The solvent was aspirated away from the pellet, which was resuspended in 100 μl of water. The recovery of the oligo linker was in the range of approximately 50%, with a final concentration of about 10 μM, which was determined by nanodrop.

Sonication Treatment

In some embodiments of the method of the invention, genomic DNA was fragmented by sonication prior to DNAse I treatment as follows.

Genomic DNA was diluted in water or in a Tris buffer (2 μg DNA with 500 μL 50 mM Tris) without EDTA and without Mn⁺⁺ (Note: EDTA will chelate the Mn⁺⁺ ions needed by the DNAse I in the next step). If EDTA was present in the sonication buffer, then a clean-up step (e.g., Qiagen Qiaquick® column) was used to remove the EDTA prior to DNAse I treatment.

Sonication was carried out in a 1.5 mL tube in an ice-water slurry, such that the sonication instrument tip was inserted into the DNA containing solution at the depth of the 100 ul mark. Sonication for each sample was carried out for 4 minutes with an amplitude of 45%, pulse on=20 seconds, pulse off=50 seconds.

The sonicated sample was then treated with DNAse I as described below.

B. DNase I Treatment of Genomic DNA

As described in Example 1, it was determined that bovine pancreatic deoxyribonuclease I (DNase I) induces random double-stranded breaks in DNA in the absence of Mg⁺⁺ and in the presence of Mn⁺⁺.

DNase I Digestion:

20 μl (2 μg) of total human genomic DNA (Clontech)

10 μl 10× reaction buffer (50 mM Tris pH 7.6 0.5 mg/ml acetylated BSA)

12.5 μl 40 mM MnCl₂

47.5 μl water

10 μl DNase I (N.E.B. Cat. No. M0303S, diluted 1:1500* in 1× buffer (100 μl 10× buffer, 125 μl MnCl₂, and 775 μl water)

100 μl total volume

The DNase I reaction was incubated at room temperature for 10 minutes and stopped by the addition of 0.2 volumes of 100 mM EDTA and immediately transferred to ice.

*The dilution of DNAse was chosen to generate fragments averaging in length from about 50 to about 500 bp, which was determined using a DNase I dilution series as described in Example 1.

The reaction mixture was then purified over a Qiaquick® spin column (Qiagen), with a recovery of about 40% of the input DNA in about 200 with a size cut-off below about 40 bp. The column purified DNA was then concentrated by precipitation and resuspended in water to a final concentration of 80 ng/μl.

C. Blunt-End Polishing, Ligation and PCR of Target Ligation Products
(i) The DNase I treated genomic DNA was blunt-end treated as follows:

10 μl DNAse treated genomic DNA (80 ng/μl)

10 μl 2× blunt buffer (NEB Quick Blunt Reaction #E120S)

4 μl 10× blunt buffer (NEB Quick Blunt Reaction #E120S)

4 μl dNTP (10 mM in each dNTP)

10.4 μl H₂O

1.6 μl T4 polymerase plus T4 polynucleotide kinase enzyme

40 μl total

The reaction was incubated at room temperature for 30 minutes, then heated at 70° C. for 10 minutes to yield approximately at least 40 ng/μl of DNase I treated and blunt end-polished genomic DNA that was ready for ligation to the stem-loop linkers.
(ii) Ligations between phosphatase treated stem-loop linkers and DNase I treated genomic DNA were carried out as follows:

10 μl 2× buffer (NEB Quick Ligation kit (#M2200S)

2 μl DNase I treated and blunt end polished gDNA (40 ng/μl)

4 μl (SEQ ID NO:105) first stem-loop linker #1, phosphatase treated (10 μM) (Note: Separate ligation reactions were carried out with each uniquely bar-coded stem-loop linker #1)

4 μl (SEQ ID NO:107) second stem-loop linker #2, phosphatase treated (10 μM)

1 μl Quick Ligase® (NEB Quick Ligation Kit) (#M2200S)

20 μl total

The ligation reaction was incubated at room temperature for 10 minutes (not heat inactivated) then diluted with 180 μl of TEzero (10 mM Tris pH 7.6 and 0.1 mM EDTA) and stored at −20° C. or used in the PCR amplification step described below.

(Note: The overall concentration of vector plus insert was preferably between 1 to 10 μg/ml for efficient ligation. For ligation products with single insertions, vector:insert ratios between 2:1 and 6:1 were preferable. It was observed that vector:insert ratios below 2:1 resulted in lower ligation efficiency, while vector: insert ratios above 6:1 promoted multiple inserts.)
(iii) PCR Amplification of Ligation Reaction (Suppression PCR)

PCR was used to produce >5 μg of product for the first round of solution-based target capture and enrichment. In order to generate this amount of product, 4×100 μl PCR reactions were carried out for each library generated.

First PCR primer:
(SEQ ID NO: 109)
5′-AATGATACGGCGACCACCGA-3′
Second PCR primer:
(SEQ ID NO: 110)
5′-CAAGCAGAAGACGGCATACG-3′

PCR Reaction Mixture with 5% DMSO:

10 μl DNA template (the ligation mixture described above diluted 10-fold with TEzero)

20 μl 5× buffer (supplied by the manufacturer with the EXPAND^{plus}® kit, Roche)

10 μl 25 mM MgCl₂

10 μl 10 μM First PCR primer (SEQ ID NO:109)

10 μl 10 μM Second PCR primer (SEQ ID NO:110)

5 μl DMSO (100%)

5 μl dNTPs (10 mM in each dNTP)

30 μl H₂O

1 μl Taq Polymerase (Invitrogen)

1 μl EXPAND^{PLUS}® Polymerase (Roche)

100 μl total

PCR Cycling Conditions:

1 Cycle:

72° C. for 1 minute; 94° C. for 2 minutes. (Note: This step copies the sequence from the stem-loop linker to the complementary strand.)

10 Cycles:
94° C. for 30 sec
60° C. for 30 sec
72° C. for 1 minute

10 Cycles:
94° C. for 30 sec
60° C. for 30 sec
72° C. for 1 minute plus 10 sec/cycle

1 Cycle:
72° C. for 7 minutes
4° C. hold

D. Evaluation of Library Quality

Two standard modes were used to evaluate library quality. The first was to load 100 ng of purified library PCR product on a 2% agarose gel followed by visual inspection of size distribution of the library. The minimum size range of the library was expected to be ≧130 bp, which is the sum of the adaptor sequences left over after PCR (90 bp) and the minimum insert size of 40 bp. Smaller bands are indicative of ligated adaptor dimers and libraries with detectable quantities of this material were rejected. We expected the bulk of library material to be a smear that ranges in size from 140 bp to 800 bp. Libraries dominated by longer fragments than this size range show poor capture performance and the resulting sequences are spread over a large area, requiring excessive sequencing to obtain the desired sequencing depth.

While visual inspection provided information on the bulk library characteristics, it could not be used to assess the content of sequences present.

To assess specific gene content of libraries, real-time PCR with TaqMan assays were carried out as follows.

As a typical example, a 100 μl PCR reaction mixture was purified over a Qiaquick® column (Qiagen) and the DNA was quantified. As shown in FIG. 3, the purified DNA comprises a sequence-ready library (at step 630), which can be directly sequenced (at step 640) or enriched for target sequences (as shown in FIG. 3, steps 650-670) prior to sequence analysis.

The gene content of the library was measured and compared to a reference genomic DNA sample using qPCR. A panel of four gene-specific quantitative PCR (qPCR) assays were used (AKT1, KRAS, PIK3CA, and PTEN). The libraries and reference genomic DNA were adjusted to uniform 10 ng/μl concentrations prior to measurement.

qPCR Reaction Mixture:

200 μl 2× TaqMan master mix (provided by the manufacturer, Applied Biosystems)

100 μl H₂O

20 μl primer/probe

220 μl total

8 μl of the qPCR reaction mixture was then aliquoted into a well of a 384 well qPCR plate. 2 μl of DNA template was added. The qPCR reactions were conducted on an ABI 7900 real-time instrument in a 384 well format using the manufacturer's recommended PCR conditions over 40 cycles.

qPCR Results:

The Counts (cts) were converted to raw quantities with the following formula:

Raw Quantity=10^{((log 10(1/2)*Ct)+10)}

The % raw abundance of library samples relative to the reference genomic DNA was then calculated. It was observed that the abundances of gene content in the libraries fell short of the reference for gene content. While not wishing to be bound by theory, the reason for this was believed to be two-fold—first, enzymatic shearing created a high likelihood of digesting within a qPCR TaqMan primer binding site, therefore sheared DNA would be expected to have a lower gene-specific activity than an unsheared reference genomic DNA control; second, the stem-loop linkers represented a substantial mass in the library (e.g., in a library with 100 bp inserts, half the mass of the library is adaptor). Therefore, a substantial portion of the mass of library DNA is comprised of ligated linkers.

TABLE 6 shows the relationship between insert size, the % of library composed of adaptor, and the TaqMan signal detected. The key point for assessing library quality was that gene content was readily detectable (target genomic DNA is present in the initial library and the insert size is ≧50 bp) and that insert size is not excessive, as judged by gel appearance combined with qPCR.

TABLE 6
Decrease in PCR Signal as a Function of Decreasing Insert Sizes

| Average Insert Size | % Stem-Loop Linker | % of gDNA Signal |
|---|---|---|
| 10 | 91 | 0.00 |
| 20 | 83 | 0.28 |
| 25 | 80 | 0.8 |
| 30 | 77 | 1.5 |
| 40 | 71 | 4 |
| 50 | 67 | 7 |
| 60 | 63 | 10 |
| 70 | 59 | 13 |
| 80 | 56 | 16 |
| 100 | 50 | 22 |
| 150 | 40 | 35 |
| 200 | 33 | 45 |
| 400 | 20 | 65 |
| 1000 | 9 | 84 |

These quality assessments were applied to the nine sample libraries described in this example. The agarose gels (not shown) produced the desired size distribution of fragments, ranging in size from ≧130 bp to ≦800 bp; the majority of fragments were in the 200-400 bp size range.

The results of qPCR for the libraries using four of the genes are shown below in TABLE 7.

TABLE 7
qPCR Results of the Gene Content of Representative Libraries

| | | | | | | | | | | 100+ | 200+ |
|---|---|---|---|---|---|---|---|---|---|---|---|
| | | | | | | | | | | con- | con- |
| %'s | lib1 | lib2 | lib3 | lib4 | lib5 | lib6 | lib7 | lib8 | lib9 | trol | trol |
| Gene | | | | | | | | | | | |
| AKT1 | 5 | 32 | 53 | 11 | 4 | 11 | 14 | 5 | 12 | 11 | 38 |
| KRAS | 24 | 48 | 31 | 25 | 17 | 14 | 18 | 16 | 23 | 21 | 45 |
| PIK3CA | 6 | 10 | 34 | 13 | 18 | 16 | 7 | 5 | 14 | 24 | 34 |
| PTEN | 7 | 34 | 35 | 15 | 7 | 15 | 19 | 13 | 19 | 16 | 39 |
| average | 11 | 31 | 38 | 16 | 12 | 14 | 14 | 10 | 17 | 18 | 39 |
| insert | 60 | 150 | 150 | 80 | 70 | 70 | 70 | 60 | 80 | 80 | 150 |
| size | | | | | | | | | | | |

The qPCR signal for genes, shown in rows in TABLE 7, is reported as a percent of the signal detected in unsheared genomic DNA. The combined values for four genes and the numerical averages for each library are shown in columns. The 100+ control and 200+ controls corresponded to well-characterized genomic libraries with known insert sizes and gene content. Here it can be seen that the nine libraries reported as an example all produced qPCR measurements consistent with the creation of useful libraries. Gel analysis showed a desirable distribution of fragment sizes and qPCR gave consistent results showing gene content metrics comparable to the two well-characterized control samples. These results show that the genomic libraries generated using these methods have the desired insert size and gene content representative of the starting genomic DNA.

### Example 3

This example describes the use of solution-based capture from a sequencing-ready library generated from genomic DNA using biotinylated capture oligos in order to enrich the 52 coding exons from 5 target genes for subsequent resequencing studies.

Rationale

In contrast to generation of resequencing libraries with PCR-generated starting material (e.g., as described in Example 1), the generation of a genomic library followed by solution-based sequence capture eliminates the need for the initial step of individually PCR-amplifying the regions of interest. Therefore, as shown in FIG. 3, the use of solution-based capture requires manipulation of a single sample throughout the resequencing library construction process, regardless of the size or complexity of the target region that is being addressed. An additional advantage is that the capture of target sequences can be applied in several rounds, with PCR amplification of the enriched library fractions between steps. This allows for the creation of resequencing samples that are largely composed of target sequences.

As shown in FIG. 4, the central basis of solution-based direct capture is the annealing of the library comprising ligation products 50A, 50B with sense 100 and anti-sense 100′ capture probes, thereby forming a plurality of bi-molecular DNA complexes (at step B) between a target strand (e.g., 50A) and a target insert sequence-specific capture probe 100 comprising a moiety 110 that binds a capture reagent 400. Following annealing, these bi-molecular DNA complexes are bound by the capture reagent 400, such as streptavidin-coated 410 paramagnetic beads, which are then purified away from the bulk solution by magnetic retention to a magnetic source 500.

For example, as shown in more detail in FIG. 4 at step A, a representative nucleic acid molecule 50A is shown that is a member of a library comprising a population of double-stranded nucleic acid molecules 50A, 50B. Each double-stranded nucleic acid molecule 50A, 50B in the library comprises an insert 10 with a candidate nucleic acid sequence flanked by a first linker region 20 and a second linker region 30.

Although this example was carried out using a library made from fragmented genomic DNA, it will be understood by those of skill in the art that the population of inserts 10 with candidate nucleic acid sequences for solution-based capture may be generated from genomic DNA or cDNA (as described in Example 2) or from PCR products (as described in Example 1).

As shown in FIG. 4 at step A, a population of sense target capture probes 100 and a population of anti-sense target capture probes 100′ are mixed with the denatured library comprising sense 50A, 50B nucleic acid molecules and anti-sense 50A′, 50B′ nucleic acid molecules. Each sense target capture probe 100 comprises a target-specific binding region 102 having a nucleic acid sequence that is substantially complementary to the sense strand of a target insert 10 of interest, and a region 104 for attaching a moiety 110 for binding to a capture reagent 400 (e.g., streptavidin-coated magnetic beads).

Similarly, each anti-sense target capture probe 100′ comprises a target-specific binding region 102′ having a nucleic acid sequence that is substantially complementary to the anti-sense-strand of a target insert 10′ of interest, and a region 104 for attaching a moiety 110 for binding to a capture reagent 400 (e.g., streptavidin-coated magnetic beads).

In operation, as shown in FIG. 4, step B, the target-specific binding region 102 of sense 100 or antisense 100′ target capture probes bind to a substantially complementary nucleic acid sequence contained in an insert region 10 or 10′ of a nucleic acid molecule 50 in the library. The moiety 110 (e.g., biotin) attached to the capture probe 100, 100′ is then contacted with a capture reagent 400 (e.g., a magnetic bead) having a binding region 410 (e.g., streptavidin coating) and pulled out of solution with a sorting device 500 that binds to the capture reagent 400, such as a magnet.

The solution-based capture method may be used to enrich a library for target sequences of interest. For example, as shown in FIG. 3, a sequencing-ready library generated from total genomic DNA 630, generated using the methods described, supra, includes a population of double-stranded nucleic acid molecules 50, each double-stranded nucleic acid molecule 50 comprising an insert 10 having a candidate nucleic acid sequence flanked by a first linker region 20 and a second linker region 30. Within the population of double-stranded nucleic acid molecules 50 in the library, there exists a subpopulation of molecules 50 that contain inserts 10 with target nucleic acid sequences within a greater population of molecules 50 that contain inserts 10 with non-target nucleic acid sequences. The subpopulation of molecules 50 that contain inserts 10 with target nucleic acid sequences may be captured in solution from the starting non-enriched genomic library using capture probes, leaving behind the larger population of molecules 50 that contain inserts 10 with non-target sequences.

With continued reference to FIG. 3, the non-enriched starting genomic DNA library 630, which is used in the first round of target capture, typically contains very few target sequences 10 in comparison to non-target sequences. In the solution-based capture methods at 650, in the first round of enrichment, the capture oligo probes are typically present in a molar excess in the first and second rounds of enrichment. An optional third round of enrichment may also be carried out which contains an excess amount of capture oligo probes that is reduced about 10-fold from the amount of capture oligo probes used in the second round of enrichment. Alternatively, a third round of enrichment may be carried out with a limiting amount of capture probe in order to normalize the content of the library (data not shown).

Methods

The libraries containing nucleic acid molecules with inserts containing target sequences of interest were generated as described above in Example 2, starting with genomic DNA, DNase I treating, blunt end polishing, and ligating on stem-loop linkers (SEQ ID NO:105 and SEQ ID NO:107), followed by 20 cycles of PCR and purification over a Qiaquick® column.

Solution-Based Capture Using Biotinylated Sequence Specific Oligonucleotide Capture Probes:

Capture Probes

A set of sense and antisense biotinylated capture oligos were generated that target the exons in the 5-gene set—AKT1, KRAS, PIK3CA, PTEN, and TP53—as shown below in TABLE 8. For exons less than 70 nucleotides in length, two sense oligos were synthesized. For exons of intermediate size (e.g., 70 nt to 200 nt), (referred to as “100+”) alternating targeting oligos evenly spaced on opposite strands were chosen. For regions longer than 200 nt (referred to as “200+”), alternating targeting oligos spaced at intervals of about 45 nt to 65 nt were chosen. The potential collection of capture oligos sequences were screened for sequences that would anneal to multiple places in the human reference genome. Such oligos were removed from the synthesis list and replaced by oligos that would be expected to anneal to a nearby site with more unique sequence characteristics.

The oligos were synthesized by Operon and provided at a concentration of 100 μM. The biotinylated oligos were pooled for subsequent validation of the solution-based capture methodology.

TABLE 8
Biotinylated Capture Oligos for Direct Capture (50-mers)

| Oligo | | SEQ |
|---|---|---|
| Reference | | ID |
| ID | Sequence | No: |
| AKT_2_1_S | [BioTEG]TGGGCTCGGGGAGCGCCAGCCTGAGAGGAGCGCGTGAGCGTC | 111 |
| | GCGGGAGC | |
| AKT_2_2_AS | [BioTEG]AACCCTCCTTCACAATAGCCACGTCGCTCATGGTGCCCGAGGC | 112 |
| | TCCCGCG | |
| AKT_3_3_S | [BioTEG]ACCTGGCGGCCACGCTACTTCCTCCTCAAGAATGATGGCACCT | 113 |
| | TCATTGG | |
| AKT_3_4_AS | [BioTEG]GTTGAGGGGAGCCTCACGTTGGTCCACATCCTGCGGCCGCTCC | 114 |
| | TTGTAGC | |
| AKT_4_5_S | [BioTEG]CTGATGAAGACGGAGCGGCCCCGGCCCAACACCTTCATCATCC | 115 |
| | GCTGCCT | |
| AKT_4_6_AS | [BioTEG]CTCCACATGGAAGGTGCGTTCGATGACAGTGGTCCACTGCAGG | 116 |
| | CAGCGGA | |
| AKT_5_7_S | [BioTEG]TGTGGCTGACGGCCTCAAGAAGCAGGAGGAGGAGGAGATGGA | 117 |
| | CTTCCGGT | |
| AKT_5_8_AS | [BioTEG]CCATCTCTTCAGCCCCTGAGTTGTCACTGGGTGAGCCCGACCG | 118 |
| | GAAGTCC | |
| AKT_6_9_S | [BioTEG]CCTGAAGCTGCTGGGCAAGGGCACTTTCGGCAAGGTGATCCTG | 119 |
| | GTGAAGG | |
| AKT_6_10_AS | [BioTEG]TCTTGAGGATCTTCATGGCGTAGTAGCGGCCTGTGGCCTTCTCC | 120 |
| | TTCACC | |
| AKT_7_11_S | [BioTEG]ACGAGGTGGCCCACACACTCACCGAGAACCGCGTCCTGCAGAA | 121 |
| | CTCCAGG | |
| AKT_7_12_S | [BioTEG]CACTCACCGAGAACCGCGTCCTGCAGAACTCCAGGCACCCCTT | 122 |
| | CCTCACA | |
| AKT_8_13_S | [BioTEG]GCCCTGAAGTACTCTTTCCAGACCCACGACCGCCTCTGCTTTGT | 123 |
| | CATGGA | |
| AKT_8_14_S | [BioTEG]AGACCCACGACCGCCTCTGCTTTGTCATGGAGTACGCCAACGG | 124 |
| | GGGCGAG | |
| AKT_9_15_S | [BioTEG]CGGGAGCGTGTGTTCTCCGAGGACCGGGCCCGCTTCTATGGCG | 125 |
| | CTGAGAT | |
| AKT_9_16_AS | [BioTEG]CACGTTCTTCTCCGAGTGCAGGTAGTCCAGGGCTGACACAATC | 126 |
| | TCAGCGC | |
| AKT_10_17_S | [BioTEG]ATGCTGGACAAGGACGGGCACATTAAGATCACAGACTTCGGGC | 127 |
| | TGTGCAA | |
| AKT_10_18_AS | [BioTEG]GGTGTGCCGCAAAAGGTCTTCATGGTGGCACCGTCCTTGATCC | 128 |
| | CCTCCTT | |
| AKT_11_19_S | [BioTEG]AGTGGACTGGTGGGGGCTGGGCGTGGTCATGTACGAGATGATG | 129 |
| | TGCGGTC | |
| AKT_11_20_AS | [BioTEG]CATGAGGATGAGCTCAAAAAGCTTCTCATGGTCCTGGTIGTAG | 130 |
| | AAGGGCA | |
| AKT_11_21_S | [BioTEG]AGATCCGCTTCCCGCGCACGCTTGGTCCCGAGGCCAAGTCCTT | 131 |
| | GCTTTCA | |
| AKT_12_22_S | [BioTEG]GCTTGGCGGGGGCTCCGAGGACGCCAAGGAGATCATGCAGCA | 132 |
| | TCGCTTCT | |
| AKT_12_23_AS | [BioTEG]CTTCTTCTCGTACACGTGCTGCCACACGATACCGGCAAAGAAG | 133 |
| | CGATGCT | |
| AKT_13_24_S | [BioTEG]CCCACCCTTCAAGCCCCAGGTCACGTCGGAGACTGACACCAGG | 134 |
| | TATTTTG | |
| AKT_13_25_AS | [BioTEG]GGTCAGGTGGTGTGATGGTGATCATCTGGGCCGTGAACTCCTC | 135 |
| | ATCAAAA | |
| AKT_14_26_S | [BioTEG]ATGACAGCATGGAGTGTGTGGACAGCGAGCGCAGGCCCCACTT | 136 |
| | CCCCCAG | |
| AKT_14_27_AS | [BioTEG]GCGCAGTCCACCGCCGCCTCAGGCCGTGCCGCTGGCCGAGTAG | 137 |
| | GAGAACT | |
| KRAS_2_1_S | [BioTEG]TGAAAATGACTGAATATAAACTTGTGGTAGTTGGAGCTGGTGG | 138 |
| | CGTAGGC | |
| KRAS_2_2_AS | [BioTEG]ATTCGTCCACAAAATGATTCTGAATTAGCTGTATCGTCAAGGC | 139 |
| | ACTCTTG | |
| KRAS_3_3_S | [BioTEG]GTCTCTTGGATATTCTCGACACAGCAGGTCAAGAGGAGTACAG | 140 |
| | TGCAATG | |
| KRAS_3_4_AS | [BioTEG]TGGCAAATACACAAAGAAAGCCCTCCCCAGTCCTCATGTACTG | 141 |
| | GTCCCTC | |
| KRAS_4_5_S | [BioTEG]TGTACCTATGGTCCTAGTAGGAAATAAATGTGATTTGCCTTCTA | 142 |
| | GAACAG | |
| KRAS_4_6_AS | [BioTEG]AGGAATTCCATAACTTCTTGCTAAGTCCTGAGCCTGTTTTGTGT | 143 |
| | CTACTG | |
| KRAS_5_7_S | [BioTEG]TGCCTTCTATACATTAGTTCGAGAAATTCGAAAACATAAAGAA | 144 |
| | AAGATGA | |
| KRAS_5_8_AS | [BioTEG]TTACACACTTTGTCTTTGACTTCTTTTTCTTCTTTTTACCATCTTT | 145 |
| | GCTC | |
| PIK3CA_2_1_S | [BioTEG]TTGATGCCCCCAAGAATCCTAGTAGAATGTTTACTACCAAATG | 146 |
| | GAATGAT | |
| PIK3CA 2_2_A | [BioTEG]CTTTATGGTTATTAATGTAGCCTCACGGAGGCATTCTAAAGTCA | 147 |
| S | CTATCA | |
| PIK3CA_2_3_S | [BioTEG]GTGTTACTCAAGAAGCAGAAAGGGAAGAATTTTTTGATGAAAC | 148 |
| | AAGACGA | |
| PIK3CA_2_4_A | [BioTEG]GTTCAATTACTTTTAAAAAGGGTTGAAAAAGCCGAAGGTCACA | 149 |
| S | AAGTCGT | |
| PIK3CA_3_5_S | [BioTEG]AGGACTTCCGAAGAAATATTCTGAACGTTTGTAAAGAAGCTGT | 150 |
| | GGATCTT | |
| PIK3CA_3_6_A | [BioTEG]GAGGATAGACATACATTGCTCTACTATGAGGTGAATTGAGGTC | 151 |
| S | CCTAAGA | |
| PIK3CA_4_7_S | [BioTEG]AAATAATGACAAGCAGAAGTATACTCTGAAAATCAACCATGAC | 152 |
| | TGTGTAC | |
| PIK3CA_4_8_A | [BioTEG]GTTCAGAGGATAGCAACATACTTCGAGTTTTTTTCCTGATTGCT | 153 |
| S | TCAGCA | |
| PIK3CA_4_9_S | [BioTEG]GTTTTAGAATATCAGGGCAAGTATATTTTAAAAGTGTGTGGAT | 154 |
| | GTGATGA | |
| PIK3CA_5_10_S | [BioTEG]CAATTTGATGTTGATGGCTAAAGAAAGCCTTTATTCTCAACTGC | 155 |
| | CAATGG | |
| PIK3CA_5_11_ | [BioTEG]CTCCATTCATATATGGTGTAGCTGTGGAAATGCGTCTGGAATA | 156 |
| AS | AGATGGC | |
| PIK3CA_5_12_S | [BioTEG]ATCCCTTTGGGTTATAAATAGTGCACTCAGAATAAAAATTCTTT | 157 |
| | GTGCAA | |
| PIK3CA_6_13_S | [BioTEG]ATCTATGTTCGAACAGGTATCTACCATGGAGGAGAACCCTTAT | 158 |
| | GTGACAA | |
| PIK3CA_6_14_ | [BioTEG]CTGGGATTGGAACAAGGTACTCTTTGAGTGTTCACATTGTCAC | 159 |
| AS | ATAAGGG | |
| PIK3CA_7_15_S | [BioTEG]ATGAATGGCTGAATTATGATATATACATTCCTGATCTTCCTCGT | 160 |
| | GCTGCT | |
| PIK3CA_7_16_ | [BioTEG]TAGCACCCTTTCGGCCTTTAACAGAGCAAATGGAAAGGCAAAG | 161 |
| AS | TCGAGCA | |
| PIK3CA_8_17_S | [BioTEG]TAAACTTGTTTGATTACACAGACACTCTAGTATCTGGAAAAAT | 162 |
| | GGCTTTG | |
| PIK3CA_8_18_ | [BioTEG]TAGGGTTCAGCAAATCTTCTAATCCATGAGGTACTGGCCAAAG | 163 |
| AS | ATTCAAA | |
| PIK3CA_9_19_S | [BioTEG]GGAGTTTGACTGGTTCAGCAGTGTGGTAAAGTTCCCAGATATG | 164 |
| | TCAGTGA | |
| PIK3CA_9_20_ | [BioTEG]TAAATCCTGCTTCTCGGGATACAGACCAATTGGCATGCTCTTCA | 165 |
| AS | ATCACT | |
| PIK3CA_10_21_ | [BioTEG]AGAGACAATGAATTAAGGGAAAATGACAAAGAACAGCTCAAA | 166 |
| S | GCAATTTC | |
| PIK3CA_10_22_ | [BioTEG]AAAATCTTTCTCCTGCTCAGTGATTTCAGAGAGAGGATCTCGTG | 167 |
| AS | TAGAAA | |
| PIK3CA_11_23_ | [BioTEG]ACACTATTGTGTAACTATCCCCGAAATTCTACCCAAATTGCTTC | 168 |
| S | TGTCTG | |
| PIK3CA_11_24_ | [BioTEG]CCAAATTGCTTCTGTCTGTTAAATGGAATTCTAGAGATGAAGT | 169 |
| S | AGCCCAG | |
| PIK3CA_12_25_ | [BioTEG]AACCTGAACAGGCTATGGAACTTCTGGACTGTAATTACCCAGA | 170 |
| S | TCCTATG | |
| PIK3CA_12_26_ | [BioTEG]CATCTGTTAAATATTTTTCCAAGCACCGAACAGCAAAACCTCG | 171 |
| AS | AACCATA | |
| PIK3CA_13_27_ | [BioTEG]TAAAATATGAACAATATTTGGATAACTTGCTTGTGAGATTTTTA | 172 |
| S | CTGAAG | |
| PIK3CA_13_28_ | [BioTEG]AATGCCAAAAGAAAAAGTGCCCAATCCTTTGATTAGTCAATGC | 173 |
| AS | TTTCTTC | |
| PIK3CA_14_29_ | [BioTEG]GCCTGCTTTTGGAGTCCTATTGTCGTGCATGTGGGATGTATTTG | 174 |
| S | AAGCAC | |
| PIK3CA_14_30_ | [BioTEG]CAGTTAAGTTAATGAGCTTTTCCATTGCCTCGACTTGCCTATTC | 175 |
| AS | AGGTGC | |
| PIK3CA_15_31_ | [BioTEG]GATGAAGTTTTTAGTTGAGCAAATGAGGCGACCAGATTTCATG | 176 |
| S | GATGCTC | |
| PIK3CA_15_32_ | [BioTEG]TTTCCTAGTTGATGAGCAGGGTTTAGAGGAGACAGAAAGCCCT | 177 |
| AS | GTAGAGC | |
| PIK3CA_16_33_ | [BioTEG]CGAATTATGTCCICTGCAAAAAGGCCACTGTGGTTGAATTGGG | 178 |
| S | AGAACCC | |
| PIK3CA_16_34_ | [BioTEG]AAAGATGATCTCATTGTTCTGAAACAGTAACTCTGACATGATG | 179 |
| AS | TCTGGGT | |
| PIK3CA_17_35_ | [BioTEG]ATTTACGGCAAGATATGCTAACACTTCAAATTATTCGTATTATG | 180 |
| S | GAAAAT | |
| PIK3CA_17_36_ | [BioTEG]ATTATTCGTATTATGGAAAATATCTGGCAAAATCAAGGTCTTG | 181 |
| S | ATCTTCG | |
| PIK3CA_18_37_ | [BioTEG]GTGGGACTTATTGAGGTGGTGCGAAATTCTCACACTATTATGC | 182 |
| S | AAATTCA | |
| PIK3CA_18_38_ | [BioTEG]TGTGTGGCTGTTGAACTGCAGTGCACCTTTCAAGCCGCCTTTGC | 183 |
| AS | ACTGAA | |
| PIK3CA_19_39_ | [BioTEG]CCATTGACCTGTTTACACGTTCATGTGCTGGATACTGTGTAGCT | 184 |
| S | ACCTTC | |
| PIK3CA_19_40_ | [BioTEG]CTTTCACCATGATGTTACTATTGTGACGATCTCCAATTCCCAAA | 185 |
| AS | ATGAAG | |
| PIK3CA_20_41_ | [BioTEG]TGGATCACAAGAAGAAAAAATTTGGTTATAAACGAGAACGTGT | 186 |
| S | GCCATTT | |
| PIK3CA_20_42_ | [BioTEG]CTTGGGCTCCTTTACTAATCACTATTAAGAAATCCTGTGTCAAA | 187 |
| AS | ACAAAT | |
| PIK3CA_21_43_ | [BioTEG]ATGCCAATCTCTTCATAAATCTTTTCTCAATGATGCTTGGCTCT | 188 |
| S | GGAATG | |
| PIK3CA_21_44_ | [BioTEG]CTCAGTTTTATCTAAGGCTAGGGTCTTTCGAATGTATGCAATGT | 189 |
| AS | CATCAA | |
| PIK3CA_21_45_ | [BioTEG]TTTCATGAAACAAATGAATGATGCACATCATGGTGGCTGGACA | 190 |
| S | ACAAAAA | |
| PTEN_l_l_S | [BioTEG]TTCAGCCACAGGCTCCCAGACATGACAGCCATCATCAAAGAGA | 191 |
| | TCGTTAG | |
| PTEN_1_2_AS | [BioTEG]GGTCAAGTCTAAGTCGAATCCATCCTCTTGATATCTCCTTTTGT | 192 |
| | TTCTGC | |
| PTEN_2_3_S | [BioTEG]ATATTTATCCAAACATTATTGCTATGGGATTTCCTGCAGAAAGA | 193 |
| | CTTGAA | |
| PTEN_2_4_AS | [BioTEG]CTTACTACATCATCAATATTGTTCCTGTATACGCCTTCAAGTCT | 194 |
| | TTCTGC | |
| PTEN_3_5_S | [BioTEG]ttaagGTTTTTGGATTCAAAGCATAAAAACCATTACAAGATATAC | 195 |
| | AATCT | |
| PTEN_3_6_S | [BioTEG]GTTTTTGGATTCAAAGCATAAAAACCATTACAAGATATACAAT | 196 |
| | CTgtaag | |
| PTEN_4_7_S | [BioTEG]ttttagTTGTGCTGAAAGACATTATGACACCGCCAAATTTAATTGC | 197 |
| | AGAG | |
| PTEN_4_8_S | [BioTEG]TTGTGCTGAAAGACATTATGACACCGCCAAATTTAATTGCAGA | 198 |
| | Ggtaggt | |
| PTEN_5_9_S | [BioTEG]AGCTAGAACTTATCAAACCCTTTTGTGAAGATCTTGACCAATG | 199 |
| | GCTAAGT | |
| PTEN_5_10_AS | [BioTEG]CACCAGTTCGTCCCTTTCCAGCTTTACAGTGAATTGCTGCAACA | 200 |
| | TGATTG | |
| PTEN_5_11_S | [BioTEG]GTGCATATTTATTACATCGGGGCAAATTTTTAAAGGCACAAGA | 201 |
| | GGCCCTA | |
| PTEN_6_12_S | [BioTEG]GCGCTATGTGTATTATTATAGCTACCTGTTAAAGAATCATCTGG | 202 |
| | ATTATA | |
| PTEN_6_13_AS | [BioTEG]GGAATAGTTTCAAACATCATCTTGTGAAACAACAGTGCCACTG | 203 |
| | GTCTATA | |
| PTEN_7_14_S | [BioTEG]ATATATTCCTCCAATTCAGGACCCACACGACGGGAAGACAAGT | 204 |
| | TCATGTA | |
| PTEN_7_15_AS | [BioTEG]TACTTTGATATCACCACACACAGGTAACGGCTGAGGGAACTCA | 205 |
| | AAGTACA | |
| PTEN_8_16_S | [BioTEG]TCTTCATACCAGGACCAGAGGAAACCTCAGAAAAAGTAGAAA | 206 |
| | ATGGAAGT | |
| PTEN_8_17_AS | [BioTEG]CTTGTCATTATCTGCACGCTCTATACTGCAAATGCTATCGATTT | 207 |
| | CTTGAT | |
| PTEN_8_18_S | [BioTEG]CTAGTACTTACTTTAACAAAAAATGATCTTGACAAAGCAAATA | 208 |
| | AAGACAA | |
| PTEN_9_19_S | [BioTEG]GAGGCTAGCAGTTCAACTTCTGTAACACCAGATGTTAGTGACA | 209 |
| | ATGAACC | |
| PTEN_9_20_AS | [BioTEG]ATTCTCTGGATCAGAGTCAGTGGTGTCAGAATATCTATAATGA | 210 |
| | TCAGGTT | |
| TP53_2_1_S | [BioTEG]CCAGACTGCCTTCCGGGTCACTGCCATGGAGGAGCCGCAGTCA | 211 |
| | GATCCTA | |
| TP54_2_2_AS | [BioTEG]TTCCATAGGTCTGAAAATGTTTCCTGACTCAGAGGGGGCTCGA | 212 |
| | CGCTAGG | |
| TP55_3_3_S | [BioTEG]ggactgactttctgctcttgtctttcagACTTCCTGAAAACAACGTTCTG | 213 |
| TP56_3_4_S | [BioTEG]ACTTCCTGAAAACAACGTTCTGgtaaggacaagggttgggctggggacct | 214 |
| TP57_4_5_S | [BioTEG]GGACGATATTGAACAATGGTTCACTGAAGACCCAGGTCCAGAT | 215 |
| | GAAGCTC | |
| TP58_4_6_AS | [BioTEG]GGTGCAGGGGCCGCCGGTGTAGGAGCTGCTGGTGCAGGGGCC | 216 |
| | ACGGGGGG | |
| TP57_4_7_S | [BioTEG]ATCTTCTGTCCCTTCCCAGAAAACCTACCAGGGCAGCTACGGTT | 217 |
| | TCCGTC | |
| TP59_5_8_S | [BioTEG]CTGCCCTGTGCAGCTGTGGGTTGATTCCACACCCCCGCCCGGC | 218 |
| | ACCCGCG | |
| TP60_5_9_AS | [BioTEG]ACCTCCGTCATGTGCTGTGACTGCTTGTAGATGGCCATGGCGC | 219 |
| | GGACGCG | |
| TP61_6_10_S | [BioTEG]CCTCCTCAGCATCTTATCCGAGTGGAAGGAAATTTGCGTGTGG | 220 |
| | AGTATTT | |
| TP62_6_11_AS | [BioTEG]CTCATAGGGCACCACCACACTATGTCGAAAAGTGTTTCTGTCA | 221 |
| | TCCAAAT | |
| TP63_7_12_S | [BioTEG]CTGACTGTACCACCATCCACTACAACTACATGTGTAACAGTTCC | 222 |
| | TGCATG | |
| TP64_7_13_AS | [BioTEG]CTTCCAGTGTGATGATGGTGAGGATGGGCCTCCGGTTCATGCC | 223 |
| | GCCCATG | |
| TP65_8_14_S | [BioTEG]ACAGCTTTGAGGTGCGTGTTTGTGCCTGTCCTGGGAGAGACCG | 224 |
| | GCGCACA | |
| TP66_8_15_AS | [BioTEG]GCAGCTCGTGGTGAGGCTCCCCTTTCTTGCGGAGATTCTCTTCC | 225 |
| | TCTGTG | |
| TP67_9_16_S | [BioTEG]CACTGCCCAACAACACCAGCTCCTCTCCCCAGCCAAAGAAGAA | 226 |
| | ACCACTG | |
| TP68_9_17_S | [BioTEG]CTCCCCAGCCAAAGAAGAAACCACTGGATGGAGAATATTTCAC | 227 |
| | CCTTCAG | |
| TP69_10_18_S | [BioTEG]TGGGCGTGAGCGCTTCGAGATGTTCCGAGAGCTGAATGAGGCC | 228 |
| | TTGGAAC | |
| TP70_10_19_AS | [BioTEG]TGAGCCCTGCTCCCCCCTGGCTCCTTCCCAGCCTGGGCATCCTT | 229 |
| | GAGTTC | |
| TP71_11_20_S | [BioTEG]CACCTGAAGTCCAAAAAGGGTCAGTCTACCTCCCGCCATAAA | 230 |
| | AAACTCA | |
| TP72_11_21_AS | [BioTEG]AGAAGTGGAGAATGTCAGTCTGAGTCAGGCCCTTCTGTCTTGA | 231 |
| | ACATGAG | |

(BioTEG indicates that the above oligonucleotides were biotinylated at the 5′ end).

Preparation of Beads

InVitrogen's Dynabeads MyOne® Streptavidin C1 magnetic beads (InVitrogen #650-01) were used (which have a binding capacity of ˜50 pmol of biotinylated dsDNA/50 μl beads). 120 μl beads were combined with 500 μl 2× binding buffer (20 mM Tris pH 7.6, 0.2 mM EDTA, 2M NaCl) and 380 μl water. The beads were pulled with a magnet and washed twice with 1 ml of 1× binding buffer and resuspended in 1200 μl 1× binding buffer.

A. First Round of Solution-Based Capture Using Biotinylated Sequence Specific Oligo Probes to Generate a Once-Enriched Genomic DNA Library

A range of pooled biotinylated target-specific capture oligos (SEQ ID NO:111-231) was tested at the following concentrations (10 pmol, 1 pmol, 100 attomol, 10 attomol, 1 attomol, no oligo control). Two different wash buffers were also tested: (1× binding buffer; (high salt): 10 mM Tris pH 7.6, 0.1 mM EDTA, 1M NaCl) (osmolarity=2000 molar) or TEzero (10 mM Tris pH 7.6 and 0.1 mM EDTA)=low salt (no NaCl) (osmolarity=10 millimolar).

A dilution series was set up as follows. A first reaction mixture was prepared with 222 μl (10 μg) of PCR product (genomic library), 277.5 μl of 2× binding buffer (20 mM Tris pH 7.6, 0.2 mM EDTA, 2M NaCl), 22.2 μl of 1 μM pooled biotinylated oligos (20 pmol) and 33.3 μl water. Four tubes were prepared with 200 μl PCR product, 250 μl 2× binding buffer and 50 μl water. Serial 10-fold dilutions were then made of 55 μl of the first reaction mixture with the biotinylated oligo through the series of the 4 non-biotin containing tubes. A control was prepared with 200 μl PCR product, 250 μl 2× binding buffer and 50 μl water.

For the solution-based capture, 10 μl of the 1 μM pooled capture oligos were combined with 50 μl of 100 ng/μl genomic library (or a pool of genomic libraries containing 625 ng of each of eight genomic libraries ligated to a particular barcode), 125 μl of 2× binding buffer and 65 μl water, for a total volume of 250 μl.

The reaction mixture was annealed as follows:

94° C. for 30 sec

90° C. for 30 sec

85° C. for 30 sec

80° C. for 30 sec

75° C. for 30 sec

70° C. for 30 sec

65° C. for 30 sec

60° C. for 30 sec

55° C. for 30 sec

50° C. for 30 sec

45° C. for 30 sec

40° C. for 30 sec

After the last annealing temperature, the cycler was allowed to come to room temperature. The 250 μl annealed mixture was combined with 100 μl washed beads and 150 μl 1× binding buffer and incubated at room temperature for 15 minutes. The beads were pulled out from the mixture with a magnet. The beads were then washed four times with either:

(1) 500 μl 1× binding buffer (10 mM Tris pH 7.6, 0.1 mM EDTA, 1M NaCl); or

(2) 500 μl TEzero (10 mM Tris pH 7.6 and 0.1 mM EDTA, no NaCl)

For washing, the beads were resuspended in either 1× binding buffer or TEzero and rocked for 5 minutes prior to pull down. This washing process was carried out four times. The washed beads were then eluted by resuspending them in 50 μl water, heating to 94° C. for 30 seconds, then the beads were pulled with a magnet and the supernatant was removed. The elution process was repeated with another 50 μl of water, giving a total volume of 100 μl eluate that contained the enriched fragment library.

B. Amplification of the Eluted Once-Enriched Library to Generate an Amplified Once-Enriched Genomic DNA Library

The eluate containing the enriched fragment library was PCR amplified as follows:

PCR Reaction Mixture (5% DMSO):

28 μl H₂O

20 μl 5× buffer (supplied by the manufacturer with the EXPAND^{plus}® kit, Roche)

10 μl 25 mM MgCl₂

10 μl template ( 1/10th of total eluate of once-enriched library)

5 μl dNTPs (10 mM each dNTP)
5 μl DMSO
10 μl 10 μM Forward PCR primer (SEQ ID NO:109)

10 μl 10 μM Reverse PCR primer (SEQ ID NO:110)

1 μl Taq polymerase

1 μl EXPAND^{plus}® polymerase, Roche

100 μl total volume

PCR Cycling CONDITIONS

1 Cycle:
94° C. for 2 minutes

10 Cycles:
94° C. for 30 sec
60° C. for 30 sec
72° C. for 1 minute

15 Cycles:
94° C. for 30 sec
60° C. for 30 sec
72° C. for 1 minute plus 10 sec/cycle

1 Cycle:
72° C. for 7 minutes
4° C. hold

The PCR reaction products were purified over a Qiaquick® column and quantified.

1 μl of PCR product was analyzed on a 2% agarose gel.

Analysis

The PCR products were analyzed by gene specific qPCR assays to determine the specific activity of target fragments in the enriched, amplified libraries.

TABLE 9
Enhancement of Target-Specific Fragments in Library After Solution-Based Capture

| | AKT1 | KRAS | PIK3CA | PTEN | TP53 |
|---|---|---|---|---|---|
| Capture | (fold | (fold | (fold | (fold | (fold |
| conditions | enhancement) | enhancement) | enhancement) | enhancement) | enhancement) |
| 1X bind/10 pmol | 33 | 24 | 18 | 24 | 22 |
| 1X bind/1 pmol | 33 | 21 | 18 | 26 | 33 |
| 1X bind/100 amol | 24 | 12 | 9 | 15 | 21 |
| 1X bind/10 amol | 4 | 4 | 2 | 4 | 3 |
| 1X bind/1 amol | 0 | 1 | 1 | 1 | 1 |
| 1X bind/0 control | 1.2 | 1.1 | 0.5 | 1.0 | 1.0 |
| TE/10 pmol | 755 | 675 | 703 | 762 | 488 |
| TE/1 pmol | 847 | 728 | 740 | 861 | 678 |
| TE/100 amol | 359 | 336 | 248 | 388 | 366 |
| TE/10 amol | 61 | 79 | 77 | 52 | 128 |
| TE/1 amol | 0 | 6 | 0 | 0 | 4 |
| TE/0 control | 2.6 | 0.1 | 0.1 | 0.1 | 0.3 |

Results

Two different wash buffers were also tested: 1× binding buffer (high salt): 10 mM Tris pH 7.6, 0.1 mM EDTA, 1M NaCl) (osmolarity=2000 molar) or TEzero (10 mM Tris pH 7.6 and 0.1 mM EDTA)=low salt (no NaCl) (osmolarity=10 millimolar).

As shown above in TABLE 9, modest enrichment was observed with high capture oligo concentrations (10 pmol to 10 amol) and a high salt wash (1× binding buffer (high salt): 10 mM Tris pH 7.6, 0.1 mM EDTA, 1M NaCl) (osmolarity=2000 molar). It was also observed that low salt washes TEzero (10 mM Tris pH 7.6 and 0.1 mM EDTA)=low salt (no NaCl) (osmolarity=10 millimolar) made a significant difference in enrichment specificity, which was oligo concentration dependent and very uniform across the five TaqMan assays. In this regard, it is noted that the Tris buffer in TE (low salt conditions) stabilizes the solution pH and the DNA duplex, but does not have the electrostatic effect of adding a monovalent cation anion such as NaCl. In contrast, the monovalent cation anion NaCl was observed to have a negative effect on stringency and enrichment.

This experimental data indicates that capture oligonucleotide concentrations in the range of 1.0 to 10 pmol are optimal for capture for 5 μg of input genomic DNA. Given that the capture was performed in 1 ml, this corresponds to a concentration of 500 ng/ml DNA target and 1 nM to 10 nM capture oligo. This data also indicates that low salt wash (TE (10 mM Tris pH 7.6, 0.1 mM EDTA) is a superior wash buffer over a high salt wash (10 mM Tris pH 7.6, 0.1 mM EDTA, 1 M NaCl).

The theoretical maximum of fold enrichment is 3,000,000 Kbp-human genome/20 Kb target region=150,000-fold. As shown above in TABLE 9, the level of target fragment specific enrichment achieved after one round of capture was in the range of 500- to 900-fold using the low salt buffer wash conditions. This motivated the following experiment in which it was determined whether a second round of capture using the first round material as input could further enrich for target sequences. In the experiment that follows, low salt conditions TEzero (10 mM Tris pH 7.6 and 0.1 mM EDTA)=low salt (no NaCl) (osmolarity=10 millimolar) were also applied during the annealing step. The results that follow indicated that annealing of the genomic DNA library to capture oligos in high salt buffer (1× binding buffer (high salt): 10 mM Tris pH 7.6, 0.1 mM EDTA, 1 M NaCl) (osmolarity=2000 molar) followed by washing the bound material in a low salt wash buffer: TEzero (10 mM Tris pH 7.6 and 0.1 mM EDTA)=low salt (no NaCl) (osmolarity=10 millimolar) worked best for enriching target sequences. Additionally, and importantly, it was determined that successive rounds of capture resulted in highly-enriched target sequences.

C. Second Round of Solution-Based Capture Using

Biotinylated Sequence Specific Oligo Probes to Generate a Twice-Enriched Genomic DNA Library

Preparation of Capture Beads

Two sets of Capture Beads were prepared as follows.

Set 1: low salt: 20 μl beads were combined with 480 μl TEzero (10 mM Tris pH 7.6, 0.1 mM EDTA). The beads were pulled out with a magnet, washed twice with 500 μl of TEzero, and resuspended in 500 μl TEzero low salt buffer (10 mM Tris pH 7.6 and 0.1 mM EDTA)=low salt (no NaCl) (osmolarity=10 millimolar). 250 μl of washed beads/reaction were used.

Set 2: high salt: 20 μl beads were combined with 250 2× binding buffer (1 M NaCl) and 230 μl water. The beads were pulled out with a magnet, washed twice with 500 μl of 1× binding buffer, and resuspended in 500 μl 1× binding buffer (high salt): 10 mM Tris pH 7.6, 0.1 mM EDTA, 1 M NaCl) (osmolarity=2000 molar). 250 μl of washed beads/reaction were used.

Four samples were prepared for solution-based direct capture using the following libraries.
1. Once-enriched Library (TE/10 pmol—Table 9) annealed in high salt (1 M NaCl). 10 μl of 1 μM pooled biotinylated capture oligos (SEQ ID NOS:111-231) were combined with 67 μl of 75 ng/μl of once-enriched gDNA library (total of 5 μg DNA, produced in 20 cycles), 125 μl 2× binding buffer and 48 μl water for a total volume of 250 μl.
2. Starting Genomic DNA Library (not enriched), annealed in high salt (1 M NaCl). 10 μl of 1 μM pooled biotinylated capture oligos (SEQ ID NOS:111-231) were combined with 100 μl of 50 ng/μl starting genomic, non-enriched library (total of 5 μg DNA, produced in 20 cycles), 125 μl of 2× binding buffer and 15 μl of water for a total volume of 250 μl.
3. Once-enriched Library (TE/10 pmol—Table 9) annealed in low salt. 10 μl of 1 μM pooled biotinylated capture oligos (SEQ ID NOS:111-231) were combined with 67 μl of 75 ng/μl of once-enriched gDNA library (total of 5 μg DNA, produced in 20 cycles) and 173 μl of TEzero for a total volume of 250 μl.
4. Starting Genomic DNA Library (not enriched), annealed in low salt. 10 μl of 1 μM pooled biotinylated capture oligos (SEQ ID NOS:111-231) were combined with 100 μl of 50 ng/μl starting genomic, non-enriched library (total of 5 μg DNA, produced in 20 cycles) and 140 μl of TEzero for a total volume of 250 μl.

The reaction mixtures were each annealed as follows.

94° C. for 30 sec

85° C. for 30 sec

80° C. for 30 sec

75° C. for 30 sec

70° C. for 30 sec

65° C. for 30 sec

60° C. for 30 sec

55° C. for 30 sec

50° C. for 30 sec

45° C. for 30 sec

40° C. for 30 sec

35° C. for 30 sec

Capture

250 μl of annealed mixture was combined with 250 μl of set 1 beads (washed in low salt) or with 250 μl of set 2 beads (washed in high salt). The mixture was incubated at room temperature with mixing for 15 minutes. The beads were pulled out with a magnet and washed four times with 500 μl of TEzero. For each wash step, the beads were resuspended and rocked for 5 minutes prior to pulling down with the magnet.

Elution

The washed beads were resuspended in 50 μl water, heated to 94° C. for 30 seconds, pulled down with a magnet, and the supernatant with the bound DNA was collected. The process was repeated with an additional 50 μl, for a total eluate volume of 100 μl.

Amplification of Eluate:

PCR Reaction Mixture (5% DMSO):

28 μl H₂O

20 μl 5× buffer (supplied by the manufacturer with EXPAND^{plus}® kit, Roche)

10 μl 25 mM MgCl₂

10 μl template ( 1/10th of the total eluted material from the twice-enriched library)

5 μl dNTPs (10 mM of each dNTP)

5 μl DMSO

10 μl 10 μM Forward PCR primer (SEQ ID NO:109)
10 μl 10 μM Reverse PCR primer (SEQ ID NO:110)

1 μl Taq polymerase

1 μl Expand polymerase

100 μl total volume

PCR Cycling Conditions

1 Cycle:
94° C. for 2 minutes

10 Cycles:
94° C. for 30 sec
60° C. for 30 sec
72° C. for 1 minute

10 or 15 Cycles:
94° C. for 30 sec
60° C. for 30 sec
72° C. for 1 minute plus 10 sec/cycle

1 Cycle:
72° C. for 7 minutes
4° C. hold

The PCR reaction products were purified over a Qiaquick column and quantified.

1 μl of PCR product was analyzed on a 2% agarose gel.

D. Comparison of Sequence-Specific Capture from (1) a Genomic DNA Starting Library, (2) a Genomic DNA Library Once-Enriched, and (3) a Genomic DNA Library Twice-Enriched

The samples generated as described above were analyzed using qPCR to determine the level of enrichment achieved and the influence of salt concentration on the wash step.

20 ng of starting gDNA library (not enriched) and 20 pg of once- or twice-enriched samples were analyzed by qPCR as follows:

1. No template control

2. Starting material: gDNA library (amplified, not enriched)

3. Starting material: once-enriched gDNA library (TABLE 9: TE/10 pmol) diluted 1000-fold))

4. Low salt annealed, twice-enriched (diluted 1000-fold)

5. Low salt annealed, once-enriched (diluted 1000-fold)

6. High salt annealed, twice-enriched (diluted 1000-fold)

7. High salt annealed, once-enriched (diluted 1000-fold)

The above samples were run on a 2% agarose gel and it was observed that all libraries had a reasonable size distribution, with fragments >about 130 nt in length (data not shown).

The TaqMan data from the 5-gene qPCR assay on the above samples was processed as follows. The raw counts (Cts) were converted to raw quantities calculated with the universal formula: 10^{(log 10(1/2)*Ct+10}).

The results shown below in TABLE 10 are adjusted by 1000-fold to be normalized with the 20 ng samples.

TABLE 10
qPCR Data (Normalized Counts)

| Sample Assayed | AKT1 | KRAS | PIK3CA | PTEN | TP53 |
|---|---|---|---|---|---|
| gDNA pool | 467 | 362 | 339 | 461 | 3175 |
| (gDNA starting library, not | | | | | |
| target enriched) | | | | | |
| E-Pool | 705,442 | 245,007 | 176,163 | 485,587 | 1,813,181 |
| (starting material, one round | | | | | |
| capture, Table 9 TE/10 pmol) | | | | | |
| Low salt annealed twice- | 586,661 | 79,010 | 86,977 | 420,247 | 938,748 |
| enriched | | | | | |
| (enriched after two rounds | | | | | |
| capture under low salt | | | | | |
| conditions) | | | | | |
| Low salt annealed once- | 20 | 287 | 21 | 135 | 2850 |
| enriched | | | | | |
| (enriched after one round of | | | | | |
| capture under low salt | | | | | |
| conditions) | | | | | |
| High salt annealed twice- | 32,398,922 | 12,469,722 | 9,078,119 | 24,276,124 | 110,388,507 |
| enriched | | | | | |
| (enriched after two rounds | | | | | |
| capture under high salt | | | | | |
| conditions) | | | | | |
| High salt annealed once- | 277,775 | 241,019 | 123,291 | 293,021 | 1,254,427 |
| enriched | | | | | |
| (enriched after one round of | | | | | |
| capture under high salt | | | | | |
| conditions) | | | | | |
| No Template Negative control | 0 | 0 | 0 | 0 | 0 |

The results shown in TABLE 11 are the ratios of the values shown in TABLE 10, as described in the first column of the table, in order to show the fold enrichment level.

TABLE 11
The Fold Enrichment of Various Libraries for Gene Target Content

| | | AKT1 | | | | |
|---|---|---|---|---|---|---|
| | | (Ratio of | | | | |
| | | fold | | | | |
| Row | Ratio measured to | enrichment | | | | |
| number | determine fold enrichment | observed) | KRAS | PIK3CA | PTEN | TP53 |
| 1 | High salt annealed once- | 595-fold | 666-fold | 364-fold | 635-fold | 395-fold |
| | enriched/gDNA starting | | | | | |
| | library | | | | | |
| 2 | High salt annealed twice- | 69,448-fold | 34,453-fold | 26,797-fold | 52,634-fold | 34,763-fold |
| | enriched/gDNA starting | | | | | |
| | library | | | | | |
| 3 | High salt twice-enriched | 46-fold | 51-fold | 52-fold | 50-fold | 61-fold |
| | pool/High salt once- | | | | | |
| | enriched pool | | | | | |

Discussion of Results

As shown above in TABLE 10, annealing in high salt (1× binding buffer: 10 mM Tris pH 7.6, 0.1 mM EDTA, 1 M NaCl) worked much better for library enrichment than annealing in low salt (10 mM Tris pH 7.6, 0.1 mM EDTA).

As shown above in TABLE 11, row number 1 is the ratio of high salt annealed once-enriched genomic pool/gDNA, which is a measure of a single round of enrichment from the starting genomic library (non enriched) to the enriched library, showing an average target enrichment level of approximately 500-fold for the 5 genes, which is very good.

Row number 2 of TABLE 11 shows an average of about 50,000-fold target enrichment in the high salt annealed, twice-enriched genomic library relative to the starting non-enriched library. This is a surprisingly successful achievement, given that theoretical perfection (3 billion bases human genome/20 kb target), would be an enrichment of 150,000-fold, which is only a factor of 3-6-fold difference. It is also noted that the approximately 50,000-fold enrichment is reasonably uniform across the five genes.

Row number 3 of TABLE 11 shows that the second round of enrichment contributes substantially to the overall target enrichment process, contributing 50-fold more purification relative to a single round alone.

Another important feature demonstrated by the data in TABLES 10 and 11 is that all five monitored targets, chosen across the five genes in this study, are fairly uniformly enriched (within 2-fold or less). In contrast to the results observed using these methods, there are several reports that sequence based capture is severely hampered by unequal representation of target sequences. See, e.g., Albert, T. J., et al., Nature Methods 4(11):903-905 (2007); Okou, D. T., et al., Nature Methods 4(11):907-909 (2007); Porreca, G. J., et al., Nature Methods 4(11):931-6 (2007); and Hodges, E., et al., Nature Genetics 39:1522-2527 (2007).

The first and second rounds of enrichment described above were both carried out with a concentration of 500 ng/ml DNA target and 1 nM to 10 nM capture oligo.

Optional Third Round of Enrichment

A twice-enriched library can optionally be further enriched prior to sequence analysis by subjecting the twice-enriched library to one more round of solution-based capture. The use of another round of biotin capture on the amplified and enriched material serves to eliminate more of the off-target sequences that may have passed through the enrichment process, and may also be used to level or normalize the fragment representation in the library.

Methods

It was previously determined that 1 pmol of oligos (1 μl of a 1 μM solution) was sufficient to bind target sequences in a library generated using stem-loop linkers. 5 μg has 5×10⁻⁶ g/(160 bp average fragment size×660 g/mol-bp)=47 pmol of dsDNA library fragments. Therefore, hybridization of 5 μg (500 ng/ml) of the twice-enriched library with 1 pmol (1 nM) of a pool of biotinylated capture oligos was used.

5 μg (39 μl) of the high salt annealed, twice-enriched library was combined with 1 μl of 1 μM biotinylated capture oligo pool (SEQ ID NOS:111-231), 125 μl of 2× binding buffer, and 85 μl water, for a total volume of 2504 μl.

The reaction mixtures were annealed as follows:

94° C. for 30 sec

90° C. for 30 sec

85° C. for 30 sec

80° C. for 30 sec

75° C. for 30 sec

70° C. for 30 sec

65° C. for 30 sec

60° C. for 30 sec

55° C. for 30 sec

50° C. for 30 sec

45° C. for 30 sec

40° C. for 30 sec

Capture

Washed beads were prepared by combining 10 μl beads, 125 μl 2× binding buffer, and 115 μl water. The beads were pulled over with a magnet, washed twice with 250 μl 1× binding buffer, and resuspended in 250 μl 1× binding buffer.

The annealed 250 μl mixture was combined with the 250 μl washed beads, mixed for 15 minutes, the beads were pulled over with a magnet, and the supernatant was decanted. The beads were then washed 4 times with TEzero (low salt).

Elution

The bound beads were eluted with two aliquots of 50 μl of water by incubation at 94° C. for 30 seconds, pulling over the beads and removing the eluate, for a total eluate volume of 100 μl. Assuming 100% capture, the purified material should possess 1 pmol library/100 μl=10 amol/μl. 2 μl was sequenced using a flow cell cluster sequencing platform, available from Illumina.

Results of Third Round of Enrichment

A bioinformatic analysis of sequences derived from the twice-enriched pool versus the three-times enriched pool indicated that the third round of enrichment contributed an additional two-fold enrichment/purification of target sequences. In one experiment, it was observed that 25% of the sequencing reads from the twice-enriched pool aligned to the overall target region, whereas 50% of the sequencing reads from the three-times enriched pool aligned to the target region.

### Example 4

This example describes solution-based capture using indirect capture via chimeric capture oligos with a gene-specific region and a region that hybridizes to a universal biotinylated adaptor oligo, with a set of indirect oligos that are specific for a set of 5 genes of interest.

Rationale

As demonstrated above in Example 3, the method of targeted sequence capture using biotinylated gene sequence specific oligonucleotides works well for its intended purpose of generating a sequencing library. However, the drawbacks to the use of biotinylated gene sequence specific oligonucleotides are that biotinylated oligos are expensive reagents to produce, they require a long time to synthesize, and the yields of oligonucleotides are generally low and unpredictably variable. An alternative approach is to use chimeric capture oligonucleotides where one portion of the capture oligonucleotides hybridizes to target sequences and one portion hybridizes to a common, biotinylated oligonucleotide, as shown in FIG. 5. The chimeric capture oligonucleotides that are not biotinyated are straightforward to produce and the universal (i.e., common) biotinylated oligo is easily manufactured in a single large batch. In contrast to capture with directly biotinylated oligonucleotides, the advantage of the indirect capture approach is that only a single biotinylated oligonucleotide sequence needs to be synthesized, and the chimeric oligos are pure DNA oligos that are relatively inexpensive to synthesize.

As shown in FIG. 5, an alternative approach for target gene enrichment of a genomic library is to use indirect capture by generating a chimeric capture probe 200, 200′ with a first region 202 that hybridizes to a target nucleic acid sequence 10, 10′ in the library and a second region 204 that hybridizes to a universal biotinylated oligo 300, mixing the chimeric oligo, the universal biotinylated oligo and the library containing a plurality of nucleic acid molecules 50 under hybridizing conditions to form a tri-molecular complex (i.e., 50/200/300), and using magnetic beads 400 coated with streptavidin 410 to bind to the biotinylated region 310 of the universal oligo 300 and pull out the target sequences 50 bound in the complex to the chimeric capture probe 200, using a magnet 400.

This experiment compares library enrichment using biotinylated capture oligos 100 for direct capture versus chimeric capture oligos 200 that have a first region that hybridizes to a target sequence and a second region that hybridizes to a universal biotinylated oligo.

Methods

Oligonucleotides

A universal 5′ biotinylated oligo was used:

(SEQ ID NO: 232)
5′[BioTEG] TAATTGCTCGAAGGGGTCCACATCCGCCACGCGT 3′

A set of chimeric capture oligos were generated that target AKT1, KRAS, PIK3CA, PTEN, and TP53, which were not biotinylated and that have a first 5′ region with the identical sequence to the oligos shown above in TABLE 8, and a second 3′ region consisting of the following additional sequence that hybridizes to universal oligo:

(SEQ ID NO: 233)
5′ ACGCGTGGCGGATGTGGACCCCTTCGAGCAATTA 3′

A set of exemplary chimeric capture oligos is provided below in TABLE 12 that target AKT1, KRAS, PIK3CA, PTEN, and TP53 that contain a 5′ first region (35 nt) that contains sequence that hybridizes to the target gene AKT1, and a 3′ region (SEQ ID NO:232) (34 nt) that hybridizes to the universal biotinylated capture oligo (SEQ ID NO:233).

TABLE 12
Chimeric Capture Oligos Targeting 5 Genes of Interest

| | | SEQ |
|---|---|---|
| Reference | | ID |
| ID | Sequence | NO: |
| AKT_2_1_S | TGGGCTCGGGGAGCGCCAGCCTGAGAGGAGCGCGTACGCGTGGCG | 234 |
| | GATGTGGACCCCTTCGAGCAATTA | |
| AKT_2_2_AS | AACCCTCCTTCACAATAGCCACGTCGCTCATGGTGACGCGTGGCGG | 235 |
| | ATGTGGACCCCTTCGAGCAATTA | |
| AKT_3_3_S | ACCTGGCGGCCACGCTACTTCCTCCTCAAGAATGAACGCGTGGCGG | 236 |
| | ATGTGGACCCCTTCGAGCAATTA | |
| AKT_3_4_AS | GTTGAGGGGAGCCTCACGTTGGTCCACATCCTGCGACGCGTGGCGG | 237 |
| | ATGTGGACCCCTTCGAGCAATTA | |
| AKT_4_5_S | CTGATGAAGACGGAGCGGCCCCGGCCCAACACCTTACGCGTGGCG | 238 |
| | GATGTGGACCCCTTCGAGCAATTA | |
| AKT_4_6_AS | CTCCACATGGAAGGTGCGTTCGATGACAGTGGTCCACGCGTGGCGG | 239 |
| | ATGTGGACCCCTTCGAGCAATTA | |
| AKT_5_7_S | TGTGGCTGACGGCCTCAAGAAGCAGGAGGAGGAGGACGCGTGGCG | 240 |
| | GATGTGGACCCCTTCGAGCAATTA | |
| AKT_5_8_AS | CCATCTCTTCAGCCCCTGAGTTGTCACTGGGTGAGACGCGTGGCGG | 241 |
| | ATGTGGACCCCTTCGAGCAATTA | |
| AKT_6_9_S | CCTGAAGCTGCTGGGCAAGGGCACTTTCGGCAAGGACGCGTGGCG | 242 |
| | GATGTGGACCCCTTCGAGCAATTA | |
| AKT_6_10_AS | TCTTGAGGATCTTCATGGCGTAGTAGCGGCCTGTGACGCGTGGCGG | 243 |
| | ATGTGGACCCCTTCGAGCAATTA | |
| AKT_7_11_S | ACGAGGTGGCCCACACACTCACCGAGAACCGCGTCACGCGTGGCG | 244 |
| | GATGTGGACCCCTTCGAGCAATTA | |
| AKT_7_12_S | CACTCACCGAGAACCGCGTCCTGCAGAACTCCAGGACGCGTGGCG | 245 |
| | GATGTGGACCCCTTCGAGCAATTA | |
| AKT_8_13_S | GCCCTGAAGTACTCTTTCCAGACCCACGACCGCCTACGCGTGGCGG | 246 |
| | ATGTGGACCCCTTCGAGCAATTA | |
| AKT_8_14_S | AGACCCACGACCGCCTCTGCTTTGTCATGGAGTACACGCGTGGCGG | 247 |
| | ATGTGGACCCCTTCGAGCAATTA | |
| AKT_9_15_S | CGGGAGCGTGTGTTCTCCGAGGACCGGGCCCGCTTACGCGTGGCGG | 248 |
| | ATGTGGACCCCTTCGAGCAATTA | |
| AKT_9_16_AS | CACGTTCTTCTCCGAGTGCAGGTAGTCCAGGGCTGACGCGTGGCGG | 249 |
| | ATGTGGACCCCTTCGAGCAATTA | |
| AKT _10_17_S | ATGCTGGACAAGGACGGGCACATTAAGATCACAGAACGCGTGGCG | 250 |
| | GATGTGGACCCCTTCGAGCAATTA | |
| AKT_10_18_AS | GGTGTGCCGCAAAAGGTCTTCATGGTGGCACCGTCACGCGTGGCGG | 251 |
| | ATGTGGACCCCTTCGAGCAATTA | |
| AKT_11_19_S | AGTGGACTGGTGGGGGCTGGGCGTGGTCATGTACGACGCGTGGCG | 252 |
| | GATGTGGACCCCTTCGAGCAATTA | |
| AKT_11_20_AS | CATGAGGATGAGCTCAAAAAGCTTCTCATGGTCCTACGCGTGGCGG | 253 |
| | ATGTGGACCCCTTCGAGCAATTA | |
| AKT_11_21_S | AGATCCGCTTCCCGCGCACGCTTGGTCCCGAGGCCACGCGTGGCGG | 254 |
| | ATGTGGACCCCTTCGAGCAATTA | |
| AKT_12_22_S | GCTTGGCGGGGGCTCCGAGGACGCCAAGGAGATCAACGCGTGGCG | 255 |
| | GATGTGGACCCCTTCGAGCAATTA | |
| AKT_12_23_AS | CTTCTTCTCGTACACGTGCTGCCACACGATACCGGACGCGTGGCGG | 256 |
| | ATGTGGACCCCTTCGAGCAATTA | |
| AKT_13_24_S | CCCACCCTTCAAGCCCCAGGTCACGTCGGAGACTGACGCGTGGCGG | 257 |
| | ATGTGGACCCCTTCGAGCAATTA | |
| AKT_13_25_AS | GGTCAGGTGGTGTGATGGTGATCATCTGGGCCGTGACGCGTGGCGG | 258 |
| | ATGTGGACCCCTTCGAGCAATTA | |
| AKT_14_26_S | ATGACAGCATGGAGTGTGTGGACAGCGAGCGCAGGACGCGTGGCG | 259 |
| | GATGTGGACCCCTTCGAGCAATTA | |
| AKT_14_27_AS | GCGCAGTCCACCGCCGCCTCAGGCCGTGCCGCTGGACGCGTGGCG | 260 |
| | GATGTGGACCCCTTCGAGCAATTA | |
| KRAS_2_1_S | TGAAAATGACTGAATATAAACTTGTGGTAGTTGGAACGCGTGGCG | 261 |
| | GATGTGGACCCCTTCGAGCAATTA | |
| KRAS_2_2_AS | ATTCGTCCACAAAATGATTCTGAATTAGCTGTATCACGCGTGGCGG | 262 |
| | ATGTGGACCCCTTCGAGCAATTA | |
| KRAS_3_3_S | GTCTCTTGGATATTCTCGACACAGCAGGTCAAGAGACGCGTGGCGG | 263 |
| | ATGTGGACCCCTTCGAGCAATTA | |
| KRAS_3_4_AS | TGGCAAATACACAAAGAAAGCCCTCCCCAGTCCTCACGCGTGGCG | 264 |
| | GATGTGGACCCCTTCGAGCAATTA | |
| KRAS_4_5_S | TGTACCTATGGTCCTAGTAGGAAATAAATGTGATTACGCGTGGCGG | 265 |
| | ATGTGGACCCCTTCGAGCAATTA | |
| KRAS_4_6_AS | AGGAATTCCATAACTTCTTGCTAAGTCCTGAGCCTACGCGTGGCGG | 266 |
| | ATGTGGACCCCTTCGAGCAATTA | |
| KRAS_5_7_S | TGCCTTCTATACATTAGTTCGAGAAATTCGAAAACACGCGTGGCGG | 267 |
| | ATGTGGACCCCTTCGAGCAATTA | |
| KRAS_5_8_AS | TTACACACTTTGTCTTTGACTTCTTTTTCTTCTTTACGCGTGGCGGAT | 268 |
| | GTGGACCCCTTCGAGCAATTA | |
| PIK3CA_2_1_S | TTGATGCCCCCAAGAATCCTAGTAGAATGTTTACTACGCGTGGCGG | 269 |
| | ATGTGGACCCCTTCGAGCAATTA | |
| PIK3_CA_2_2_AS | CTTTATGGTTATTAATGTAGCCTCACGGAGGCATTACGCGTGGCGG | 270 |
| | ATGTGGACCCCTTCGAGCAATTA | |
| PIK3CA_2_3_S | GTGTTACTCAAGAAGCAGAAAGGGAAGAATTTTTTACGCGTGGCG | 271 |
| | GATGTGGACCCCTTCGAGCAATTA | |
| PIK3_CA_2_4_AS | GTTCAATTACTTITAAAAAGGGTTGAAAAAGCCGAACGCGTGGCG | 272 |
| | GATGTGGACCCCTTCGAGCAATTA | |
| PIK3CA_3_5_S | AGGACTTCCGAAGAAATATTCTGAACGTTTGTAAAACGCGTGGCGG | 273 |
| | ATGTGGACCCCTTCGAGCAATTA | |
| PIK3CA_3_6_AS | GAGGATAGACATACATTGCTCTACTATGAGGTGAAACGCGTGGCG | 274 |
| | GATGTGGACCCCTTCGAGCAATTA | |
| PIK3CA_4_7_S | AAATAATGACAAGCAGAAGTATACTCTGAAAATCAACGCGTGGCG | 275 |
| | GATGTGGACCCCTTCGAGCAATTA | |
| PIK3CA_4_8_AS | GTTCAGAGGATAGCAACATACTTCGAGTTTTTTTCACGCGTGGCGG | 276 |
| | ATGTGGACCCCTTCGAGCAATTA | |
| PIK3CA_4_9_S | GTTTTAGAATATCAGGGCAAGTATATTTTAAAAGTACGCGTGGCGG | 277 |
| | ATGTGGACCCCTTCGAGCAATTA | |
| PIK3CA_5_10_S | CAATTTGATGTTGATGGCTAAAGAAAGCCTTTATTACGCGTGGCGG | 278 |
| | ATGTGGACCCCTTCGAGCAATTA | |
| PIK3CA_5_11_AS | CTCCATTCATATATGGTGTAGCTGTGGAAATGCGTACGCGTGGCGG | 279 |
| | ATGTGGACCCCTTCGAGCAATTA | |
| PIK3CA_5_12_S | ATCCCTTTGGGTTATAAATAGTGCACTCAGAATAAACGCGTGGCGG | 280 |
| | ATGTGGACCCCTTCGAGCAATTA | |
| PIK3CA_6_13_S | ATCTATGTTCGAACAGGTATCTACCATGGAGGAGAACGCGTGGCG | 281 |
| | GATGTGGACCCCTTCGAGCAATTA | |
| PIK3CA_6_14_AS | CTGGGATTGGAACAAGGTACTCTTTGAGTGTTCACACGCGTGGCGG | 282 |
| | ATGTGGACCCCTTCGAGCAATTA | |
| PIK3CA_7_15_S | ATGAATGGCTGAATTATGATATATACATTCCTGATACGCGTGGCGG | 283 |
| | ATGTGGACCCCTTCGAGCAATTA | |
| PIK3CA_7_16_AS | TAGCACCCTTTCGGCCTTTAACAGAGCAAATGGAAACGCGTGGCGG | 284 |
| | ATGTGGACCCCTTCGAGCAATTA | |
| PIK3CA_8_17_S | TAAACTTGTTTGATTACACAGACACTCTAGTATCTACGCGTGGCGG | 285 |
| | ATGTGGACCCCTTCGAGCAATTA | |
| PIK3CA_8_18_AS | TAGGGTTCAGCAAATCTTCTAATCCATGAGGTACTACGCGTGGCGG | 286 |
| | ATGTGGACCCCTTCGAGCAATTA | |
| PIK3CA_9_19_S | GGAGTTTGACTGGTTCAGCAGTGTGGTAAAGTTCCACGCGTGGCGG | 287 |
| | ATGTGGACCCCTTCGAGCAATTA | |
| PIK3CA_9_20_AS | TAAATCCTGCTTCTCGGGATACAGACCAATTGGCAACGCGTGGCGG | 288 |
| | ATGTGGACCCCTTCGAGCAATTA | |
| PIK3CA_10_21_S | AGAGACAATGAATTAAGGGAAAATGACAAAGAACAACGCGTGGC | 289 |
| | GGATGTGGACCCCTTCGAGCAATTA | |
| PIK3CA_10_22_AS | AAAATCTTTCTCCTGCTCAGTGATTTCAGAGAGAGACGCGTGGCGG | 290 |
| | ATGTGGACCCCTTCGAGCAATTA | |
| PIK3CA_11_23_S | ACACTATTGTGTAACTATCCCCGAAATTCTACCCAACGCGTGGCGG | 291 |
| | ATGTGGACCCCTTCGAGCAATTA | |
| PIK3CA_11_24_S | CCAAATTGCTTCTGTCTGTTAAATGGAATTCTAGAACGCGTGGCGG | 292 |
| | ATGTGGACCCCTTCGAGCAATTA | |
| PIK3CA_12_25_S | AACCTGAACAGGCTATGGAACTTCTGGACTGTAATACGCGTGGCGG | 293 |
| | ATGTGGACCCCTTCGAGCAATTA | |
| PIK3CA_12_26_AS | CATCTGTTAAATATTTTTCCAAGCACCGAACAGCAACGCGTGGCGG | 294 |
| | ATGTGGACCCCTTCGAGCAATTA | |
| PIK3CA_13_27_S | TAAAATATGAACAATATTTGGATAACTTGCTTGTGACGCGTGGCGG | 295 |
| | ATGTGGACCCCTTCGAGCAATTA | |
| PIK3CA_13_28_AS | AATGCCAAAAGAAAAAGTGCCCAATCCTTTGATTAACGCGTGGCG | 296 |
| | GATGTGGACCCCTTCGAGCAATTA | |
| PIK3CA_14_29_S | GCCTGCTTTTGGAGTCCTATTGTCGTGCATGTGGGACGCGTGGCGG | 297 |
| | ATGTGGACCCCTTCGAGCAATTA | |
| PIK3CA_14_30_AS | CAGTTAAGTTAATGAGCTTTTCCATTGCCTCGACTACGCGTGGCGG | 298 |
| | ATGTGGACCCCTTCGAGCAATTA | |
| PIK3CA_15_31_S | GATGAAGTTTTTAGTTGAGCAAATGAGGCGACCAGACGCGTGGCG | 299 |
| | GATGTGGACCCCTTCGAGCAATTA | |
| PIK3CA_15_32_AS | TTTCCTAGTTGATGAGCAGGGTTTAGAGGAGACAGACGCGTGGCG | 300 |
| | GATGTGGACCCCTTCGAGCAATTA | |
| PIK3CA_16_33_S | CGAATTATGTCCTCTGCAAAAAGGCCACTGTGGTTACGCGTGGCGG | 301 |
| | ATGTGGACCCCTTCGAGCAATTA | |
| PIK3CA_16_34_AS | AAAGATGATCTCATTGTTCTGAAACAGTAACTCTGACGCGTGGCGG | 302 |
| | ATGTGGACCCCTTCGAGCAATTA | |
| PIK3CA_17_35_S | ATTTACGGCAAGATATGCTAACACTTCAAATTATTACGCGTGGCGG | 303 |
| | ATGTGGACCCCTTCGAGCAATTA | |
| PIK3CA_17_36_S | ATTATTCGTATTATGGAAAATATCTGGCAAAATCAACGCGTGGCGG | 304 |
| | ATGTGGACCCCTTCGAGCAATTA | |
| PIK3CA_18_37_S | GTGGGACTTATTGAGGTGGTGCGAAATTCTCACACACGCGTGGCGG | 305 |
| | ATGTGGACCCCTTCGAGCAATTA | |
| PIK3CA _18_38_AS | TGTGTGGCTGTTGAACTGCAGTGCACCTTTCAAGCACGCGTGGCGG | 306 |
| | ATGTGGACCCCTTCGAGCAATTA | |
| PIK3CA_19_39_S | CCATTGACCTGTTTACACGTTCATGTGCTGGATACACGCGTGGCGG | 307 |
| | ATGTGGACCCCTTCGAGCAATTA | |
| PIK3CA_19_40_AS | CTTTCACCATGATGTTACTATTGTGACGATCTCCAACGCGTGGCGG | 308 |
| | ATGTGGACCCCTTCGAGCAATTA | |
| PIK3CA_20_41_S | TGGATCACAAGAAGAAAAAATTTGGTTATAAACGAACGCGTGGCG | 309 |
| | GATGTGGACCCCTTCGAGCAATTA | |
| PIK3CA_20_42_AS | CTTGGGCTCCTTTACTAATCACTATTAAGAAATCCACGCGTGGCGG | 310 |
| | ATGTGGACCCCTTCGAGCAATTA | |
| PIK3CA_21_43_S | ATGCCAATCTCTTCATAAATCTTTTCTCAATGATGACGCGTGGCGG | 311 |
| | ATGTGGACCCCTTCGAGCAATTA | |
| PIK3CA_21_44_AS | CTCAGTTTTATCTAAGGCTAGGGTCTTTCGAATGTACGCGTGGCGG | 312 |
| | ATGTGGACCCCTTCGAGCAATTA | |
| PIK3CA_21_45_S | TTTCATGAAACAAATGAATGATGCACATCATGGTGACGCGTGGCGG | 313 |
| | ATGTGGACCCCTTCGAGCAATTA | |
| PTEN_1_1_S | TTCAGCCACAGGCTCCCAGACATGACAGCCATCATACGCGTGGCGG | 314 |
| | ATGTGGACCCCTTCGAGCAATTA | |
| PTEN_1_2_AS | GGTCAAGTCTAAGTCGAATCCATCCTCTTGATATCACGCGTGGCGG | 315 |
| | ATGTGGACCCCTTCGAGCAATTA | |
| PTEN_2_3_S | ATATTTATCCAAACATTATTGCTATGGGATTTCCTACGCGTGGCGG | 316 |
| | ATGTGGACCCCTTCGAGCAATTA | |
| PTEN_2_4_AS | CTTACTACATCATCAATATTGTTCCTGTATACGCCACGCGTGGCGG | 317 |
| | ATGTGGACCCCTTCGAGCAATTA | |
| PTEN_3_5_S | ttaagGTTTTTGGATTCAAAGCATAAAAACCATTAACGCGTGGCGGAT | 318 |
| | GTGGACCCCTTCGAGCAATTA | |
| PTEN_3_6_S | GTTTTTGGATTCAAAGCATAAAAACCATTACAAGAACGCGTGGCGG | 319 |
| | ATGTGGACCCCTTCGAGCAATTA | |
| PTEN_4_7_S | ttttagTTGTGCTGAAAGACATTATGACACCGCCAACGCGTGGCGGATG | 320 |
| | TGGACCCCTTCGAGCAATTA | |
| PTEN_4_8_S | TTGTGCTGAAAGACATTATGACACCGCCAAATTTAACGCGTGGCGG | 321 |
| | ATGTGGACCCCTTCGAGCAATTA | |
| PTEN_5_9_S | AGCTAGAACTTATCAAACCCTTTTGTGAAGATCTTACGCGTGGCGG | 322 |
| | ATGTGGACCCCTTCGAGCAATTA | |
| PTEN_5_10_AS | CACCAGTTCGTCCCTTTCCAGCTTTACAGTGAATTACGCGTGGCGG | 323 |
| | ATGTGGACCCCTTCGAGCAATTA | |
| PTEN_5_11_S | GTGCATATTTATTACATCGGGGCAAATTTTTAAAGACGCGTGGCGG | 324 |
| | ATGTGGACCCCTTCGAGCAATTA | |
| PTEN_6_12_S | GCGCTATGTGTATTATTATAGCTACCTGTTAAAGAACGCGTGGCGG | 325 |
| | ATGTGGACCCCTTCGAGCAATTA | |
| PTEN_6_13_AS | GGAATAGTTTCAAACATCATCTTGTGAAACAACAGACGCGTGGCG | 326 |
| | GATGTGGACCCCTTCGAGCAATTA | |
| PTEN_7_14_S | ATATATTCCTCCAATTCAGGACCCACACGACGGGAACGCGTGGCGG | 327 |
| | ATGTGGACCCCTTCGAGCAATTA | |
| PTEN_7_15_AS | TACTTTGATATCACCACACACAGGTAACGGCTGAGACGCGTGGCGG | 328 |
| | ATGTGGACCCCTTCGAGCAATTA | |
| PTEN_8_16_S | TCTTCATACCAGGACCAGAGGAAACCTCAGAAAAAACGCGTGGCG | 329 |
| | GATGTGGACCCCTTCGAGCAATTA | |
| PTEN_8_17_AS | CTTGTCATTATCTGCACGCTCTATACTGCAAATGCACGCGTGGCGG | 330 |
| | ATGTGGACCCCTTCGAGCAATTA | |
| PTEN_8_18_S | CTAGTACTTACTTTAACAAAAAATGATCTTGACAAACGCGTGGCGG | 331 |
| | ATGTGGACCCCTTCGAGCAATTA | |
| PTEN_9_19_S | GAGGCTAGCAGTTCAACTTCTGTAACACCAGATGTACGCGTGGCGG | 332 |
| | ATGTGGACCCCTTCGAGCAATTA | |
| PTEN_9_20_AS | ATTCTCTGGATCAGAGTCAGTGGTGTCAGAATATCACGCGTGGCGG | 333 |
| | ATGTGGACCCCTTCGAGCAATTA | |
| TP53_2_1_S | CCAGACTGCCTTCCGGGTCACTGCCATGGAGGAGCACGCGTGGCG | 334 |
| | GATGTGGACCCCTTCGAGCAATTA | |
| TP53_2_2_AS | TTCCATAGGTCTGAAAATGTTTCCTGACTCAGAGGACGCGTGGCGG | 335 |
| | ATGTGGACCCCTTCGAGCAATTA | |
| TP53_3_3_S | ggactgactactgctcttgtattcagACTTCCTACGCGTGGCGGATGTGGACCCCTT | 336 |
| | CGAGCAATTA | |
| TP53_3_4_S | ACTTCCTGAAAACAACGTTCTGgtaaggacaagggACGCGTGGCGGATGT | 337 |
| | GGACCCCTTCGAGCAATTA | |
| TP53_4_5_S | GGACGATATTGAACAATGGTTCACTGAAGACCCAGACGCGTGGCG | 338 |
| | GATGTGGACCCCTTCGAGCAATTA | |
| TP53_4_6_AS | GGTGCAGGGGCCGCCGGTGTAGGAGCTGCTGGTGCACGCGTGGCG | 339 |
| | GATGTGGACCCCTTCGAGCAATTA | |
| TP53_4_7_S | ATCTTCTGTCCCTTCCCAGAAAACCTACCAGGGCAACGCGTGGCGG | 340 |
| | ATGTGGACCCCTTCGAGCAATTA | |
| TP53_5_8_S | CTGCCCTGTGCAGCTGTGGGTTGATTCCACACCCCACGCGTGGCGG | 341 |
| | ATGTGGACCCCTTCGAGCAATTA | |
| TP53_5_9_AS | ACCTCCGTCATGTGCTGTGACTGCTTGTAGATGGCACGCGTGGCGG | 342 |
| | ATGTGGACCCCTTCGAGCAATTA | |
| TP53_6_10_S | CCTCCTCAGCATCTTATCCGAGTGGAAGGAAATTTACGCGTGGCGG | 343 |
| | ATGTGGACCCCTTCGAGCAATTA | |
| TP53_6_11_AS | CTCATAGGGCACCACCACACTATGTCGAAAAGTGTACGCGTGGCG | 344 |
| | GATGTGGACCCCTTCGAGCAATTA | |
| TP53_7_12_S | CTGACTGTACCACCATCCACTACAACTACATGTGTACGCGTGGCGG | 345 |
| | ATGTGGACCCCTTCGAGCAATTA | |
| TP53_7_13_AS | CTTCCAGTGTGATGATGGTGAGGATGGGCCTCCGGACGCGTGGCGG | 346 |
| | ATGTGGACCCCTTCGAGCAATTA | |
| TP53_8_14_S | ACAGCTTTGAGGTGCGTGTTTGTGCCTGTCCTGGGACGCGTGGCGG | 347 |
| | ATGTGGACCCCTTCGAGCAATTA | |
| TP53_8_15_AS | GCAGCTCGTGGTGAGGCTCCCCTTTCTTGCGGAGAACGCGTGGCGG | 348 |
| | ATGTGGACCCCTTCGAGCAATTA | |
| TP53_9_16_S | CACTGCCCAACAACACCAGCTCCTCTCCCCAGCCAACGCGTGGCGG | 349 |
| | ATGTGGACCCCTTCGAGCAATTA | |
| TP53_9_17_S | CTCCCCAGCCAAAGAAGAAACCACTGGATGGAGAAACGCGTGGCG | 350 |
| | GATGTGGACCCCTTCGAGCAATTA | |
| TP53_10_18_S | TGGGCGTGAGCGCTTCGAGATGTTCCGAGAGCTGAACGCGTGGCG | 351 |
| | GATGTGGACCCCTTCGAGCAATTA | |
| TP53_10_19_AS | TGAGCCCTGCTCCCCCCTGGCTCCTTCCCAGCCTGACGCGTGGCGG | 352 |
| | ATGTGGACCCCTTCGAGCAATTA | |
| TP53_11_20_S | CCACCTGAAGTCCAAAAAGGGTCAGTCTACCTCCCACGCGTGGCGG | 353 |
| | ATGTGGACCCCTTCGAGCAATTA | |
| TP53_11_21_AS | AGAAGTGGAGAATGTCAGTCTGAGTCAGGCCCTTCACGCGTGGCG | 354 |
| | GATGTGGACCCCTTCGAGCAATTA | |

Comparison of Direct Versus Indirect Solution-Based Capture Methods

Preparation of Oligo Pools

A 100 μM pool was created of all the direct capture oligos (50-mers) (SEQ ID NOS:111-231), referred to as “D oligo pool.”

A 100 μM pool was created of all the indirect capture chimeric oligos (69-mers), (SEQ ID NOS:234-354) referred to as the “I oligo pool.” 1 μM of the biotinylated adaptor capture oligo (SEQ ID NO:232) was added to the I oligo pool, referred to as “I oligo pool+capture adaptor oligo.”

TABLE 13
Capture Probes Tested

| Sample ID | Capture oligos used | Oligo Concentration |
|---|---|---|
| D-10 | direct capture biotinylated oligos (SEQ ID | 10 pmol |
| | NOS: 111-231) | |
| D-1 | direct capture biotinylated oligos (SEQ ID | 1.0 pmol |
| | NOS: 111-231) | |
| D-0.1 | direct capture biotinylated oligos (SEQ ID | 0.1 pmol |
| | NOS: 111-231) | |
| I-10 | Indirect oligos (SEQ ID NOS: 234-354) plus | 10 pmol of indirect oligos plus 10 pmol of |
| | biotinylated adaptor oligo (SEQ ID NO: 232) | biotinylated adaptor oligo |
| I-1 | Indirect oligos (SEQ ID NOS: 234-354) plus | 1.0 pmol of indirect oligos plus 1.0 pmol of |
| | biotinylated adaptor oligo (SEQ ID NO: 232) | biotinylated adaptor oligo |
| I-0.1 | Indirect oligos (SEQ ID NOS: 234-354) plus | 0.1 pmol of indirect oligos plus 0.1 pmol of |
| | biotinylated adaptor oligo (SEQ ID NO: 232) | biotinylated adaptor oligo |

Capture Mixture

The above dilution series was prepared as follows:

A 1800 μl master mix was prepared by combining 36 μg (545 μl of 66 ng/μl pool) of a gDNA library (non-enriched), prepared with heterologous stem loop adaptors as described in Example 2, 900 μl 2× binding buffer, and 355 μl water. Aliquots were taken from the master mix with two tubes of 300 μl and four tubes of 270 μl. 12.5 μl of either the direct biotinylated oligo pool (1 μM D oligo pool), or the indirect chimeric oligo pool (1 μM I oligo pool+universal adaptor) to the tubes with 300 μl and 30 μl was serially transferred to the remaining tubes to create a dilution series as shown in TABLE 13. 250 μl of each sample was used in the capture method as follows:

The reaction mixtures were annealed as follows:

94° C. for 1 minute

90° C. for 1 minute

85° C. for 1 minute

80° C. for 1 minute

75° C. for 1 minute

70° C. for 1 minute

65° C. for 1 minute

60° C. for 1 minute

55° C. for 1 minute

50° C. for 1 minute

45° C. for 1 minute

40° C. for 1 minute

Capture Reagents

Washed beads were prepared by combining 66 μl beads, 500 μl 2× binding buffer and 440 μl water. The beads were pulled over with a magnet and washed twice with 1 ml 1× binding buffer, and resuspended in 600 μl 1× binding buffer. 100 μl washed beads were transferred to individual tubes and 150 μl 1× binding buffer (10 mM Tris pH 7.6, 0.1 mM EDTA, 1 M NaCl) was added for a total volume of 250 μl.

First Round of Capture

The annealed 250 μl mixture was combined with the 250 μl washed beads. mixed for 15 minutes, the beads were pulled over with a magnet, and the supernatant was decanted. The beads were then washed 4 times with 500 μl TEzero (low salt=10 mM Tris pH 7.6, 0.1 mM EDTA).

Elution

The DNA bound to the beads was eluted with two aliquots of 50 μl of water by incubation at 94° C. for 30 seconds, pulling over the beads and removing the eluate, for a total eluate volume of 100 μl.

Amplification of Eluate (Once-Enriched Library)

PCR Reaction Mixture (5% DMSO)

29 μl H₂O

20 μl 5× buffer (supplied by manufacturer with the EXPAND^{plus}® kit, Roche)

10 μl 25 mM MgCl₂

10 μl template ( 1/10th eluate from once-enriched fragment library)

5 μl dNTPs (10 nM each dNTP)
5 μl DMSO
10 μl 10 μM Forward PCR primer (SEQ ID NO:109)

10 μl 10 μM Reverse PCR primer (SEQ ID NO:110

1 μl Expand^{PLUS}® polymerase (Roche)

100 μl total volume

PCR Cycling Conditions:

1 Cycle:
94° C. for 2 minutes

10 Cycles:
94° C. for 30 sec
60° C. for 30 sec
72° C. for 1 minute

10 or 15 Cycles:
94° C. for 30 sec
60° C. for 30 sec
72° C. for 1 minute plus 10 sec/cycle

1 Cycle:
72° C. for 7 minutes
4° C. hold

The PCR reaction products were purified over a Qiaquick column and quantified.

1 μl of PCR product was analyzed on a 2% agarose gel.

Second Round Capture

5 μg of first round PCR product was mixed with the capture oligos (D-10:10 pmol D oligo); (I-10:10 pmol I oligo pool+adaptor oligo) in 1× binding buffer (high salt=10 mM Tris pH 7.6, 0.1 mM EDTA, 1 M NaCl) to a total final volume of 250 μl and annealed under the same temperatures as the first round capture shown above.

The annealed mixture was then mixed with 10 μl of washed beads, as described supra. The beads were washed 4 times in TEzero (low salt=10 mM Tris pH 7.6, 0.1 mM EDTA). The captured DNA was eluted by resuspending the beads in water, as described supra, to give a total volume of eluate of 100 μl (twice-enriched). 10 μl of the eluate was amplified in a 100 μl PCR reaction under the same conditions shown above, and purified over a Qiaquick® column.

Third Round of Capture and Enrichment

5 μg of the PCR amplified second round capture material (50 pmol of fragments) was combined with 1 pmol capture oligos in 500 μl 1× binding buffer. The incubation, wash, and elution steps were carried out as described above for the first and second capture.

TABLE 14
qPCR Analysis of Libraries Enriched by Direct or Indirect Solution-based Capture

| Sample | AKT1 | KRAS | PIK3CA | PTEN | TP53 |
|---|---|---|---|---|---|
| No template control | 0 | 0 | 0 | 0 | 0 |
| gDNA | 201 | 323 | 122 | 172 | 895 |
| D10 | 55,618 | 99,723 | 42,283 | 75,788 | 331,250 |
| D1 | 248,767 | 295,648 | 103,156 | 163,626 | 1,015,336 |
| D0.1 | 151,637 | 179,229 | 47,130 | 106,709 | 804,054 |
| I10 | 112,928 | 141,126 | 88,792 | 143,495 | 734,659 |
| I1 | 115,325 | 127,103 | 26,589 | 81,358 | 592,030 |
| I0.1 | 30,071 | 35,305 | 10,799 | 30,060 | 176,812 |
| D10 - 2 rounds | 15,539,150 | 22,955,591 | 9,332,159 | 7,222,279 | 31,904,829 |
| I10 - 2 rounds | 29,133,566 | 27,469,246 | 11,444,918 | 13,423,041 | 83,868,123 |

TABLE 15
Ratios of Enriched Signal to Starting
gDNA Material Showing Fold Enrichment for Each
Gene During the Solution-Based Capture Process
for Direct Versus Indirect Capture Methodologies

| Row | Ratios | AKT1 | KRAS | PIK3CA | PTEN | TP53 |
|---|---|---|---|---|---|---|
| 1 | D10/gDNA | 277 | 309 | 345 | 440 | 370 |
| 2 | D1/gDNA | 1240 | 916 | 842 | 951 | 1134 |
| 3 | D0.1/gDNA | 756 | 555 | 385 | 620 | 898 |
| 4 | I10/gINA | 563 | 437 | 725 | 834 | 821 |
| 5 | I1/gINA | 575 | 394 | 217 | 473 | 661 |
| 6 | I0.1/gINA | 150 | 109 | 88 | 175 | 197 |
| 7 | D10 2nd | 77,450 | 71,087 | 76,212 | 41,977 | 35,636 |
| | enrich/gDNA | | | | | |
| 8 | I10 2nd | 145,207 | 85,064 | 93,466 | 78,017 | 93,675 |
| | enrich/gDNA | | | | | |
| 9 | D10 2nd | 279 | 230 | 221 | 95 | 96 |
| | enrich/D10 | | | | | |
| 10 | I10 2nd | 258 | 195 | 129 | 94 | 114 |
| | enrich/I10 | | | | | |

As shown above in TABLES 14 and 15, direct capture and indirect capture worked equally well. It is also important to note that, using both methods, the fold enrichment observed for all 5 gene targets are similar, suggesting there was no preferential enrichment of certain sequences.

Sequence Verification of Enriched Library

Up to this point in this example, 5 qPCR assays, each positioned within one of several exons per gene, were used to assess gene enrichment. The collection of capture oligonucleotides was designed to enrich 56 total exon sequences. To establish that enrichment had taken place across all of the exons of targeted genes, the sample that had been twice-enriched with 10 pmol indirect capture oligos was applied to an Illumina sequencing flow cell and 3,272,895 alignable sequencing reads of 36 nucleotides each were obtained. Of these, 35% mapped uniquely to the 5 target gene regions. The majority of these sequencing reads occurred either within the coding regions of coding exons or within nearby flanking intron segments, as expected if sequence based capture was performing to enrich for target segments.

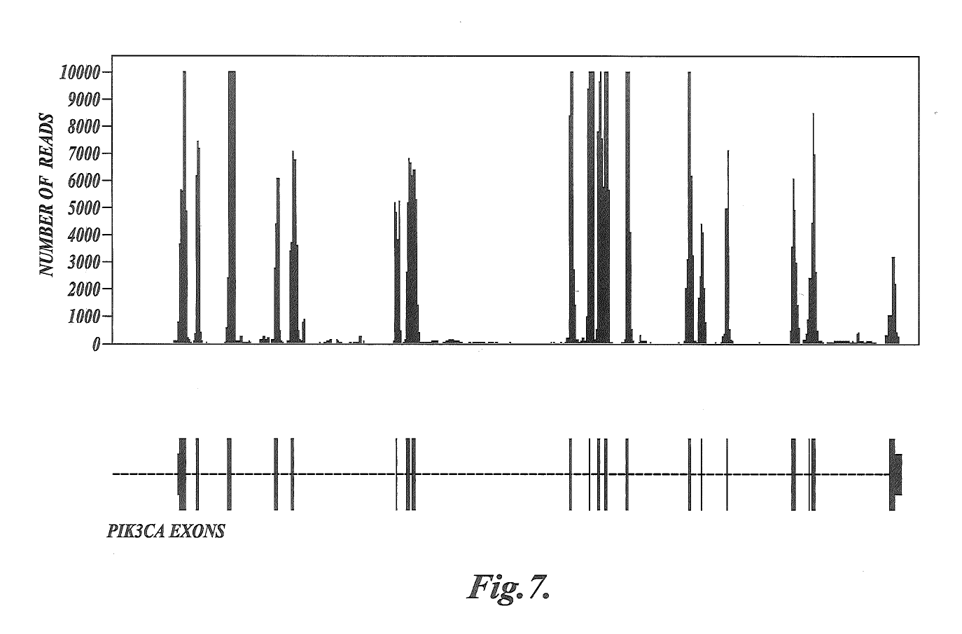

A representative alignment to the PIK3CA gene is shown in FIG. 7. The upper part of FIG. 7 is a graph showing number of sequencing reads (y-axis) that map to each base of the PIK3CA gene (displayed along the X-axis). The lower portion of FIG. 7 shows the exon structure for PIK3CA, with solid boxes representing each coding exon that is spliced into the PIK3CA mRNA. As shown in FIG. 7, all of the targeted exons in the PIK3CA gene (as well as the other targeted exons in the other 4 genes, not shown) showed a read density of >1000 reads at each targeted exonic base position. These data conclusively demonstrate that targeted capture for gene resequencing using indirect capture strategies is effective.

### Example 5

This example describes solution-based indirect capture using a population of 3,229 chimeric capture oligos having a first region that is substantially complementary to the sequence of an exon region of one of 77 target genes and a second region for binding to a universal biotinylated oligo, which in turn binds to a capture reagent.

Rationale

This example describes a scale-up from 5 gene targets, 56 exons and 13,267 bp of target sequences that were targeted with 121 oligonucleotides (as described in Example 4), to 77 genes, 1,221 exons, and 304,161 bp of target sequences targeted with 3,229 capture probes. As further described in this example, during the scale-up of this technique it was discovered that the magnitude of target enrichment was substantially enhanced by more stringent washing of the trimolecular capture complex.

Preparation of Capture Probes

A set of 77 genes was identified that is important in the PI3K kinase pathway, shown below in TABLE 16. All the exons of this set of 77 genes were identified, for a total of 1,221 exons, including alternatively spliced exons, for a total target region of 182,061 bases. An algorithm was then applied for picking alternating sense and antisense strand chimeric oligos with a 5′ target-specific region (35 nt) with a sequence that hybridizes to either the sense or antisense strand of each of these exons, and a 3′ region (SEQ ID NO:233) that hybridizes to the biotinylated adaptor capture oligo (SEQ ID NO:232), resulting in a total of 3,229 oligos.

These capture oligonucleotides were chosen as follows. For exons less than 69 nucleotides in length, 2 oligonucleotides, both targeting the same strand and oriented in the same direction and not overlapping one another in sequence by more than 10 nucleotides, were chosen. In some cases where exons were very short (i.e., <60 nucleotides), these capture oligonucleotides included flanking exon sequences.

For exons between 70 and 115 nucleotides in length, 2 oligonucleotides targeting opposite Watson and Crick strands and oriented in the opposite orientations were selected. The first oligonucleotide covered exon base positions 1-35 and the second oligonucleotide was positioned from base positions 80-115, which often included flanking intron sequences so that the oligos were each about 35 nt in length and spaced about 45 nt apart.

For exonic sequences greater than 115 nucleotides in length, the first capture oligonucleotide was placed at exon positions 1-35 and successive oligos were placed in alternating orientations with a spacing of 45 nucleotides between oligonucleotides.

Not to be bound by this example, it is envisioned that capture oligonucleotides could be spaced at many different intervals, have many different lengths, and the placement process could take into account genomic features such as genetic variation, G:C content, predicted oligo Tm, and the like.

The oligos designed as described above were synthesized by Operon and provided in a plate at 100 μM and pooled into a single 50 ml sample using a Biomek robot. The pooled 3,229 capture oligos were then diluted to 10 μM and 1 μM.

TABLE 16
Overview of the Set of 3,299 Capture Oligos

| | Oligo Numbers in | Total # Oligos/ | TaqMan |
|---|---|---|---|
| Gene | Candidate Set | Per Gene Target | Assay |
| AKT3 | 1-85 | 86 | Y |
| AXIN1 | 86-162 | 77 | |
| BAD | 163-170 | 8 | |
| BCL2 | 171-188 | 18 | |
| BCL2L1 | 189-203 | 15 | |
| BMP2 | 204-219 | 16 | |
| BRAF | 220-261 | 42 | Y |
| BRCA1 | 262-397 | 136 | |
| BRIP1 | 398-456 | 59 | |
| CASP9 | 457-479 | 23 | |
| CCND1 | 480-494 | 15 | |
| CDC42 | 495-507 | 13 | |
| CDKN1B | 508-516 | 9 | |
| CDKN2A | 517-539 | 23 | |
| CENTG1 | 540-585 | 46 | |
| CHUK | 586-630 | 45 | |
| CTNNB1 | 631-671 | 41 | Y |
| EGFR | 672-746 | 75 | Y |
| EP300 | 747-861 | 115 | |
| ERBB2 | 862-930 | 69 | |
| ESR1 | 931-957 | 27 | |
| FBXW7 | 958-997 | 40 | |
| FKBP1A | 998-1005 | 8 | |
| FRAP1 | 1006-1142 | 137 | |
| GAB1 | 1143-1177 | 35 | |
| GSK3B | 1178-1203 | 26 | |
| HGF | 1204-1250 | 47 | |
| HRAS | 1251-1262 | 12 | |
| IGF1R | 1263-1328 | 66 | |
| IKBKB | 1329-1373 | 45 | |
| IL6 | 1374-1386 | 13 | |
| ILK | 1387-1412 | 26 | |
| IRS1 | 1413-1459 | 47 | |
| KIAA1303 | 1460-1534 | 75 | |
| KRAS | 1535-1546 | 12 | Y |
| LRRFIP1 | 1547-1585 | 39 | |
| MAPK1 | 1586-1603 | 18 | |
| MAPK3 | 1604-1625 | 22 | |
| MAPK8 | 1626-1654 | 29 | |
| MET | 1655-1721 | 67 | |
| MYC | 1722-1741 | 20 | |
| NFKB1 | 1742-1796 | 55 | |
| NFKBIA | 1797-1813 | 17 | |
| NRAS | 1814-1823 | 10 | |
| PAK1 | 1824-1855 | 32 | |
| PALB2 | 1856-1911 | 56 | |
| PDPK1 | 1912-1944 | 33 | |
| PIK3CA | 1945-1999 | 55 | Y |
| PIK3R1 | 2000-2041 | 42 | |
| PLCG1 | 2042-2119 | 78 | |
| PPARG | 2120-2147 | 28 | |
| PPP2CA | 2148-2164 | 17 | |
| PRKCA | 2165-2202 | 38 | |
| PRKCZ | 2203-2241 | 39 | |
| PRKDC | 2242-2458 | 217 | |
| PTEN | 2459-2481 | 23 | Y |
| PTK2 | 2482-2552 | 71 | |
| RAF1 | 2553-2588 | 36 | |
| RB1 | 2589-2646 | 58 | |
| RBBP8 | 2647-2695 | 49 | |
| RET | 2696-2754 | 59 | Y |
| RICTOR | 2755-2851 | 97 | |
| RPS6KB1 | 2852-2884 | 33 | |
| SMAD3 | 2885-2905 | 21 | |
| SRC | 2906-2934 | 29 | |
| STAT1 | 2935-2986 | 52 | |
| STAT3 | 2987-3040 | 54 | |
| STK11 | 3041-3062 | 22 | |
| TGFBR2 | 3063-3090 | 28 | |
| TNF | 3091-3103 | 13 | |
| TP53 | 3104-3126 | 23 | Y |
| TSC1 | 3127-3189 | 63 | |
| TSC2 | 3190-3288 | 99 | |
| YWHAH | 3289-3299 | 11 | Y |

TaqMan assays were developed for the 10 genes (AKT1, BRAF, CTNNB1, EGFR, KRAS, PIK3CA, PTEN, RET, TP53, and YWHAH), as shown in TABLE 16. TaqMan assays were also developed for off-target genes ANKHD and MKRN1 for use as negative controls. These genes were not targeted by capture oligonucleotides and it was shown that their representation diminished during the course of target library enrichment.

Library Generation

Genomic DNA libraries were generated as described above with a 1/100 DNase I treated library (smaller size distribution) and a 1/200 DNase I treated library (larger insert size distribution), forward stem loop adaptors (SEQ ID NO:105) and reverse stem loop adaptors (SEQ ID NO:7) were ligated onto the inserts, followed by PCR amplification for 20 cycles with PCR forward primer (SEQ ID NO:109) and PCR reverse primer (SEQ ID NO:110), then the PCR product was purified over a Qiaquick column.

Solution-Based Capture and Enrichment of Libraries for Target Sequences

In a preliminary experiment, it was determined that although the 5-gene capture worked well under the conditions described above, the 77-gene capture showed a higher level of non-specific binding. While not wishing to be bound by theory, it is likely that the increased oligo diversity going from 121 oligos up to 3,229 oligos creates a more diverse landscape of sequences, which may cause non-specific binding effects.

It was also observed that certain types of plastic microfuge tubes were not optimal for use with the magnetic beads MyOne™ Streptavidin C1 (InVitrogen #650-01). It was determined that microfuge Axygen M-175C tubes work well for magnetic capture using these beads.

As described in this example, it was determined that the addition of 25% formamide in a low salt wash buffer (10 mM Tris pH 7.6, 0.1 mM EDTA) was effective to increase binding specificity in the 77-gene capture environment.

In a related experiment, it was further determined that the addition of 0.1% triton X100 (or tween or NP40) nonionic detergent during the annealing phase enhanced the binding specificity by an order of magnitude (data not shown).

Capture Reagents

10 μM of 3,229 capture oligos for the 77 candidate genes described in TABLE 16 were mixed with 10 μM of the biotinylated adaptor oligo (SEQ ID NO:232). The genomic library DNA was prepared as described in Example 2

Capture Mixture

125 μl of 2× binding buffer (2 M NaCl, 20 mM Tris pH 7.6, 0.2 mM EDTA), 60 μl (4.3 μg) of gDNA library, 5 μl capture oligo pool (50 μM of 10 μM of 3229 oligo pool+adaptor oligo), and 60 μl water, for a total volume of 250 μl.

The reaction mixture was annealed as follows:

94° C. for 1 minute

90° C. for 1 minute

85° C. for 1 minute

80° C. for 1 minute

75° C. for 1 minute

70° C. for 1 minute

65° C. for 1 minute

60° C. for 1 minute

55° C. for 1 minute

50° C. for 1 minute

45° C. for 1 minute

40° C. for 1 minute

25° C.—hold

Note: It was determined in another experiment that longer annealing times between capture oligos and target DNA (15 minutes per 5° C. step) further improved the quality of the capture experiment (data not shown).

Capture Reagents

Washed beads were prepared by combining 6 aliquots of 50 μl beads (in principle, each 50 μl of beads is capable of binding 50 pmol of dsDNA complex), 500 μl 2× binding buffer and 440 μl water. The beads were pulled over with a magnet and washed twice with 1 ml 1× binding buffer.

First Round of Capture/Enrichment

The aliquots of washed oligos were combined with the annealed oligos into a total volume of 1 ml of 1× binding buffer and mixed gently for 15 minutes.

Wash Solutions

A series of wash buffers with increasing formamide were tested, each with 100 mM Tris pH 7.6, 1 mM EDTA, and a range of formamide from 15%, 20%, 25%, 30%, and 50%.

It was previously determined that the presence of 20 mM NaCl in the 10 mM Tris pH 7.6, 1 mM EDTA buffer enhanced non-specific binding (data not shown); therefore, the NaCl was eliminated in the wash buffer in this experiment.

The capture oligos/library/bead complexes were washed 4 times with the above-described wash buffers including formamide, 1 ml each wash for 5 minutes.

Elution

The DNA bound to the beads was eluted with 2 aliquots of 50 μl of water by incubation at 94° C. for 1 minute each, pulling over the beads and removing the eluate, for a total eluate volume of 100 μl.

Amplification of Eluate

The eluted material was amplified through 20 cycles of PCR as described in Example 5.

Analysis

qPCR analysis was carried out for the 10 genes shown in TABLE 16. The fold enrichment observed under different wash conditions are shown in TABLE 17.

TABLE 17
Fold Enrichment of Targets in gDNA Library With Wash
Buffers Containing Increasing Amounts of Formamide

| Wash buffer (core buffer: | Average | | Stdev as |
|---|---|---|---|
| 100 mM Tris pH | fold- | | % of |
| 7.6, 1 mM EDTA) | enrichment | Stdev | average |
| 0% formamide | 26 | 7 | 25 |
| 15% formamide | 128 | 36 | 28 |
| 20% formamide | 186 | 51 | 27 |
| 25% formamide | 269 | 77 | 29 |
| 30% formamide | 266 | 107 | 40 |
| 50% formamide | 168 | 278 | 166 |

As shown above in TABLE 17, the addition of formamide to the wash buffer had a significantly positive impact on the fold enrichment observed after one round of capture. Because the goal is uniform enrichment of all targets in the library, the 25% formamide washed beads were used in the methods described herein, due to the smaller standard deviation observed.

Second Round of Capture/Enrichment

The eluent obtained from the beads washed in 25% formamide was amplified and 5 μg of purified PCR product was subjected to a second round of oligo capture as follows:

125 μl 2× binding buffer (2 M NaCl, 20 mM Tris pH 7.6, 0.2 mM EDTA), 5 μg PCR product (once-enriched), 5 μl (50 pmol of 50 μM of 10 μM of 3229 chimeric indirect capture oligo pool+adaptor capture oligo), water to a final volume of 250 μl. Annealing was carried out as described for the first capture round. The bound complex was washed 4 times in 1 ml of wash buffer (12.5 mls formamide, 500 μl 1 M Tris pH 7.6, μl of 0.5 M EDTA and 37 mls water for a total of 50 mls wash solution at 25% formamide).

Elution

The DNA bound to the beads was eluted with two aliquots of 50 μl of water by incubation at 94° C. for 1 minute each, pulling over the beads and removing the eluate, for a total eluate volume of 100 μl. The eluted twice-enriched material was then PCR amplified through 20 cycles using the PCR conditions described above for the once-enriched eluate.

Third Round of Capture/Enrichment

10 μg of purified twice-enriched PCR amplified product (about 100 nmols of fragments) was annealed to 5 μl of 1 μM (5 pmols) capture oligo pool as follows:

125 μl 2× binding buffer, 10 μg PCR product, 2 μl (2 pmol) of 1 μM indirect candidate oligo pool+adaptor oligo, water was added to a total volume of 250 μl. The captured complexes were annealed to 5 μl of washed beads as described above. The wash in 25% formamide buffer was carried out as described above for the first and second capture. Captured nucleic acids were eluted from the beads with two 25 μl aliquots of water, 1 minute at 94° C. each. In the third round of capture/enrichment, the amount of capture oligo was reduced to 5 pmol (instead of 50 pM in the first and second rounds). After 2 rounds of enrichment, the solution of PCR products contains an excess of targeted fragments. When a limiting amount of capture oligos are added to the excess of fragments, the capture oligos will become saturated. Therefore, in the third round of enrichment, capture oligos were added in the same molar abundance so that the composition of the sequencing material would be represented in nearly equal amounts.

The amount of beads was reduced to 5 μl (instead of 50 μl in the first and second round of capture) in order to provide just enough beads to bind all complexes present, in order to minimize any non-specific binding effects that may occur with the use of excess beads in the third round of capture.

Analysis

The starting gDNA library, once-enriched and twice-enriched libraries were analyzed by qPCR and submitted for sequence analysis. The qPCR results, which monitored 1 exon, each within 10 target genes (out of 1,221 total targeted exons: AKT1, BRAF, CTNNB1, EGFR, KRAS, PIK3CA, PRET, PTEN, TP53, and YWHAH) and 1 exon, each within 2 non-targeted genes (ANKHD and MKRN1) are shown in TABLE 18. As described above, shorter insert (100+) and longer insert (200+) libraries of control reference human genomic DNA were captured. TABLE 19 shows the fold enrichment for each individual gene and the averages for all 10 target genes. The shorter insert (100+) library showed 4,650-fold enrichment averaged over all 10 genes and significant depletion of the non-targeted genes. The longer insert library (200+) showed slightly less enrichment, 3,756-fold, as expected for longer targets that are more dispersed across the genome.

TABLE 18
Raw qPCR Values for 10 Targeted and 2 Non-Targeted Genes
Across 2 Libraries (100+ and 200+) and 2 Enrichment Steps Per Library

| | 100+ gDNA | 100+ 1st | 100+ 2nd | 200+ gDNA | 200+ 1st | 200+ 2nd |
|---|---|---|---|---|---|---|
| Raw values | library | enrichment | enrichment | library | enrichment | enrichment |
| AKT1 | 113 | 43,343 | 1,020,097 | 367 | 118,523 | 2,733,551 |
| ANKHD | 28 | 51 | 27 | 125 | 48 | 26 |
| BRAF | 39 | 9,954 | 214,621 | 161 | 24,796 | 337,500 |
| CTNNB1 | 92 | 25,257 | 743,927 | 361 | 109,018 | 2,953,848 |
| EGFR | 184 | 49,839 | 1,126,117 | 531 | 157,430 | 4,098,106 |
| KRAS | 261 | 42,021 | 409,344 | 470 | 31,328 | 196,314 |
| MKRN1 | 60 | 35 | 18 | 216 | 203 | 143 |
| PIK3CA | 50 | 4,672 | 38,174 | 210 | 14,221 | 103,576 |
| PRET | 167 | 33,649 | 625,767 | 371 | 67,372 | 891,252 |
| PTEN | 129 | 29,636 | 686,516 | 228 | 37,929 | 593,306 |
| TP53 | 726 | 126,317 | 3,309,405 | 1,261 | 305,070 | 5,131,470 |
| YWHAH | 183 | 28,616 | 328,326 | 575 | 86,582 | 1,220,647 |

TABLE 19
Fold-Enrichment Values Over the Starting Raw Genomic DNA Libraries
After the 1st and 2nd Rounds of Enrichment for the Shorter-
Insert (100+) and Longer Insert (200+) Libraries

| | 100+ library | 100+ library | 200+ library | 200+ library |
|---|---|---|---|---|
| Fold- | 1st enrich- | 2nd enrich- | 1st enrich- | 2nd enrich- |
| enrichment | ment | ment | ment | ment |
| AKT1 | 383 | 9,017 | 323 | 7,457 |
| ANKHD | 2 | 1 | 0 | 0 |
| BRAF | 256 | 5,520 | 154 | 2,098 |
| CTNNB1 | 275 | 8,096 | 302 | 8,173 |
| EGFR | 271 | 6,122 | 297 | 7,724 |
| KRAS | 161 | 1,571 | 67 | 418 |
| MKRN1 | 1 | 0 | 1 | 1 |
| PIK3CA | 94 | 764 | 68 | 493 |
| PRET | 201 | 3,741 | 182 | 2,405 |
| PTEN | 229 | 5,311 | 166 | 2,600 |
| TP53 | 174 | 4,556 | 242 | 4,068 |
| YWHAH | 157 | 1,798 | 151 | 2,123 |
| Average | 220 | 4,650 | 195 | 3,756 |

Sequence Analysis

A sequencing flow cell was created as shown in TABLE 20 in order to determine the specific coverage of target genes as a function of library enrichment and normalization.

TABLE 20
Sequencing Analysis by Flow Cell

| | | | # of Clusters Per |
|---|---|---|---|
| Sample ID | Library | Amount Added | Sequencing Tile |
| 1 | 100+ insert/gDNA library | 4 μl of 1 ng/μl to 2 μl | 34,642 |
| | (non-enriched) | | |
| 2 | 100+ insert/once-enriched | 4 μl of 1 ng/μl to 2 μl | 33,088 |
| 3 | 100+ insert/twice-enriched | 4 μl of 1 ng/μl to 2 μl | 27,829 |
| 4 | 100+ insert/twice-enriched | 20 μl to 4 μl | 30,047 |
| | and normalized (third round | | |
| | of enrichment) | | |
| 5 | 200+ insert/gDNA library | 4 μl of 1 ng/μl to 2 μl | 24,813 |
| | (non-enriched) | | |
| 6 | 200+ insert/once-enriched | 4 μl of 1 ng/μl to 2 μl | 23,472 |
| 7 | 200+ insert/twice-enriched | 4 μl of 1 ng/μl to 2 μl | 20,455 |
| 8 | 200+ insert/twice-enriched | 20 μl to 4 μl | 22,375 |
| | and normalized (third round | | |
| | of enrichment) | | |

TABLE 21
Alignment of Sequencing Reads to Target Region

| | | | | | | | fold |
|---|---|---|---|---|---|---|---|
| | | | | % reads | | % reads | enrichment |
| | | total number | | that | # of reads | that | of reads |
| | | of 27 nt | # of reads | align to | that align | align to | aligning to |
| Sample | | sequencing | that align to | the gene | to coding | coding | coding |
| ID | Library | reads | the gene loci | loci | exons | exons | exons |
| 1 | 100+ insert/gDNA | 3,798,404 | 135,139 | 3.55% | 262 | .0069% | 1 |
| | library | | | | | | |
| | (non-enriched) | | | | | | |
| 2 | 100+ insert/once- | 4,220,177 | 276,322 | 6.54% | 31,865 | 0.755% | 122 |
| | enriched | | | | | | |
| 3 | 100+ insert/twice- | 4,274,896 | 1,099,077 | 25.71% | 653,057 | 15.27% | 2493 |
| | enriched | | | | | | |
| 4 | 100+ insert/twice- | 4,431,923 | 2,144,103 | 48.38% | 1,428,594 | 32.23% | 5453 |
| | enriched and | | | | | | |
| | normalized (third | | | | | | |
| | round of enrichment) | | | | | | |
| 5 | 200+ insert/gDNA | 4,335,770 | 156,622 | 3.61% | 324 | .0074% | 1 |
| | library | | | | | | |
| | (non-enriched) | | | | | | |
| 6 | 200+ insert/once- | 4,243,550 | 260,528 | 6.13% | 29,577 | 0.696% | 91 |
| | enriched | | | | | | |
| 7 | 200+ insert/twice- | 3,855,917 | 970,067 | 25.15% | 464,853 | 12.05% | 1435 |
| | enriched | | | | | | |
| 8 | 200+ insert/twice- | 3,913,182 | 1,697,263 | 43.37% | 933,503 | 23.85% | 2881 |
| | enriched and | | | | | | |
| | normalized (third | | | | | | |
| | round of enrichment) | | | | | | |

To assess the overall characteristics of the 77-gene targeted libraries, the 100+ twice-enriched processed library was applied to one lane of an Illumina sequencing flow cell. As shown above in TABLE 21, for the 100+ short insert library, approximately 50% of the overall sequencing reads in the twice-enriched and normalized (third round of enrichment) sample (#4) aligned to the gene target region (all the sequence space around a particular gene), while 32% of these reads aligned specifically to the target exonic regions. This demonstrates that 67% (1,428,594/2,144,103×100%) of the sequencing reads that map to the gene region are within the target exons. Further analysis indicated that the remaining 33% of the gene region mapped sequencing reads aligned to the intronic regions immediately adjacent to the exons (data not shown).

For the 200+ longer insert library, approximately 43% of the overall sequencing reads in the twice-enriched and normalized sample (third round of enrichment) (#8) aligned to the gene target region, while 24% of these reads aligned specifically to the target exonic regions. This demonstrates that 55% (933,503/1,697,263×100%) of the sequencing reads that map to the gene region are within the target exons and 45% of the reads mapped to adjacent introns, as would be expected for longer inserts that extend into intronic regions.

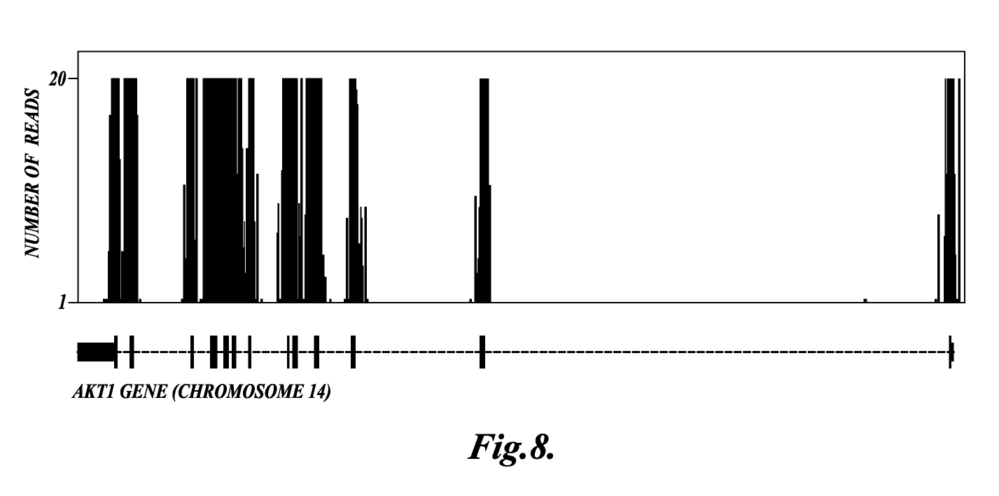

With regard to the sequence coverage at the level of an individual gene, as shown in FIG. 8, a base-by-base read depth from the 100+ short insert twice-enriched and normalized (third round of enrichment) library was determined for the exemplary gene AKT1. FIG. 8 shows the exon structure for AKT1, with solid boxes representing exons and dotted lines representing intron regions. The base-by-base sequencing read depth is plotted on a scale from 0 to 20 reads. As shown in FIG. 8, each exon region was covered by a sequencing read depth of at least 20 reads, while the intronic regions that were sequenced all clustered around the exonic targets of interest.

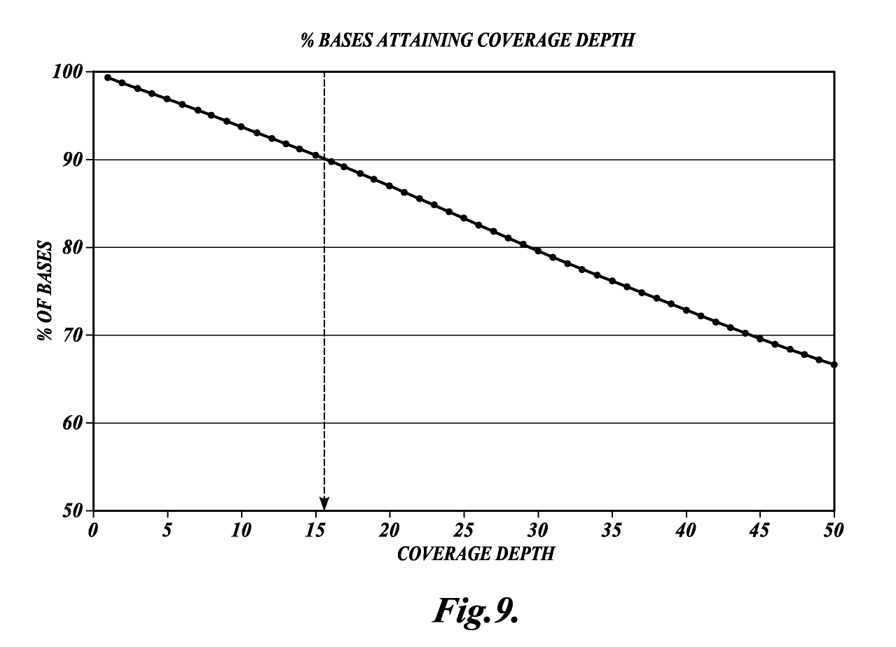

To address the issue of uniformity of sequencing coverage of a target region, the performance of the 100+ short insert twice-enriched library (sample #4 in TABLE 21) was analyzed in more detail. FIG. 9 shows the overall characteristics of this data, with the X-axis showing the sequencing coverage depth, defined as the number of times each individual base was found in an aligned sequence. The y-axis shows the percentage of bases, defined as the percentage of bases that have ≧the coverage depth shown on the x-axis. The percent of target bases was plotted as a function of sequence coverage depth (i.e., number of sequencing reads). The line plotted in FIG. 9 shows that 99% of the target bases were covered by at least one sequencing read and the arrow shows that 90% of the target bases were covered by 16 or more sequencing reads. This result is important because sequencing read depths ≧16 are necessary to reveal single nucleotide polymorphisms (SNPs) with confidence. Therefore, this overall coverage analysis indicated that the data obtained from one flow cell lane on a given sample (˜4,000,000 reads), there would be adequate sequence coverage depth to determine the presence of a small nucleotide polymorphism (SNP) with confidence across >90% of the target capture region.

In view of these results, an additional criterion for the selection of capture probe sequences will be to scan the candidate capture probe sequences for the presence of any known duplicated regions and eliminate these from use. Another approach will be to design the capture probes to selectively align to a particular genomic region of interest, such as a region less than one megabase of the human genome.

In summary, it has been demonstrated that the methods of generating an enriched library for a target region of interest are very useful for high throughput resequencing. In particular, it has been demonstrated that a genomic library that has been twice-enriched and normalized (third round of enrichment) library using the target capture methods described herein provides a highly enriched fraction of sequencing templates containing the target regions we endeavor to sequence.

### Example 6

This example describes the use of the solution-based capture method for sequence analysis of copy number variation from a sequencing-ready library prepared from total genomic library.

Rationale

In contrast to the methods described in Examples 3-5, in which it was advantageous to enrich the library for target sequences by capturing the target sequences in several rounds of solution-based capture, in this example, the concept was to generate low coverage shotgun sequencing of total genomic libraries that contained the number of target regions that were representative of the starting sample and sequencing the library. Read density maps were then generated by mapping the sequencing reads back to large, 500 Kb intervals of a reference genome corresponding to the type of sample. This example describes the application of this method to chromosome 14 of a human subject.

Methods

A sequencing-ready library of total genomic DNA inserts was generated as described in Example 2, starting with genomic DNA isolated from a healthy human subject, DNase I treating, blunt end polishing, and ligating on stem-loop linkers (SEQ ID NO:105 and SEQ ID NO:107), followed by 20 cycles of PCR and purification over a Qiaquick® column.

Analysis

Read density maps were generated by mapping the sequencing reads of the once-enriched library back to large, 500 Kb intervals of the sequenced 87.3 Mb portion of human chromosome 14.

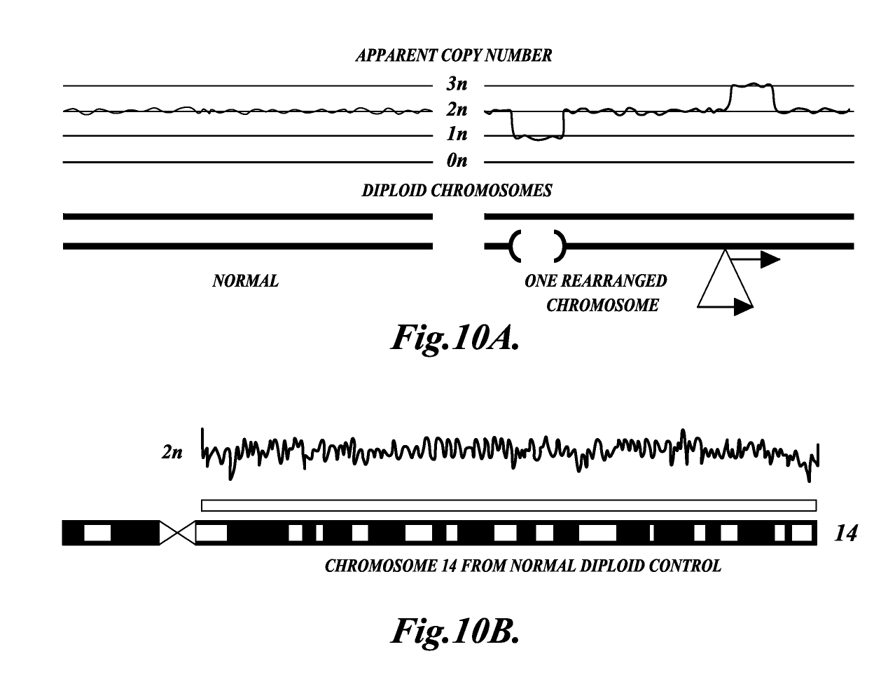

FIG. 10A illustrates the measurement of copy number variation using low-coverage genomic sequencing and molecular karyotyping, with the density of aligning sequencing reads per 100 Kb plotted along the x-axis as the apparent copy number. FIG. 10A, shows a sample containing a normal diploid chromosomal region (shown on the left), which exhibits a uniform 2 n density of sequencing reads across the entire region. In contrast, as further shown in FIG. 10A, a sample containing 1 normal chromosome and 1 chromosome with a deletion and a tandem duplication (shown on the right) will generate an abnormally low read density “dip” to 1 n across the deleted region and an abnormally high read density “spike” to 3 n across the duplicated region.

FIG. 10B shows the actual molecular karyotype across the 87.3 Mb sequenced portion of chromosome 14 showing uniform 2 n coverage from the normal human subject using the methods described in this Example. The density of aligning reads per 100 Kb region is plotted on the line shown.

The results in this example demonstrate the use of the described methods to analyze copy number variation of a target region of genomic DNA of interest from a subject.

### Example 7

This example describes a combination of whole transcriptome amplification, sequencing-ready library generation of the amplified whole transcriptome, enrichment of the library for target sequences of interest, and targeted resequencing of the library.

Rationale

Recent genome-wide association studies, which attempt to correlate a plurality of subjects sharing a particular phenotype with a particular genetic variation, have generated a puzzling result; more than half of the statistically defensible associations reported to date (>170 reports as of mid 2007) map to chromosomal regions devoid of any known genes.

This example describes the generation of a sequencing-ready library generated from whole transcriptome amplified nucleic acids that is enriched for a target locus of interest in order to provide sufficient sequencing coverage of a specific chromosomal location in a cost-effective manner.

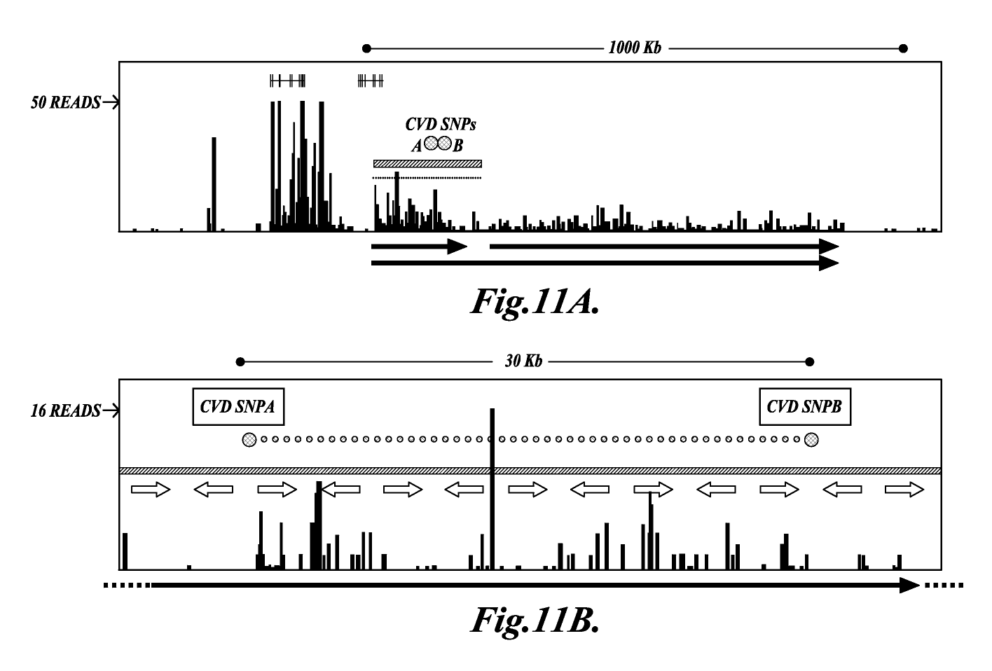

In order to demonstrate proof of concept for the combined approach, we focused on the cardiovascular disease risk locus on chromosome 9p21 (Helgadottir et al., Science 316:1491 (2007), shown in FIG. 11A which contains two SNPs (shown as SNPA and SNPB) associated with cardiovascular risk.

Methods

cDNA Synthesis for Whole-Transcriptome Library

A whole-transcriptome library was first generated as described in U.S. Patent Application Publication No. 2008/0187969, herein incorporated by reference. Briefly summarized, the method involves using a population of oligonucleotides to prime the amplification of a target population of nucleic acid molecules within a larger population of nucleic acid molecules, wherein each oligonucleotide comprises a hybridizing portion, wherein the hybridizing portion consists of one of 6, 7, or 8 nucleotides; and the population of oligonucleotides is selected to hybridize under defined conditions to a first subpopulation of the target nucleic acid population (i.e., mRNA molecules obtained from a human subject), but not hybridize under the defined conditions to a second subpopulation of the target nucleic acid population (i.e., ribosomal RNA). A population of not-so-random oligonucleotides that is capable of amplifying all transcripts except 18S and 28S transcripts was used to prime the amplification of mRNA and was generated as described in U.S. Patent Application Publication No. 2008/0187969.

Total RNA was extracted from a human subject and reverse transcriptase was used for first strand cDNA synthesis from the template RNA with the set of non-so-random primers. Second strand cDNA synthesis was then carried out and the double-stranded cDNA was used as the starting material for preparation of a sequencing-ready library, as described in Example 2.

Capture Oligonucleotides

A universal 5′ biotinylated oligo was used:

(SEQ ID NO: 232)
5′ [BioTEG] TAATTGCTCGAAGGGGTCCACATCCGCCACGCGT 3′

A series of closely-spaced chimeric capture oligos were generated that span a 200 Kb region across a segment of chromosome 9p21 encompassing SNPA and SNPB, as shown in FIG. 11B. The chimeric oligos were not biotinylated and each has a first 5′ region that hybridizes to the target region of chromosome 9p21, and a second 3′ region consisting of the following additional sequence that hybridizes to universal oligo:

(SEQ ID NO: 233)
5′ ACGCGTGGCGGATGTGGACCCCTTCGAGCAATTA 3′

Solution-Based Capture

Three rounds of solution-based capture were carried out as described in Example 3. Each fraction of library (raw library, first round enriched material, second round enriched material, and third round enriched material) was then sequenced and analyzed as described below.

Analysis

While very few ESTs map to the cardiovascular disease risk locus on chromosome 9p21, sequencing data obtained from sequencing-ready libraries generated from whole transcriptome amplification using the not-so-random primer amplification method, as described in this example, provided evidence that a large segment surrounding the disease-associated SNPA and SNPB is actively transcribed. As shown in FIG. 11A, an expanded view of this region of interest shows transcriptional activity covering >800 Kb that can be transcriptionally assigned to one or two transcriptional units.

As shown in FIG. 11B, by increasing the intensity of transcript-derived sequences from this region, the transcript structure can be mapped with confidence. Based on this information, assays can be developed that interrogate expression patterns of this region in tissues (e.g., a body atlas) to determine if expression of such loci correlates with patient phenotypes.

### Example 8

This example describes the use of the solution-based capture method for sequence analysis of genomic DNA isolated from clinical patient samples in order to identify genetic markers prognostic for treatment outcomes.

Rationale

While the application of genome-wide association studies to samples obtained from patients during clinical trials has the potential to point to genetic markers that may be prognostic for treatment outcomes, such associations are often weak. One explanation for this weak association is that while a genotyped SNP may be linked to an important genetic variation, it may not itself be causal for the observed phenotype. Moreover, although the genotyped SNP may be a common variant, it may also be linked to a rare, and as yet undiscovered, variation that is much more strongly associated with the phenotypic trait. Therefore, targeted resequencing can be used to uncover rare genetic variants, for example, in the genomic region surrounding a previously identified SNP.

Methods

Nucleic acids are isolated (DNA or RNA) from clinical samples obtained from subjects undergoing a particular treatment, or from a group of subjects exhibiting a particular phenotype of interest. Sequencing-ready libraries are made from the isolated nucleic acids, and the libraries are then enriched for a particular target region of interest. For example, a target region of interest may encompass the region surrounding a known SNP, such as common SNP “A” that is weakly associated with a rare and unfavorable adverse event. Targeted resequencing of a ˜40 Kb region surrounding this SNP uncovers a rare C→T SNP that is more strongly associated with the adverse event. Genotyping for the rare T variant in treatment populations would enable clinicians to eliminate subjects vulnerable to unfavorable outcomes.

The methods described in this example may be carried out on a plurality of nucleic acid-containing samples obtained over a period of time from the human subject in order to monitor the subject for genetic mutations in a target region of interest or to monitor the effect of a particular treatment regimen on a subject.

While the preferred embodiment of the invention has been illustrated and described, it will be appreciated that various changes can be made therein without departing from the spirit and scope of the invention.

1.-15. (canceled)

16. A method of enriching a library for target nucleic acid regions of interest, the method comprising:
(a) contacting a library of DNA molecules comprising a subpopulation of nucleic acid target insert sequences of interest flanked by a first primer binding region and a second primer binding region within a larger population of nucleic acid insert sequences flanked by the first primer binding region and the second primer binding region with a set of capture probes, the set of capture probes comprising a plurality of capture oligonucleotides, each comprising a first target sequence-specific binding region and a second capture reagent binding region, under conditions that allow binding between the capture oligonucleotides and the nucleic acid target regions of interest, to form a mixture comprising a plurality of complexes between target regions of interest and capture probes;
(b) contacting the mixture of step (a) with a capture reagent and separating the capture reagent bound complex from the mixture; and
(c) eluting the target regions of interest flanked by the first primer binding region and the second primer binding region from the capture reagent bound complex.

17. The method of claim 16, wherein the second capture reagent binding region directly binds to the capture reagent.

18. The method of claim 16, wherein the second capture reagent binding region binds to an adaptor capture oligonucleotide comprising a region that binds to the capture reagent; wherein the method further comprises contacting the mixture of step (a) with a plurality of adaptor capture oligonucleotides.

19. The method of claim 16, wherein step (a) is carried out in a solution comprising from 100 mM to 2 M NaCl.

20. The method of claim 16, further comprising washing the separated capture reagent bound complex with a wash solution comprising less than 10 mM NaCl prior to step (c).

21. The method of claim 17, wherein the wash solution further comprises from 15% to 30% formamide.

22. The method of claim 13, wherein the set of capture probes comprises a plurality of capture oligonucleotides, each capture probe comprising a first target-specific binding region that is at least 95% identical to at least a portion of the sense or antisense strand of the exons in at least 5 different genes.

23. The method of claim 16, wherein the set of capture probes comprises a plurality of capture oligonucleotides, each comprising a first target-specific binding region that is at least 95% identical to at least a portion of the sense or antisense strand of the exons in at least 70 different genes.

24. The method of claim 16, further comprising amplifying the eluted target regions of interest flanked by the first primer binding region and the second primer binding region with a forward PCR primer and a reverse PCR primer that bind to the first and second primer binding regions to generate a library that is once-enriched for target regions of interest.

25. The method of claim 24, further comprising:
(d) contacting the library that is once-enriched for target regions of interest with the capture probe pool under conditions that allow binding between the capture oligonucleotides and the nucleic acid target regions of interest, to form a plurality of complexes between target regions of interest and capture probes;
(e) contacting the mixture of step (d) with a capture reagent and separating the capture reagent bound complex from the mixture; and
(f) eluting the target regions of interest flanked by the first primer binding region and the second primer binding region from the capture reagent bound complex.

26. The method of claim 25 further comprising amplifying the eluted target regions of interest flanked by the first primer binding region and the second primer binding region with a forward PCR primer and a reverse PCR primer that bind to the first and second primer binding regions to generate a library that is twice-enriched for target regions of interest.

27. A method of generating a target enriched, sequencing ready library for resequencing at least one target region of interest from a nucleic acid containing sample, the method comprising:
(a) providing a library comprising fragmented nucleic acid molecules flanked by a first primer binding region and a second primer binding region; and
(b) enriching the library for target sequences with a set of capture probes comprising a plurality of capture oligonucleotides, each comprising a first target-specific binding region and a second capture reagent binding region, thereby generating an enriched sequencing ready library for resequencing at least one target region of interest.

28. The method of claim 27, further comprising PCR amplifying the enriched library with PCR primers that bind to the first primer binding region and the second primer binding region to generate an amplified product.

29. The method of claim 27, wherein at least one of the first stem-loop linker or the second stem-loop linker oligonucleotides comprises a molecular bar code.

30. The method of claim 27, further comprising sequencing at least a portion of the enriched library to determine the sequence of the regions of interest.

31. The method of claim 27, wherein the library is generated from nucleic acids obtained from a human subject.

32. The method of claim 28, further comprising sequencing at least a portion of the enriched library to determine the sequence of the regions of interest.
